(19) United States
(12) Patent Application Publication
(10) Pub. No.: US 2004/0130754 A1
(43) Pub. Date: Jul. 8, 2004

(54) Printing method and printing apparatus

(75) Inventors: Nobuaki Usui, Kawasaki (JP); Junichi Odagiri, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/740,793

(22) Filed: Dec. 22, 2003

(30) Foreign Application Priority Data
Dec. 25, 2002 (JP) 2002-374899

(51) Int. Cl. H04N 1/405; H04N 1/409; H04N 1/52; H04N 1/58

(52) U.S. Cl. 358/3.13; 358/3.26; 358/535; 358/533

(57) ABSTRACT

The invention provides a printing method and apparatus which can reduce moirés and artifacts. The printing method includes an expanding step of expanding a multi-value image in a storage area, and an image forming step of binarizing the multi-value image expanded in the storage area based on a binarization dither matrix pattern wherein the turn-on order of pixels is set so that dots having shapes same as each other individually grow in order from a plurality of points and forming an image based on a result of the binarization.

### BACKGROUND OF THE INVENTION

1) Field of the Invention

The present invention relates to a binarization dither matrix pattern (dither pattern table) for use with a binarization process for converting a multi-value image (Continuous Tone Image) such as a natural image, a graphic image or a color character image into a binary image and a technique which uses the binarization dither matrix pattern.

2) Description of the Related Art

In order to output a multi-value image such as a natural image, a graphic image or a color character image obtained by fetching from an inputting apparatus such as a scanner or by preparation from an outputting apparatus such as a printer, a binarization process must be performed in order to represent the multi-value image by ON/OFF of a color material (such as ink, toner or the like; hereinafter referred to sometimes as dot or dots).

A dither method is known as one of such binarization methods. The dither method is a method for comparing the magnitudes of a value of a particular pixel (object pixel) in a multi-value image and a threshold value set in advance with each other to decide a gradation density of a pixel and deciding ON/OFF of a dot regarding the pixel in accordance with the gradation density of the pixel using a binarization dither matrix pattern prepared in advance.

For example, according to a method disclosed in Japanese Patent Laid-Open (Kokai) No. SHO 58-189641, such a dither pattern that the centers of gravity of regions in which a color material is fixed are arranged so as to satisfy tanθ=⅓ (approximately 18.43°) can be obtained. Further, moirés and artificial stripe patterns (Artifacts) can be reduced by using a dither angle other than 0° and 45°.

[Patent Document 1]

Japanese Patent Laid-Open (Kokai) No. SHO 58-189641 (pages 3 and 4, FIGS. 1 and 2)

[Patent Document 2]

Japanese Patent Application No. 2001-193657

However, in such a dither pattern obtained by the method disclosed in Japanese Patent Laid-Open (Kokai) No. SHO 58-189641 as described above, there is a subject that moirés in a vertical direction (printing direction) and a transverse direction (direction perpendicular to the printing direction) cannot be reduced, and as a result, the printing quality is low.

### SUMMARY OF THE INVENTION

It is an object of the present invention to provide a binarization dither matrix pattern and a printing technique using the same by which moirés and artifacts can be reduced.

In order to attain the object described above, according to an aspect of the present invention, there is provided a printing method, comprising an expanding step of expanding a multi-value image in a storage area, and an image forming step of binarizing the multi-value image expanded in the storage area based on a binarization dither matrix pattern and forming an image based on a result of the binarization, and wherein the binarization dither matrix pattern is configured as a rectangular pattern wherein a plurality of pixels to be turned on successively are arranged in a matrix, and the rectangular pattern includes a plurality of basic patterns formed such that, in a partly lacking matrix having eight rows and seven columns, the pixels of the fourth to sixth columns which form the first row of the partly lacking matrix are turned on 29th, 35th, and 39th, respectively, the pixels of the first to sixth columns which form the second row of the partly lacking matrix are turned on 37th, 27th, 15th, 17th, 25th, and 31st, respectively, the pixels of the first to sixth columns which form the third row of the partly lacking matrix are turned on 33rd, 21st, 9th, 7th, 11th, and 19th, respectively, the pixels of the first to seventh columns which form the fourth row of the partly lacking matrix are turned on 28th, 10th, 3rd, 1st, 5th, 13th, and 23rd, respectively, the pixels of the first to seventh columns which form the fifth row of the partly lacking matrix are turned on 22nd, 12th, 4th, 2nd, 6th, 18th, and 34th, respectively, the pixels of the second to seventh columns which form the sixth row of the partly lacking matrix are turned on 26th, 16th, 8th, 14th, 30th, and 38th, respectively, the pixels of the second to fifth columns which form the seventh row of the partly lacking matrix are turned on 36th, 32nd, 24th, and 20th, respectively, and the pixel of the second column which forms the eighth row of the partly lacking matrix is turned on 40th, and the turn-on order of the pixels is set so that dots having shapes same as each other individually grow in order from a plurality of points.

According to another aspect of the present invention, there is provided a printing method, comprising an expanding step of expanding a multi-value image in a storage area, and an image forming step of binarizing the multi-value image expanded in the storage area based on a binarization dither matrix pattern and forming an image based on a result of the binarization, and wherein the binarization dither matrix pattern is configured as a rectangular pattern wherein a plurality of pixels to be turned on successively are arranged in a matrix, and the rectangular pattern includes a plurality of sub patterns formed by arranging m basic patterns formed such that, in a partly lacking matrix having eight rows and seven columns, the pixels of the fourth to sixth columns which form the first row of the partly lacking matrix are turned on n+28×mth, n+34×mth, and n+38×mth, respectively, the pixels of the first to sixth columns which form the second row of the partly lacking matrix are turned on n+36×mth, n+26×mth, n+14×mth, n+16×mth, n+24×mth, and n+30×mth, respectively, the pixels of the first to sixth columns which form the third row of the partly lacking matrix are turned on n+32×mth, n+20×mth, n+8×mth, n+6×mth, n+10×mth, and n+18×mth, respectively, the pixels of the first to seventh columns which form the fourth row of the partly lacking matrix are turned on n+27×mth, n+9×mth, n+2×mth, nth, n+4×mth, n+12×mth, and n+22×mth, respectively, the pixels of the first to seventh columns which form the fifth row of the partly lacking matrix are turned on n+21×mth, n+11×mth, n+3×mth, n+mth, n+5×mth, n+17×mth, and n+33×mth, respectively, the pixels of the second to seventh columns which form the sixth row of the partly lacking matrix are turned on n+25×mth, n+15×mth, n+7×mth, n+13×mth, n+29×mth, and n+37×mth, respectively, the pixels of the second to fifth columns which form the seventh row of the partly lacking matrix are turned on n+35×mth, n+31×mth, n+23×mth, and n+19×mth, respectively, and the pixel of the second column which forms the eighth row of the partly lacking matrix is turned on n+39×mth, m and n being arbitrary natural numbers, and the turn-on order of the pixels is set so that dots having shapes same as each other individually grow in order based on the plurality of sub patterns.

According to a further aspect of the present invention, there is provided a printing method, comprising an expanding step of expanding a multi-value image in a storage area, and an image forming step of binarizing the multi-value image expanded in the storage area based on a binarization dither matrix pattern and forming an image based on a result of the binarization, and wherein the binarization dither matrix pattern is configured as a rectangular pattern wherein a plurality of pixels to be turned on successively are arranged in a matrix, and the rectangular pattern includes a plurality of basic patterns formed such that, in a partly lacking matrix having seven rows and six columns, the pixels of the first to sixth columns which form the first row of the partly lacking matrix are turned on 34th, 26th, 14th, 24th, 32nd, and 36th, respectively, the pixels of the first to sixth columns which form the second row of the partly lacking matrix are turned on 30th, 16th, 8th, 12th, 20th, and 28th, respectively, the pixels of the first to sixth columns which form the third row of the partly lacking matrix are turned on 22nd, 6th, 2nd, 4th, 10th, and 18th, respectively, the pixels of the first to sixth columns which form the fourth row of the partly lacking matrix are turned on 15th, 5th, 1st, 3rd, 11th, and 23rd, respectively, the pixels of the first to sixth columns which form the fifth row of the partly lacking matrix are turned on 25th, 13th, 7th, 9th, 19th, and 31st, respectively, the pixels of the first to sixth columns which form the sixth row of the partly lacking matrix are turned on 33rd, 29th, 21st, 17th, 27th, and 35th, respectively, and the pixel of the first column which forms the seventh row is turned on 37th, and the turn-on order of the pixels is set so that dots having shapes same as each other individually grow in order from a plurality of points.

According to a still further aspect of the present invention, there is provided a printing method, comprising an expanding step of expanding a multi-value image in a storage area, and an image forming step of binarizing the multi-value image expanded in the storage area based on a binarization dither matrix pattern and forming an image based on a result of the binarization, and wherein the binarization dither matrix pattern is configured as a rectangular pattern wherein a plurality of pixels to be turned on successively are arranged in a matrix, and the rectangular pattern includes a plurality of sub patterns formed by arranging m basic patterns formed such that, in a partly lacking matrix having seven rows and six columns, the pixels of the first to sixth columns which form the first row of the partly lacking matrix are turned on n+33×mth, n+25×mth, n+13×mth, n+23×mth, n+31×mth, and n+35×mth, respectively, the pixels of the first to sixth columns which form the second row of the partly lacking matrix are turned on n+29×mth, n+15×mth, n+7×mth, n+11×mth, n+19×mth, and n+27×mth, respectively, the pixels of the first to sixth columns which form the third row of the partly lacking matrix are turned on n+21×mth, n+5×mth, n+mth, n+3×mth, n+9×mth, and n+17×mth, respectively, the pixels of the first to sixth columns which form the fourth row of the partly lacking matrix are turned on n+14×mth, n+4×mth, nth, n+2×mth, n+10×mth, and n+22×mth, respectively, the pixels of the first to sixth columns which form the fifth row of the partly lacking matrix are turned on n+24×mth, n+12×mth, n+6×mth, n+8×mth, n+18×mth, and n+30×mth, respectively, the pixels of the first to sixth columns which form the sixth row of the partly lacking matrix are turned on n+32×mth, n+28×mth, n+20×mth, n+16×mth, n+26×mth, and n+34×mth, respectively, and the pixel of the first column which forms the seventh row of the partly lacking matrix is turned on n+36×mth, m and n being arbitrary natural numbers, and the turn-on order of the pixels is set so that dots having shapes same as each other individually grow in order based on the plurality of sub patterns.

According to a yet further aspect of the present invention, there is provided a printing method, comprising an expanding step of expanding a multi-value image in a storage area, and an image forming step of binarizing the multi-value image expanded in the storage area based on a binarization dither matrix pattern and forming an image based on a result of the binarization, and wherein the binarization dither matrix pattern is configured as a rectangular pattern wherein a plurality of pixels to be turned on successively are arranged in a matrix, and the rectangular pattern includes a plurality of sub patterns formed by arranging m basic patterns formed such that, in a partly lacking matrix having six rows and five columns, the pixels of the first to fifth columns which form the first row of the partly lacking matrix are turned on n+22×mth, n+14×mth, n+12×mth, n+20×mth, and n+24×mth, respectively, the pixels of the first to fifth columns which form the second row of the partly lacking matrix are turned on n+18×mth, n+6×mth, n+4×mth, n+8×mth, and n+16×mth, respectively, the pixels of the first to fifth columns which form the third row of the partly lacking matrix are turned on n+11×mth, n+3×mth, nth, n+2×mth, and n+10×mth, respectively, the pixels of the first to fifth columns which form the fourth row of the partly lacking matrix are turned on n+13×mth, n+5×mth, n+mth, n+7×mth, and n+19×mth, respectively, the pixels of the first to fifth columns which form the fifth row of the partly lacking matrix are turned on n+21×mth, n+17×mth, n+9×mth, n+15×mth, and n+23×mth, respectively, and the pixel of the first column which forms the sixth row of the partly lacking matrix is turned on n+25×mth, m and n being arbitrary natural numbers, and the turn-on order of the pixels is set so that dots having shapes same as each other individually grow in order based on the plurality of sub patterns.

According to a yet further aspect of the present invention, there is provided a printing method, comprising an expanding step of expanding a multi-value image in a storage area, and an image forming step of binarizing the multi-value image expanded in the storage area based on a binarization dither matrix pattern and forming an image based on a result of the binarization, and wherein the binarization dither matrix pattern is configured as a rectangular pattern wherein a plurality of pixels to be turned on successively are arranged in a matrix, and the rectangular pattern includes a plurality of basic patterns formed such that, in a partly lacking matrix having four rows and three columns, the pixels of the first to third columns which form the first row of the partly lacking matrix are turned on seventh, fifth, and ninth, respectively, the pixels of the first to third columns which form the second row of the partly lacking matrix are turned on fourth, first, and third, respectively, the pixels of the first to third columns which form the third row of the partly lacking matrix are turned on sixth, second, and eighth, respectively, and the pixel of the first column which forms the fourth row of the partly lacking matrix is turned on tenth, and the turn-on order of the pixels is set so that dots having shapes same as each other individually grow in order from a plurality of points.

According to a yet further aspect of the present invention, there is provided a printing method, comprising an expanding step of expanding a multi-value image in a storage area, and an image forming step of binarizing the multi-value image expanded in the storage area based on a binarization dither matrix pattern and forming an image based on a result of the binarization, and wherein the binarization dither matrix pattern is configured as a rectangular pattern wherein a plurality of pixels to be turned on successively are arranged in a matrix, and the rectangular pattern includes a plurality of sub patterns formed by arranging m basic patterns formed such that, in a partly lacking matrix having four rows and three columns, the pixels of the first to third columns which form the first row of the partly lacking matrix are turned on n+6×mth, n+4×mth, and n+8×mth, respectively, the pixels of the first to third columns which form the second row of the partly lacking matrix turned on n+3×mth, nth, and n+2×mth, respectively, the pixels of the first to third columns which form the third row of the partly lacking matrix are turned on n+5×mth, n+mth, and n+7×mth, respectively, and the pixel of the first column which forms the fourth row of the partly lacking matrix is turned on n+9×mth, m and n being arbitrary natural numbers, and the turn-on order of the pixels is set so that dots having shapes same as each other individually grow in order based on the plurality of sub patterns.

According to a yet further aspect of the present invention, there is provided a printing method, comprising an expanding step of expanding a multi-value image in a storage area, and an image forming step of binarizing the multi-value image expanded in the storage area based on a binarization dither matrix pattern and forming an image based on a result of the binarization, and wherein the binarization dither matrix pattern is configured as a rectangular pattern wherein a plurality of pixels to be turned on successively are arranged in a matrix, and the rectangular pattern includes a plurality of basic patterns formed such that, in a partly lacking matrix having five rows and four columns, the pixels of the first to fourth columns which form the first row of the partly lacking matrix are turned on 14th, 6th, 12th, and 16th, respectively, the pixels of the first to fourth columns which form the second row of the partly lacking matrix are turned on 10th, 2nd, 4th, and 8th, respectively, the pixels of the first to fourth columns which form the third row of the partly lacking matrix are turned on 5th, 1st, 3rd, and 11th, respectively, the pixels of the first to fourth columns which form the fourth row of the partly lacking matrix are turned on 13th, 9th, 7th, and 15th, respectively, and the pixel of the first column which forms the fifth row of the partly lacking matrix is turned on 17th, and the turn-on order of the pixels is set so that dots having shapes same as each other individually grow in order from a plurality of points.

According to a yet further aspect of the present invention, there is provided a printing method, comprising an expanding step of expanding a multi-value image in a storage area, and an image forming step of binarizing the multi-value image expanded in the storage area based on a binarization dither matrix pattern and forming an image based on a result of the binarization, and wherein the binarization dither matrix pattern is configured as a rectangular pattern wherein a plurality of pixels to be turned on successively are arranged in a matrix, and the rectangular pattern includes a plurality of sub patterns formed by arranging m basic patterns formed such that, in a partly lacking matrix having five rows and four columns, the pixels of the first to fourth column which form the first row of the partly lacking matrix are turned on n+13×mth, n+5×mth, n+11×mth, and n+15×mth, respectively, the pixels of the first to fourth columns which form the second row of the partly lacking matrix are turned on n+9×mth, n+mth, n+3×mth, and n+7×mth, respectively, the pixels of the first to fourth columns which form the third row of the partly lacking matrix are turned on n+4×mth, nth, n+2×mth, and n+10×mth, respectively, the pixels of the first to fourth columns which form the fourth row of the partly lacking matrix are turned on n+12×mth, n+8×mth, n+6×mth, and n+14×mth, respectively, and the pixel of the first column which forms the fifth row of the partly lacking matrix is turned on n+16×mth, m and n being arbitrary natural numbers, and the turn-on order of the pixels is set so that dots having shapes same as each other individually grow in order based on the plurality of sub patterns.

According to a yet further aspect of the present invention, there is provided a printing method, comprising an expanding step of expanding a multi-value image in a storage area, and an image forming step of binarizing the multi-value image expanded in the storage area based on a binarization dither matrix pattern and forming an image based on a result of the binarization, and wherein the binarization dither matrix pattern is configured as a rectangular pattern wherein a plurality of pixels to be turned on successively are arranged in a matrix, and the rectangular pattern includes a plurality of basic patterns formed such that, in a partly lacking matrix having six rows and five columns, the pixels of the first to fifth columns which form the first row of the partly lacking matrix are turned on 23rd, 15th, 13th, 21st, and 25th, respectively, the pixels of the first to fifth columns which form the second row of the partly lacking matrix are turned on 19th, 7th, 5th, 9th, and 17th, respectively, the pixels of the first to fifth columns which form the third row of the partly lacking matrix are turned on 12th, 4th, 1st, 3rd, and 11th, respectively, the pixels of the first to fifth columns which form the fourth row of the partly lacking matrix are turned on 14th, 6th, 2nd, 8th, and 20th, respectively, the pixels of the first to fifth columns which form the fifth row of the partly lacking matrix are turned on 22nd, 18th, 10th, 16th, and 24th, respectively, and the pixel of the first column which forms the sixth row of the partly lacking matrix is turned on 26th, and the turn-on order of the pixels is set so that dots having shapes same as each other individually grow in order from a plurality of points.

According to a yet further aspect of the present invention, there is provided a printing method, comprising a step of preparing a binarization dither matrix pattern which is formed as a rectangular pattern wherein a plurality of pixels to be turned on successively are arranged in a matrix, the rectangular pattern including a plurality of basic patterns formed such that, in a partly lacking matrix having four rows and three columns, the pixels of the first to third columns which form the first row of the partly lacking matrix are turned on 7th, 5th, and 9th, respectively, the pixels of the first to third columns which form the second row of the partly lacking matrix are turned on 4th, 1st, and 3rd, respectively, the pixels of the first to third columns which form the third row of the partly lacking matrix are turned on 6th, 2nd, and 8th, respectively, and the pixel of the first column which forms the fourth row of the partly lacking matrix is turned on 10th, the turn-on order of the pixels being set so that dots having shapes same as each other individually grow from a plurality of points, and an image forming step of selecting the pixels from the starting pixel in the turn-on order to the pixel to which a predetermined turn-on order number is set in the binarization dither matrix pattern in accordance with the turn-on order based on a pixel value of an inputted multi-value image to determine the pixels on which a color material is to be formed and forming the color material on the determined pixels to form an image.

According to a yet further aspect of the present invention, there is provided a printing method, comprising a step of preparing a binarization dither matrix pattern which is formed as a rectangular pattern wherein a plurality of pixels to be turned on successively are arranged in a matrix, the rectangular pattern including a plurality of sub patterns formed by arranging m basic patterns formed such that, in a partly lacking matrix having four rows and three columns, the pixels of the first to third columns which form the first row of the partly lacking matrix are turned on n+6×mth, n+4×mth, and n+8×mth, respectively, the pixels of the first to third columns which form the second row of the partly lacking matrix are turned on n+3×mth, nth, and n+2×mth, respectively, the pixels of the first to third columns which form the third row of the partly lacking matrix are turned on n+5×mth, n+mth, and n+7×mth, respectively, and the pixel of the first column which forms the fourth row of the partly lacking matrix is turned on n+9×mth, m and n being arbitrary natural numbers, the turn-on order of the pixels being set so that dots having shapes same as each other individually grow from a plurality of points, and an image forming step of selecting the pixels from the starting pixel in the turn-on order to the pixel to which a predetermined turn-on order number is set in the binarization dither matrix pattern in accordance with the turn-on order based on a pixel value of an inputted multi-value image to determine the pixels on which a color material is to be formed and forming the color material on the determined pixels to form an image.

According to a yet further aspect of the present invention, there is provided a printing method, comprising a step of preparing a binarization dither matrix pattern which is formed as a rectangular pattern wherein a plurality of pixels to be turned on successively are arranged in a matrix, the rectangular pattern including a plurality of basic patterns formed such that, in a partly lacking matrix having five rows and four columns, the pixels of the first to fourth columns which form the first row of the partly lacking matrix are turned on 14th, 6th, 12th, and 16th, respectively, the pixels of the first to fourth columns which form the second row of the partly lacking matrix are turned on 10th, 2nd, 4th, and 8th, respectively, the pixels of the first to fourth columns which form the third row of the partly lacking matrix are turned on 5th, 1st, 3rd, and 11th, respectively, the pixels of the first to fourth columns which form the fourth row of the partly lacking matrix are turned on 13th, 9th, 7th, and 15th, respectively, and the pixel of the first column which forms the fifth row of the partly lacking matrix is turned on 17th, the turn-on order of the pixels being set so that dots having shapes same as each other individually grow from a plurality of points, and an image forming step of selecting the pixels from the starting pixel in the turn-on order to the pixel to which a predetermined turn-on order number is set in the binarization dither matrix pattern in accordance with the turn-on order based on a pixel value of an inputted multi-value image to determine the pixels on which a color material is to be formed and forming the color material on the determined pixels to form an image.

According to a yet further aspect of the present invention, there is provided a printing method, comprising a step of preparing a binarization dither matrix pattern which is formed as a rectangular pattern wherein a plurality of pixels to be turned on successively are arranged in a matrix, the rectangular pattern including a plurality of sub patterns formed by arranging m basic patterns formed such that, in a partly lacking matrix having five rows and four columns, the pixels of the first to fourth columns which form the first row of the partly lacking matrix are turned on n+13×mth, n+5×mth, n+11×mth, and n+15×mth, respectively, the pixels of the first to fourth columns which form the second row of the partly lacking matrix are turned on n+9×mth, n+mth, n+3×mth, and n+7×mth, respectively, the pixels of the first to fourth columns which form the third row of the partly lacking matrix are turned on n+4×mth, nth, n+2×mth, and n+10×mth, respectively, the pixels of the first to fourth columns which form the fourth row of the partly lacking matrix are turned on n+12×mth, n+8×mth, n+6×mth, and n+14×mth, respectively, and the pixel of the first column which forms the fifth row of the partly lacking matrix is turned on n+16×mth, m and n being arbitrary natural numbers, the turn-on order of the pixels being set so that dots having shapes same as each other individually grow from a plurality of points, and an image forming step of selecting the pixels from the starting pixel in the turn-on order to the pixel to which a predetermined turn-on order number is set in the binarization dither matrix pattern in accordance with the turn-on order based on a pixel value of an inputted multi-value image to determine the pixels on which a color material is to be formed and forming the color material on the determined pixels to form an image.

According to a yet further aspect of the present invention, there is provided a printing method, comprising a step of preparing a binarization dither matrix pattern which is formed as a rectangular pattern wherein a plurality of pixels to be turned on successively are arranged in a matrix, the rectangular pattern including a plurality of basic patterns formed such that, in a partly lacking matrix having six rows and five columns, the pixels of the first to fifth columns which form the first row of the partly lacking matrix are turned on 23rd, 15th, 13th, 21st, and 25th, respectively, the pixels of the first to fifth columns which form the second row of the partly lacking matrix are turned on 19th, 7th, 5th, 9th, and 17th, respectively, the pixels of the first to fifth columns which form the third row of the partly lacking matrix are turned on 12th, 4th, 1st, 3rd, and 11th, respectively, the pixels of the first to fifth columns which form the fourth row of the partly lacking matrix are turned on 14th, 6th, 2nd, 8th, and 20th, respectively, the pixels of the first to fifth columns which form the fifth row of the partly lacking matrix are turned on 22nd, 18th, 10th, 16th, and 24th, respectively, and the pixel of the first column which forms the sixth row of the partly lacking matrix is turned on 26th, the turn-on order of the pixels being set so that dots having shapes same as each other individually grow from a plurality of points, and an image forming step of selecting the pixels from the starting pixel in the turn-on order to the pixel to which a predetermined turn-on order number is set in the binarization dither matrix pattern in accordance with the turn-on order based on a pixel value of an inputted multi-value image to determine the pixels on which a color material is to be formed and forming the color material on the determined pixels to form an image.

According to a yet further aspect of the present invention, there is provided a printing method, comprising a step of preparing a binarization dither matrix pattern which is formed as a rectangular pattern wherein a plurality of pixels to be turned on successively are arranged in a matrix, the rectangular pattern including a plurality of sub patterns formed by arranging m basic patterns formed such that, in a partly lacking matrix having six rows and five columns, the pixels of the first to fifth columns which form the first row of the partly lacking matrix are turned on n+22×mth, n+14×mth, n+12×mth, n+20×mth, and n+24×mth, respectively, the pixels of the first to fifth columns which form the second row of the partly lacking matrix are turned on n+18×mth, n+6×mth, n+4×mth, n+8×mth, and n+16×mth, respectively, the pixels of the first to fifth columns which from the third row of the partly lacking matrix are turned on n+11×mth, n+3×mth, nth, n+2×mth, and n+10×mth, respectively, the pixels of the first to fifth columns which form the fourth row of the partly lacking matrix are turned on n+13×mth, n+5×mth, n+mth, n+7×mth, and n+19×mth, respectively, the pixels of the first to fifth columns which form the fifth row of the partly lacking matrix are turned on n+21×mth, n+17×mth, n+9×mth, n+15×mth, and n+23×mth, respectively, and the pixel of the first column which forms the sixth row of the partly lacking matrix is turned on n+25×mth, m and n being arbitrary natural numbers, the turn-on order of the pixels being set so that dots having shapes same as each other individually grow from a plurality of points, and an image forming step of selecting the pixels from the starting pixel in the turn-on order to the pixel to which a predetermined turn-on order number is set in the binarization dither matrix pattern in accordance with the turn-on order based on a pixel value of an inputted multi-value image to determine the pixels on which a color material is to be formed and forming the color material on the determined pixels to form an image.

According to a yet further aspect of the present invention, there is provided a printing method, comprising a step of preparing a binarization dither matrix pattern which is formed as a rectangular pattern wherein a plurality of pixels to be turned on successively are arranged in a matrix, the rectangular pattern including a plurality of basic patterns formed such that, in a partly lacking matrix having seven rows and six columns, the pixels of the first to sixth columns which form the first row of the partly lacking matrix are turned on 34th, 26th, 14th, 24th, 32nd, and 36th, respectively, the pixels of the first to sixth columns which form the second row of the partly lacking matrix are turned on 30th, 16th, 8th, 12th, 20th, and 28th, respectively, the pixels of the first to sixth columns which form the third row of the partly lacking matrix are turned on 22nd, 6th, 2nd, 4th, 10th, and 18th, respectively, the pixels of the first to sixth columns which form the fourth row of the partly lacking matrix are turned on 15th, 5th, 1st, 3rd, 11th, and 23rd, respectively, the pixels of the first to sixth columns which form the fifth row of the partly lacking matrix are turned on 25th, 13th, 7th, 9th, 19th, and 31st, respectively, the pixels of the first to sixth columns which form the sixth row of the partly lacking matrix are turned on 33rd, 29th, 21st, 17th, 27th, and 35th, respectively, and the pixel of the first column which forms the seventh row of the partly lacking matrix is turned on 37th, the turn-on order of the pixels being set so that dots having shapes same as each other individually grow from a plurality of points, and an image forming step of selecting the pixels from the starting pixel in the turn-on order to the pixel to which a predetermined turn-on order number is set in the binarization dither matrix pattern in accordance with the turn-on order based on a pixel value of an inputted multi-value image to determine the pixels on which a color material is to be formed and forming the color material on the determined pixels to form an image.

According to a yet further aspect of the present invention, there is provided a printing method, comprising a step of preparing a binarization dither matrix pattern which is formed as a rectangular pattern wherein a plurality of pixels to be turned on successively are arranged in a matrix, the rectangular pattern including a plurality of sub patterns formed by arranging m basic patterns formed such that, in a partly lacking matrix having seven rows and six columns, the pixels of the first to sixth columns which form the first row of the partly lacking matrix are turned on n+33×mth, n+25×mth, n+13×mth, n+23×mth, n+31×mth, and n+35×mth, respectively, the pixels of the first to sixth columns which form the second row of the partly lacking matrix are turned on n+29×mth, n+15×mth, n+7×mth, n+11×mth, n+19×mth, and n+27×mth, respectively, the pixels of the first to sixth columns which form the third row of the partly lacking matrix are turned on n+21×mth, n+5×mth, n+mth, n+3×mth, n+9×mth, and n+17×mth, respectively, the pixels of the first to sixth columns which form the fourth row of the partly lacking matrix are turned on n+14×mth, n+4×mth, nth, n+2×mth, n+10×mth, and n+22×mth, respectively, the pixels of the first to sixth columns which form the fifth row of the partly lacking matrix are turned on n+24×mth, n+12×mth, n+6×mth, n+8×mth, n+18×mth, and n+30×mth, respectively, the pixels of the first to sixth columns which form the sixth row of the partly lacking matrix are turned on n+32×mth, n+28×mth, n+20×mth, n+16×mth, n+26×mth, and n+34×mth, respectively, and the pixel of the first column which forms the seventh row of the partly lacking matrix is turned on n+36×mth, m and n being arbitrary natural numbers, the turn-on order of the pixels being set so that dots having shapes same as each other individually grow from a plurality of points, and an image forming step of selecting the pixels from the starting pixel in the turn-on order to the pixel to which a predetermined turn-on order number is set in the binarization dither matrix pattern in accordance with the turn-on order based on a pixel value of an inputted multi-value image to determine the pixels on which a color material is to be formed and forming the color material on the determined pixels to form an image.

According to a yet further aspect of the present invention, there is provided a printing method, comprising a step of preparing a binarization dither matrix pattern which is formed as a rectangular pattern wherein a plurality of pixels to be turned on successively are arranged in a matrix, the rectangular pattern including a plurality of basic patterns formed such that, in a partly lacking matrix having eight rows and seven columns, the pixels of the fourth to sixth columns which form the first row of the partly lacking matrix are turned on 29th, 35th, and 39th, respectively, the pixels of the first to sixth columns which form the second row of the partly lacking matrix are turned on 37th, 27th, 15th, 17th, 25th, and 31st, respectively, the pixels of the first to sixth columns which form the third row of the partly lacking matrix are turned on 33rd, 21st, 9th, 7th, 11th, and 19th, respectively, the pixels of the first to seventh columns which form the fourth row of the partly lacking matrix are turned on 28th, 10th, 3rd, 1st, 5th, 13th, and 23rd, respectively, the pixels of the first to seventh columns which form the fifth row of the partly lacking matrix are turned on 22nd, 12th, 4th, 2nd, 6th, 18th, and 34th, respectively, the pixels of the second to seventh columns which form the sixth row of the partly lacking matrix are turned on 26th, 16th, 8th, 14th, 30th, and 38th, respectively, the pixels of the second to fifth columns which form the seventh row of the partly lacking matrix are turned on 36th, 32nd, 24th, and 20th, respectively, and the pixel of the second column which forms the eighth row of the partly lacking matrix is turned on 40th, the turn-on order of the pixels being set so that dots having shapes same as each other individually grow from a plurality of points, and an image forming step of selecting the pixels from the starting pixel in the turn-on order to the pixel to which a predetermined turn-on order number is set in the binarization dither matrix pattern in accordance with the turn-on order based on a pixel value of an inputted multi-value image to determine the pixels on which a color material is to be formed and forming the color material on the determined pixels to form an image.

According to a yet further aspect of the present invention, there is provided a printing method, comprising a step of preparing a binarization dither matrix pattern which is formed as a rectangular pattern wherein a plurality of pixels to be turned on successively are arranged in a matrix, the rectangular pattern including a plurality of sub patterns formed by arranging m basic patterns formed such that, in a partly lacking matrix having eight rows and seven columns, the pixels of the fourth to sixth columns which form the first row of the partly lacking matrix are turned on n+28×mth, n+34×mth, and n+38×mth, respectively, the pixels of the first to sixth columns which form the second row of the partly lacking matrix are turned on n+36×mth, n+26×mth, n+14×mth, n+16×mth, n+24×mth, and n+30×mth, respectively, the pixels of the first to sixth columns which form the third row of the partly lacking matrix are turned on n+32×mth, n+20×mth, n+8×mth, n+6×mth, n+10×mth, and n+18×mth, respectively, the pixels of the first to seventh columns which form the fourth row of the partly lacking matrix are turned on n+27×mth, n+9×mth, n+2×mth, nth, n+4×mth, n+12×mth, and n+22×mth, respectively, the pixels of the first to seventh columns which form the fifth row of the partly lacking matrix are turned on n+21×mth, n+11×mth, n+3×mth, n+mth, n+5×mth, n+17×mth, and n+33×mth, respectively, the pixels of the second to seventh columns which form the sixth row of the partly lacking matrix are turned on n+25×mth, n+15×mth, n+7×mth, n+13×mth, n+29×mth, and n+37×mth, respectively, the pixels of the second to fifth columns which form the seventh row of the partly lacking matrix are turned on n+35×mth, n+31×mth, n+23×mth, and n+19×mth, respectively, and the pixel of the second column which forms the eighth row of the partly lacking matrix is turned on n+39×mth, m and n being arbitrary natural numbers, the turn-on order of the pixels being set so that dots having shapes same as each other individually grow from a plurality of points, and an image forming step of selecting the pixels from the starting pixel in the turn-on order to the pixel to which a predetermined turn-on order number is set in the binarization dither matrix pattern in accordance with the turn-on order based on a pixel value of an inputted multi-value image to determine the pixels on which a color material is to be formed and forming the color material on the determined pixels to form an image.

In the binarization dither matrix pattern, the rectangular pattern to which the turn-on order is set may be turned 90 or 270 degrees. Or, in the binarization dither matrix pattern, the turn-on order number set to an arbitrary pixel in the rectangular pattern and the turn-on order number set to a pixel at a point symmetric to the pixel with respect to the center of the rectangular pattern may be exchanged for each other.

According to a yet further aspect of the present invention, there is provided a printing apparatus, comprising a storage area for expanding a multi-value image, and an image forming section for binarizing the multi-value image expanded in the storage area using a binarization dither matrix pattern and forming an image based on a result of the binarization, and wherein the binarization dither matrix pattern is configured as a rectangular pattern wherein a plurality of pixels to be turned on successively are arranged in a matrix, and the rectangular pattern includes a plurality of basic patterns formed such that, in a partly lacking matrix having four rows and three columns, the pixels of the first to third columns which form the first row of the partly lacking matrix are turned on 7th, 5th, and 9th, respectively, the pixels of the first to third columns which form the second row of the partly lacking matrix are turned on 4th, 1st, and 3rd, respectively, the pixels of the first to third columns which form the third row of the partly lacking matrix are turned on 6th, 2nd, and 8th, respectively, and the pixel of the first column which forms the fourth row of the partly lacking matrix is turned on 10th, and the turn-on order of the pixels is set so that dots having shapes same as each other individually grow in order from a plurality of points.

According to a yet further aspect of the present invention, there is provided a printing apparatus, comprising a storage area for expanding a multi-value image, and an image forming section for binarizing the multi-value image expanded in the storage area using a binarization dither matrix pattern and forming an image based on a result of the binarization, and wherein the binarization dither matrix pattern is configured as a rectangular pattern wherein a plurality of pixels to be turned on successively are arranged in a matrix, and the rectangular pattern includes a plurality of sub patterns formed by arranging m basic patterns formed such that, in a partly lacking matrix having four rows and three columns, the pixels of the first to third columns which form the first row of the partly lacking matrix are turned on n+6×mth, n+4×mth, and n+8×mth, respectively, the pixels of the first to third columns which form the second row of the partly lacking matrix turned on n+3×mth, nth, and n+2×mth, respectively, the pixels of the first to third columns which form the third row of the partly lacking matrix are turned on n+5×mth, n+mth, and n+7×mth, respectively, and the pixel of the first column which forms the fourth row of the partly lacking matrix is turned on n+9×mth, m and n being arbitrary natural numbers, and the turn-on order of the pixels is set so that dots having shapes same as each other individually grow in order based on the plurality of sub patterns.

According to a yet further aspect of the present invention, there is provided a printing apparatus, comprising a storage area for expanding a multi-value image, and an image forming section for binarizing the multi-value image expanded in the storage area using a binarization dither matrix pattern and forming an image based on a result of the binarization, and wherein the binarization dither matrix pattern is configured as a rectangular pattern wherein a plurality of pixels to be turned on successively are arranged in a matrix, and the rectangular pattern includes a plurality of basic patterns formed such that, in a partly lacking matrix having five rows and four columns, the pixels of the first to fourth columns which form the first row of the partly lacking matrix are turned on 14th, 6th, 12th, and 16th, respectively, the pixels of the first to fourth columns which form the second row of the partly lacking matrix are turned on 10th, 2nd, 4th, and 8th, respectively, the pixels of the first to fourth columns which form the third row of the partly lacking matrix are turned on 5th, 1st, 3rd, and 11th, respectively, the pixels of the first to fourth columns which form the fourth row of the partly lacking matrix are turned on 13th, 9th, 7th, and 15th, respectively, and the pixel of the first column which forms the fifth row of the partly lacking matrix is turned on 17th, and the turn-on order of the pixels is set so that dots having shapes same as each other individually grow in order from a plurality of points.

According to a yet further aspect of the present invention, there is provided a printing apparatus, comprising a storage area for expanding a multi-value image, and an image forming section for binarizing the multi-value image expanded in the storage area using a binarization dither matrix pattern and forming an image based on a result of the binarization, and wherein the binarization dither matrix pattern is configured as a rectangular pattern wherein a plurality of pixels to be turned on successively are arranged in a matrix, and the rectangular pattern includes a plurality of sub patterns formed by arranging m basic patterns formed such that, in a partly lacking matrix having five rows and four columns, the pixels of the first to fourth column which form the first row of the partly lacking matrix are turned on n+13×mth, n+5×mth, n+11×mth, and n+15×mth, respectively, the pixels of the first to fourth columns which form the second row of the partly lacking matrix are turned on n+9×mth, n+mth, n+3×mth, and n+7×mth, respectively, the pixels of the first to fourth columns which form the third row of the partly lacking matrix are turned on n+4×mth, nth, n+2×mth, and n+10×mth, respectively, the pixels of the first to fourth columns which form the fourth row of the partly lacking matrix are turned on n+12×mth, n+8×mth, n+6×mth, and n+14×mth, respectively, and the pixel of the first column which forms the fifth row of the partly lacking matrix is turned on n+16×mth, m and n being arbitrary natural numbers, and the turn-on order of the pixels is set so that dots having shapes same as each other individually grow in order based on the plurality of sub patterns.

According to a yet further aspect of the present invention, there is provided a printing apparatus, comprising a storage area for expanding a multi-value image, and an image forming section for binarizing the multi-value image expanded in the storage area using a binarization dither matrix pattern and forming an image based on a result of the binarization, and wherein the binarization dither matrix pattern is configured as a rectangular pattern wherein a plurality of pixels to be turned on successively are arranged in a matrix, and the rectangular pattern includes a plurality of basic patterns formed such that, in a partly lacking matrix having six rows and five columns, the pixels of the first to fifth columns which form the first row of the partly lacking matrix are turned on 23rd, 15th, 13th, 21st, and 25th, respectively, the pixels of the first to fifth columns which form the second row of the partly lacking matrix are turned on 19th, 7th, 5th, 9th, and 17th, respectively, the pixels of the first to fifth columns which form the third row of the partly lacking matrix are turned on 12th, 4th, 1st, 3rd, and 11th, respectively, the pixels of the first to fifth columns which form the fourth row of the partly lacking matrix are turned on 14th, 6th, 2nd, 8th, and 20th, respectively, the pixels of the first to fifth columns which form the fifth row of the partly lacking matrix are turned on 22nd, 18th, 10th, 16th, and 24th, respectively, and the pixel of the first column which forms the sixth row of the partly lacking matrix is turned on 26th, and the turn-on order of the pixels is set so that dots having shapes same as each other individually grow in order from a plurality of points.

According to a yet further aspect of the present invention, there is provided a printing apparatus, comprising a storage area for expanding a multi-value image, and an image forming section for binarizing the multi-value image expanded in the storage area using a binarization dither matrix pattern and forming an image based on a result of the binarization, and wherein the binarization dither matrix pattern is configured as a rectangular pattern wherein a plurality of pixels to be turned on successively are arranged in a matrix, and the rectangular pattern includes a plurality of sub patterns formed by arranging m basic patterns formed such that, in a partly lacking matrix having six rows and five columns, the pixels of the first to fifth columns which form the first row of the partly lacking matrix are turned on n+22×mth, n+14×mth, n+12×mth, n+20×mth, and n+24×mth, respectively, the pixels of the first to fifth columns which form the second row of the partly lacking matrix are turned on n+18×mth, n+6×mth, n+4×mth, n+8×mth, and n+16×mth, respectively, the pixels of the first to fifth columns which form the third row of the partly lacking matrix are turned on n+11×mth, n+3×mth, nth, n+2×mth, and n+10×mth, respectively, the pixels of the first to fifth columns which form the fourth row of the partly lacking matrix are turned on n+13×mth, n+5×mth, n+mth, n+7×mth, and n+19×mth, respectively, the pixels of the first to fifth columns which form the fifth row of the partly lacking matrix are turned on n+21×mth, n+17×mth, n+9×mth, n+15×mth, and n+23×mth, respectively, and the pixel of the first column which forms the sixth row of the partly lacking matrix is turned on n+25×mth, m and n being arbitrary natural numbers, and the turn-on order of the pixels is set so that dots having shapes same as each other individually grow in order based on the plurality of sub patterns.

According to a yet further aspect of the present invention, there is provided a printing apparatus, comprising a storage area for expanding a multi-value image, and an image forming section for binarizing the multi-value image expanded in the storage area using a binarization dither matrix pattern and forming an image based on a result of the binarization, and wherein the binarization dither matrix pattern is configured as a rectangular pattern wherein a plurality of pixels to be turned on successively are arranged in a matrix, and the rectangular pattern includes a plurality of basic patterns formed such that, in a partly lacking matrix having seven rows and six columns, the pixels of the first to sixth columns which form the first row of the partly lacking matrix are turned on 34th, 26th, 14th, 24th, 32nd, and 36th, respectively, the pixels of the first to sixth columns which form the second row of the partly lacking matrix are turned on 30th, 16th, 8th, 12th, 20th, and 28th, respectively, the pixels of the first to sixth columns which form the third row of the partly lacking matrix are turned on 22nd, 6th, 2nd, 4th, 10th, and 18th, respectively, the pixels of the first to sixth columns which form the fourth row of the partly lacking matrix are turned on 15th, 5th, 1st, 3rd, 11th, and 23rd, respectively, the pixels of the first to sixth columns which form the fifth row of the partly lacking matrix are turned on 25th, 13th, 7th, 9th, 19th, and 31st, respectively, the pixels of the first to sixth columns which form the sixth row of the partly lacking matrix are turned on 33rd, 29th, 21st, 17th, 27th, and 35th, respectively, and the pixel of the first column which forms the seventh row is turned on 37th, and the turn-on order of the pixels is set so that dots having shapes same as each other individually grow in order from a plurality of points.

According to a yet further aspect of the present invention, there is provided a printing apparatus, comprising a storage area for expanding a multi-value image, and an image forming section for binarizing the multi-value image expanded in the storage area using a binarization dither matrix pattern and forming an image based on a result of the binarization, and wherein the binarization dither matrix pattern is configured as a rectangular pattern wherein a plurality of pixels to be turned on successively are arranged in a matrix, and the rectangular pattern includes a plurality of sub patterns formed by arranging m basic patterns formed such that, in a partly lacking matrix having seven rows and six columns, the pixels of the first to sixth columns which form the first row of the partly lacking matrix are turned on n+33×mth, n+25×mth, n+13×mth, n+23×mth, n+31×mth, and n+35×mth, respectively, the pixels of the first to sixth columns which form the second row of the partly lacking matrix are turned on n+29×mth, n+15×mth, n+7×mth, n+11×mth, n+19×mth, and n+27×mth, respectively, the pixels of the first to sixth columns which form the third row of the partly lacking matrix are turned on n+21×mth, n+5×mth, n+mth, n+3×mth, n+9×mth, and n+17×mth, respectively, the pixels of the first to sixth columns which form the fourth row of the partly lacking matrix are turned on n+14×mth, n+4×mth, nth, n+2×mth, n+10×mth, and n+22×mth, respectively, the pixels of the first to sixth columns which form the fifth row of the partly lacking matrix are turned on n+24×mth, n+12×mth, n+6×mth, n+8×mth, n+18×mth, and n+30×mth, respectively, the pixels of the first to sixth columns which form the sixth row of the partly lacking matrix are turned on n+32×mth, n+28×mth, n+20×mth, n+16×mth, n+26×mth, and n+34×mth, respectively, and the pixel of the first column which forms the seventh row of the partly lacking matrix is turned on n+36×mth, m and n being arbitrary natural numbers, and the turn-on order of the pixels is set so that dots having shapes same as each other individually grow in order based on the plurality of sub patterns.

According to a yet further aspect of the present invention, there is provided a printing apparatus, comprising a storage area for expanding a multi-value image, and an image forming section for binarizing the multi-value image expanded in the storage area using a binarization dither matrix pattern and forming an image based on a result of the binarization, and wherein the binarization dither matrix pattern is configured as a rectangular pattern wherein a plurality of pixels to be turned on successively are arranged in a matrix, and the rectangular pattern includes a plurality of basic patterns formed such that, in a partly lacking matrix having eight rows and seven columns, the pixels of the fourth to sixth columns which form the first row of the partly lacking matrix are turned on 29th, 35th, and 39th, respectively, the pixels of the first to sixth columns which form the second row of the partly lacking matrix are turned on 37th, 27th, 15th, 17th, 25th, and 31st, respectively, the pixels of the first to sixth columns which form the third row of the partly lacking matrix are turned on 33rd, 21st, 9th, 7th, 11th, and 19th, respectively, the pixels of the first to seventh columns which form the fourth row of the partly lacking matrix are turned on 28th, 10th, 3rd, 1st, 5th, 13th, and 23rd, respectively, the pixels of the first to seventh columns which form the fifth row of the partly lacking matrix are turned on 22nd, 12th, 4th, 2nd, 6th, 18th, and 34th, respectively, the pixels of the second to seventh columns which form the sixth row of the partly lacking matrix are turned on 26th, 16th, 8th, 14th, 30th, and 38th, respectively, the pixels of the second to fifth columns which form the seventh row of the partly lacking matrix are turned on 36th, 32nd, 24th, and 20th, respectively, and the pixel of the second column which forms the eighth row of the partly lacking matrix is turned on 40th, and the turn-on order of the pixels is set so that dots having shapes same as each other individually grow in order from a plurality of points.

According to a yet further aspect of the present invention, there is provided a printing apparatus, comprising a storage area for expanding a multi-value image, and an image forming section for binarizing the multi-value image expanded in the storage area using a binarization dither matrix pattern and forming an image based on a result of the binarization, and wherein the binarization dither matrix pattern is configured as a rectangular pattern wherein a plurality of pixels to be turned on successively are arranged in a matrix, and the rectangular pattern includes a plurality of sub patterns formed by arranging m basic patterns formed such that, in a partly lacking matrix having eight rows and seven columns, the pixels of the fourth to sixth columns which form the first row of the partly lacking matrix are turned on n+28×mth, n+34×mth, and n+38×mth, respectively, the pixels of the first to sixth columns which form the second row of the partly lacking matrix are turned on n+36×mth, n+26×mth, n+14×mth, n+16×mth, n+24×mth, and n+30×mth, respectively, the pixels of the first to sixth columns which form the third row of the partly lacking matrix are turned on n+32×mth, n+20×mth, n+8×mth, n+6×mth, n+10×mth, and n+18×mth, respectively, the pixels of the first to seventh columns which form the fourth row of the partly lacking matrix are turned on n+27×mth, n+9×mth, n+2×mth, nth, n+4×mth, n+12×mth, and n+22×mth, respectively, the pixels of the first to seventh columns which form the fifth row of the partly lacking matrix are turned on n+21×mth, n+11×mth, n+3×mth, n+mth, n+5×mth, n+17×mth, and n+33×mth, respectively, the pixels of the second to seventh columns which form the sixth row of the partly lacking matrix are turned on n+25×mth, n+15×mth, n+7×mth, n+13×mth, n+29×mth, and n+37×mth, respectively, the pixels of the second to fifth columns which form the seventh row of the partly lacking matrix are turned on n+35×mth, n+31×mth, n+23×mth, and n+19×mth, respectively, and the pixel of the second column which forms the eighth row of the partly lacking matrix is turned on n+39×mth, m and n being arbitrary natural numbers, and the turn-on order of the pixels is set so that dots having shapes same as each other individually grow in order based on the plurality of sub patterns.

In the binarization dither matrix pattern, the rectangular pattern to which the turn-on order is set may be turned 90 or 270 degrees. Or, in the binarization dither matrix pattern, the turn-on order number set to an arbitrary pixel in the rectangular pattern and the turn-on order number set to a pixel at a point symmetric to the pixel with respect to the center of the rectangular pattern may be exchanged for each other.

With the printing methods and the printing apparatus of the present invention, the following effects or advantages can be anticipated.

(1) A binarization dither matrix pattern wherein the turn-on order of pixels is set so that dots having shapes same as each other individually grow in order from a plurality of points is used to binarize a multi-value image, and an image is formed based on a result of the binarization. Consequently, moirés and artifacts (artificial stripe patterns) can be reduced.

(2) Since concentrated image formation can be performed, even where printing of a high resolution is effected, a color material (toner, ink or the like) can be formed stably on a printing medium (such as print paper).

(3) Since the dither angle of the binarization dither matrix pattern is close to 15 degrees, vertical stripe patterns, moirés and so forth which are not involved in an original image and appear on a printed matter from a mechanical characteristic of a printing apparatus (such as, for example, elongation or contraction of an elastic member used in a printing engine) can be made less conspicuous.

(4) Even if a rectangular pattern in the binarization dither matrix pattern in which the turn-on order is set is turned by 90 degrees or 270 degrees, moirés and artifacts can still be reduced.

(5) Even if the turn-on order in the binarization dither matrix pattern is changed through a lookup table, moirés and artifacts can still be reduced.

The above and other objects, features and advantages of the present invention will become apparent from the following description and the appended claims, taken in conjunction with the accompanying drawings in which like parts or elements are denoted by like reference characters.

### BRIEF DESCRIPTION OF THE DRAWINGS

FIG. 1 is a block diagram schematically showing a functional configuration of a printing system as an embodiment of the present invention;

FIG. 2 is a block diagram schematically showing a hardware configuration of the printing system as the embodiment of the present invention;

FIGS. 3(a) and 3(b) are views showing a binarization pattern (binarization dither matrix pattern) used in a printing apparatus of the embodiment of the present invention;

FIG. 4 is a view showing a basic pattern of the binarization pattern used in the printing apparatus of the embodiment of the present invention;

FIG. 5 is a view illustrating a forming method of the binarization pattern used in the printing apparatus of the embodiment of the present invention;

FIG. 6 is a view showing an example of a one-dimensional lookup table used in the printing apparatus of the embodiment of the present invention; and

FIGS. 7 to 26 are views individually showing modification to the binarization pattern used in the printing apparatus of the embodiment of the present invention.

### DESCRIPTION OF THE PREFERRED EMBODIMENT

In the following, an embodiment of the present invention is described with reference to the drawings.

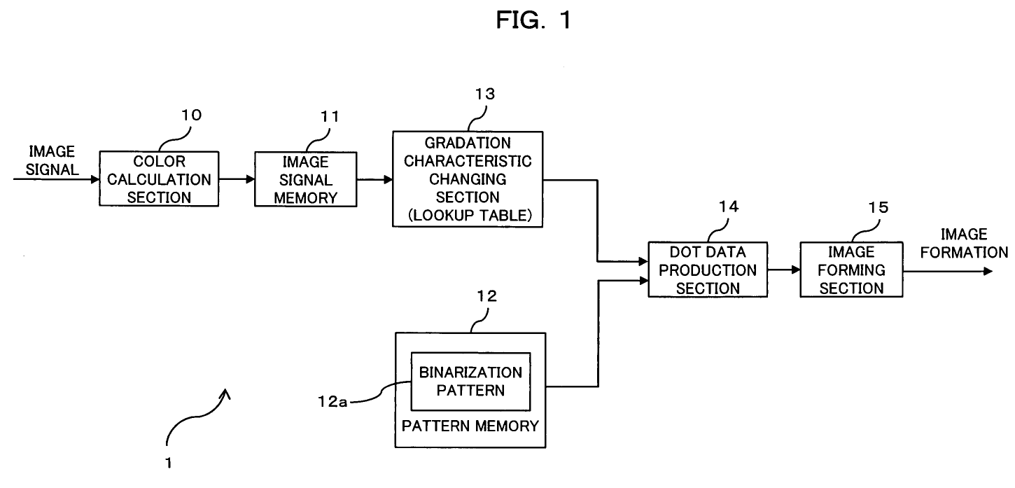

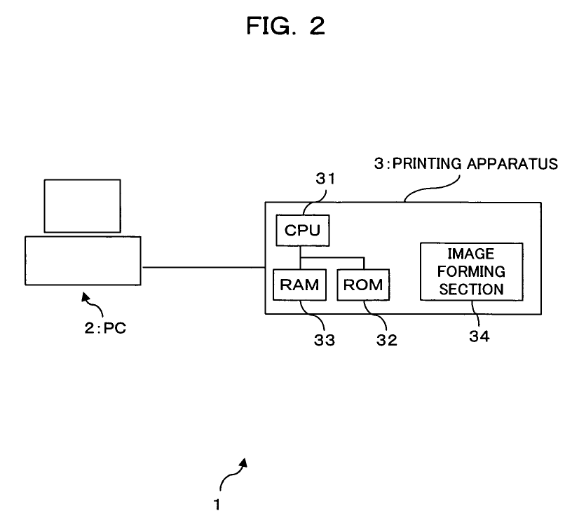

FIG. 1 is a block diagram schematically showing a functional configuration of a printing system as an embodiment of the present invention, and FIG. 2 is a block diagram schematically showing a hardware configuration of the printing system.

As shown in FIG. 2, the printing system 1 includes a personal computer (PC) 2 and a printing apparatus 3. The printing system 1 binarizes a multi-value image produced or acquired by the PC 2 using a binarization pattern (binarization dither matrix pattern; hereinafter described in detail) to control ON/OFF of a color material and forms (prints) an image based on a result of the binarization. Further, the printing system represents a multi-value image depending upon the magnitude of microscopic dots (halftone dots) of a color material placed on the surface of paper, a film, a printing plate or the like, and represents the density of the image depending upon an area ratio of dots to a unit area.

The printing apparatus 3 forms (spots) a color material (such as toner, ink or the like) on a medium such as printing paper used in, for example, an ink jet printer, a laser beam printer, a thermal transfer printer, a sublimation type printer, an LED printer, a printing press and so forth to form (print) an image. Further, the printing apparatus 3 represents a gradation of a multi-value image (continuous color tone image) depending upon the area of a color material (dots) to be formed on a printing medium.

It is to be noted that, in the present embodiment, it is assumed that each of pixels which are an object of the binarization process individually has a value (multi-value), for example, one of 0 to 255, and each of the pixels after the binarization (halftone) process individually has a value (binary value) or either 0 or 255. Even if the definition just described is applied, the generality is not lost.

The printing apparatus 3 includes a CPU (Central Processing Unit) 31, a ROM (Read Only Memory) 32, a RAM (Random Access Memory) 33 and an image forming section 34. An application program (binarization program, printing program) for implementing a color calculation section 10, a gradation characteristic changing section 13 and a dot data production section 14 hereinafter described is stored in the ROM 32. If the CPU 31 executes the application program from the ROM 32, then functions (hereinafter described in detail) as the color calculation section 10, gradation characteristic changing section 13 and dot data production section 14 are implemented, and as a result, the printing method of the present invention is implemented.

Here, a computer is a concept including hardware and an operation system and signifies hardware which operates under the control of the operation system. Further, where the operation system is not necessary and hardware is operated only by the application program, the hardware itself corresponds to a computer. The hardware at least includes a microprocessor such as a CPU (Central Processing Unit) and means for reading out a computer program recorded on a recording medium.

It is to be noted that, in the present embodiment, a computer is a concept including hardware and an operation system and signifies hardware which operates under the control of the operation system. Further, where the operating system is not necessary and hardware is operated only by the application program, the hardware itself corresponds to a computer. The hardware at least includes a microprocessor such as a CPU and means for reading out a computer program recorded on a recording medium. In the present embodiment, the printing apparatus 3 has a function as a computer.

Further, the program (binarization program, printing program) for implementing the functions of the color calculation section 10, gradation characteristic changing section 13 and dot data production section 14 is provided in a form wherein the program is recorded on a computer-readable recording medium such as, for example, a flexible disk, CD-ROM, CD-R, CD-R/W, DVD, DVD-R, DVD-R/W, magnetic disk, optical disk, magneto-optical disk and so forth. Then, the computer reads out the program from the recording medium and transfers it to an internal storage apparatus or an external storage apparatus to store and use it. Alternatively, the program may be recorded in advance on a storage apparatus (recording medium) such as, for example, a magnetic disk, optical disk, magneto-optical disk or the like, and provided from the storage apparatus to the computer through a communication path.

When the functions as the color calculation section 10, gradation characteristic changing section 13 and dot data production section 14 are to be implemented, the program stored in an internal storage apparatus (in the present embodiment, a RAM or a ROM of the printer) is executed by a microprocessor (in the present embodiment, the CPU of the printer) of the computer. At this time, the computer may alternatively read out and execute the program recorded on a recording medium.

Further, as a recording medium in the present embodiment, not only a flexible disk, CD-ROM, CD-R, CD-R/W, DVD, DVD-R, DVD-R/W, magnetic disk, optical disk, and magneto-optical disk described above but also various computer-readable media such as an IC card, a ROM cartridge, a magnetic tape, a punched card, an internal storage apparatus (memory such as a RAM and ROM) and an external storage apparatus of the computer, a printed matter on which a code such as a barcode is printed and so forth can be utilized.

The printing system 1 produces dots on the surface of paper, a film, a printing plate or the like based on an image signal of a multi-value image. As shown in FIG. 1, the printing system includes the color calculation section 10, an image signal memory (storage area) 11, a pattern memory (binarization dither matrix pattern setting section) 12, the gradation characteristic changing section 13, the dot data production section (selection binarization pattern production section) 14 and an image forming section 15.

The color calculation section 10 performs color calculation regarding an image signal of a multi-value image. In particular, the color calculation section 10 performs several processes such as color modification, gradation correction, ink plate generation, base color removal, sharpness emphasis and so forth for an inputted image signal (represented, for example, with pixel values ranging from 0 to 255).

The image signal memory 11 stores an image signal processed by the color calculation section 10 and functions as a storage area for expanding a multi-value image.

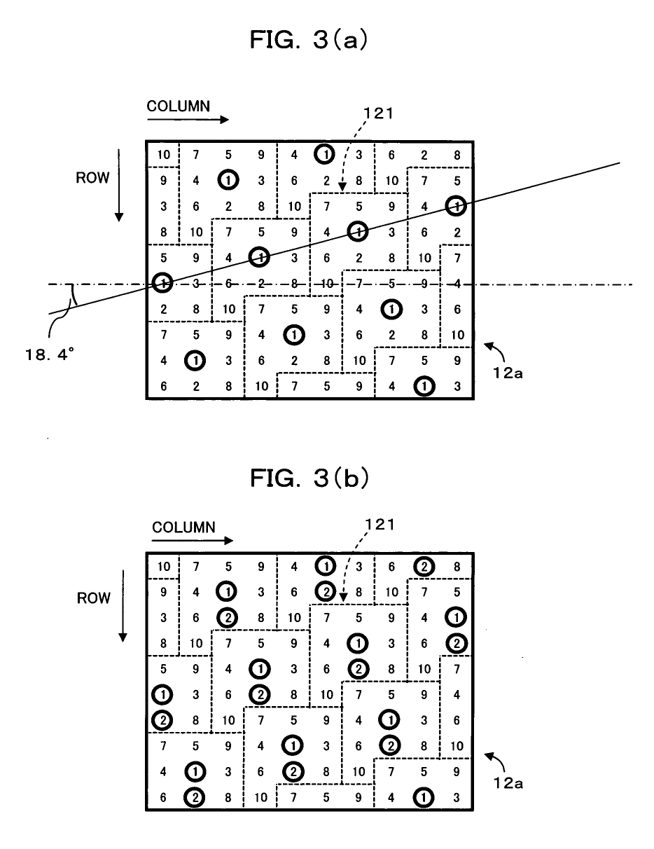

The pattern memory 12 stores such a binarization dither matrix pattern (hereinafter referred to sometimes as binarization pattern) 12a as shown in FIG. 3(a). It is to be noted that actually the binarization program and the printing program are stored in the RAM (Random Access Memory) 33, ROM (Read Only Memory) 32 or some other storage medium (for example, a storage apparatus of the PC 2 or the like). If the CPU 31 of the printing apparatus 3 or the CPU (not shown) of the PC executes the binarization program or printing program, then the pattern memory 12 is implemented, and as a result, it can be considered that the binarization pattern 12a is stored in the pattern memory 12.

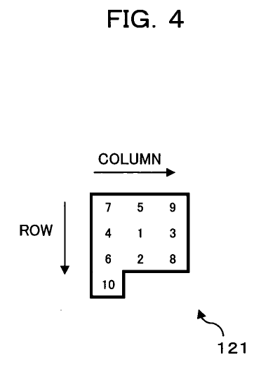

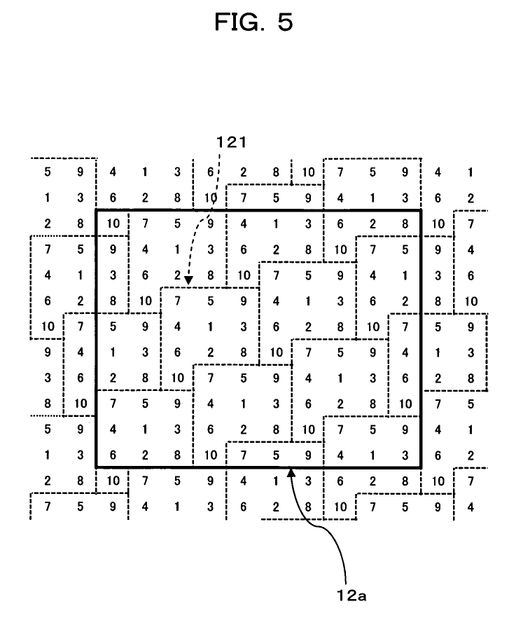

FIGS. 3(a) and 3(b) are views showing a binarization pattern (binarization dither matrix pattern) 12a used in the printing apparatus of the embodiment of the present invention, FIG. 4 is a view showing a basic pattern of the binarization pattern 12a, and FIG. 5 is a view illustrating a forming method of the binarization pattern 12a. It is to be noted that, in FIGS. 3(a), 3(b) and 4, numerical values indicate turn-on order numbers of pixels. Further, in the binarization pattern 12a shown in FIG. 3(a), ◯ is applied to those pixels whose turn-on order number is 1, and, in the binarization pattern 12a shown in FIG. 3(b), ◯ is applied to those pixels whose turn-on order number is 1 and 2. Further, in the binarization patterns 12a shown in FIGS. 3(a) and 3(b), a portion of the basic pattern thereof (refer to FIG. 4; hereinafter described in detail) is shown enclosed by a broken line.

The binarization pattern 12a is a rectangular pattern wherein a plurality of pixels to be successively turned on are arranged in a matrix. As shown in FIGS. 3(a) and 3(b), the binarization pattern 12a is formed from one hundred pixels arranged in a matrix of ten rows and ten columns (rectangular pattern). An order (hereinafter referred to as turn-on order) in which a color material (such as toner, ink or the like) is to be formed (turned on) is set to the picture elements.

As shown in FIGS. 3(a) and 3(b), in the binarization pattern 12a, the turn-on order is set so that dots having shapes same as each other individually grow in order from a plurality of points (in the binarization pattern 12a, those pixels to which the numerical value 1 is applied).

As shown in FIG. 5, the binarization pattern 12a is formed by repetitively placing the basic pattern 121 shown in FIG. 4 in a vertical direction and a transverse direction. As shown in FIG. 4, the basic pattern 121 is formed by cutting away part of a rectangular matrix formed from twelve pixels of four rows and three columns. In the present embodiment, the basic pattern 121 is formed by cutting away two pixels at the lower right positions (in particular, the pixels of the second and third columns of the fourth row). Such a partly cut away matrix as just described is hereinafter referred to as partly lacking matrix.

Further, in the basic pattern (partly lacking matrix) 121, the turn-on order is set so that a dot grows in a substantially circular form as seen from FIG. 4. In particular, if a pixel already turned on and positioned nearest to a specific point (in the present embodiment, the center of the figure of the basic pattern 121) in the basic pattern 121 exists, then an unturned on pixel adjacent the turned on pixel is turned on, and then a pixel at a point-symmetric position with respect to the specific point of the basic pattern 121 is turned on.

In particular, in the basic pattern 121 shown in FIG. 4, a color material is placed on pixels in order from a pixel having a low order number to another pixel having a higher order number. Consequently, a dot grows in a substantially circular form in order from the center of the figure (the specific point) of the basic pattern, and the binarization pattern 12a functions as a dot concentration type binarization pattern (binarization dither matrix pattern; dither pattern).

The basic pattern 121 is formed such that, in the partly lacking matrix having four rows and three columns, the pixels of the first to third columns which form the first row of the partly lacking matrix are turned on 7th, 5th, and 9th, respectively; the pixels of the first to third columns which form the second row of the partly lacking matrix are turned on 4th, 1st, and 3rd, respectively; the pixels of the first to third columns which form the third row of the partly lacking matrix are turned on 6th, 2nd, and 8th, respectively; and the pixel of the first column which forms the fourth row of the partly lacking matrix is turned on 10th.

As shown in FIG. 5, the binarization pattern 12a is formed by arranging such basic patterns (partly lacking matrixes) 121 such that the lacking portion (in FIG. 4, a lower right portion) of each basic pattern 121 is fitted with a portion (in FIG. 4, an upper left portion) of another basic pattern 121 at a point-symmetric position with respect to the center of the figure in the basic pattern 121 and a turn-on order appears repetitively and successively in a vertical direction (row arrangement direction) and a transverse direction (column arrangement direction) of the binarization pattern 12a without a clearance left therebetween and then cutting out an arbitrary rectangular portion (refer to a thick line of FIG. 5) of ten rows and ten columns from the arranged basic patterns 121.

Further, in the binarization pattern 12a, the turn-on order is set so that dots having shapes same as each other individually grow in order from the basic patterns 121 provided in the binarization pattern 12a.

In particular, in the binarization pattern 12a, the turn-on order of one hundred pixels is set such that:

(1) the pixels of the first to tenth columns which form the first row of the rectangular pattern are turned on 10th, 7th, 5th, 9th, 4th, 1st, 3rd, 6th, 2nd, and 8th, respectively;

(2) the pixels of the first to tenth columns which form the second row of the rectangular pattern are turned on 9th, 4th, 1st, 3rd, 6th, 2nd, 8th, 10th, 7th, and 5th, respectively;

(3) the pixels of the first to tenth columns which form the third row of the rectangular pattern are turned on 3rd, 6th, 2nd, 8th, 10th, 7th, 5th, 9th, 4th, and 1st, respectively;

(4) the pixels of the first to tenth columns which form the fourth row of the rectangular pattern are turned on 8th, 10th, 7th, 5th, 9th, 4th, 1st, 3rd, 6th, and 2nd, respectively;

(5) the pixels of the first to tenth columns which form the fifth row of the rectangular pattern are turned on 5th, 9th, 4th, 1st, 3rd, 6th, 2nd, 8th, 10th, and 7th, respectively;

(6) the pixels of the first to tenth columns which form the sixth row of the rectangular pattern are turned on 1st, 3rd, 6th, 2nd, 8th, 10th, 7th, 5th, 9th, and 4th, respectively;

(7) the pixels of the first to tenth columns which form the seventh row of the rectangular pattern are turned on 2nd, 8th, 10th, 7th, 5th, 9th, 4th, 1st, 3rd, and 6th, respectively;

(8) the pixels of the first to tenth columns which form the eighth row of the rectangular pattern are turned on 7th, 5th, 9th, 4th, 1st, 3rd, 6th, 2nd, 8th, and 10th, respectively;

(9) the pixels of the first to tenth columns which form the ninth row of the rectangular pattern are turned on 4th, 1st, 3rd, 6th, 2nd, 8th, 10th, 7th, 5th, and 9th, respectively; and

(10) the pixels of the first to tenth columns which form the tenth row of the rectangular pattern are turned on 6th, 2nd, 8th, 10th, 7th, 5th, 9th, 4th, 1st, and 3rd, respectively.

Further, in the binarization pattern 12a, as shown in FIG. 3(a), the angle formed by a line (refer to a solid line with respect to an alternate long and short dash line in FIG. 3(a)) which interconnects the centers of the figures of the basic patterns 121 adjacent each other in a transverse direction, that is, the dither angle (screen angle, halftone dot angle), is 18.4 degrees.

In particular, the binarization pattern 12a shown in FIG. 3(a) is a binarization pattern having a dither angle of 18.4 degrees and an output line number (unit: lpi (line per inch)) of 190.0 lpi.

It is to be noted that, by using such a binarization pattern 12a as described above, the pixel value (for example, within a range from 0 to 255) of each of pixels which form a multi-value image (original image) to be printed can be represented in eleven stages (gradations).

In particular, in the binarization pattern 12a, the basic pattern 121 shown in FIG. 4 forms a single dot. Then, in the basic pattern 121, dots having ten different sizes ranging from a minimum dot where only one pixel whose turn-on order number is 1 is turned on to a maximum dot where all of the pixels whose turn-on order number ranges from 1 to 10 are turned on can be formed. Consequently, the pixel value of each of the pixels which form an original image can be represented in eleven stages.

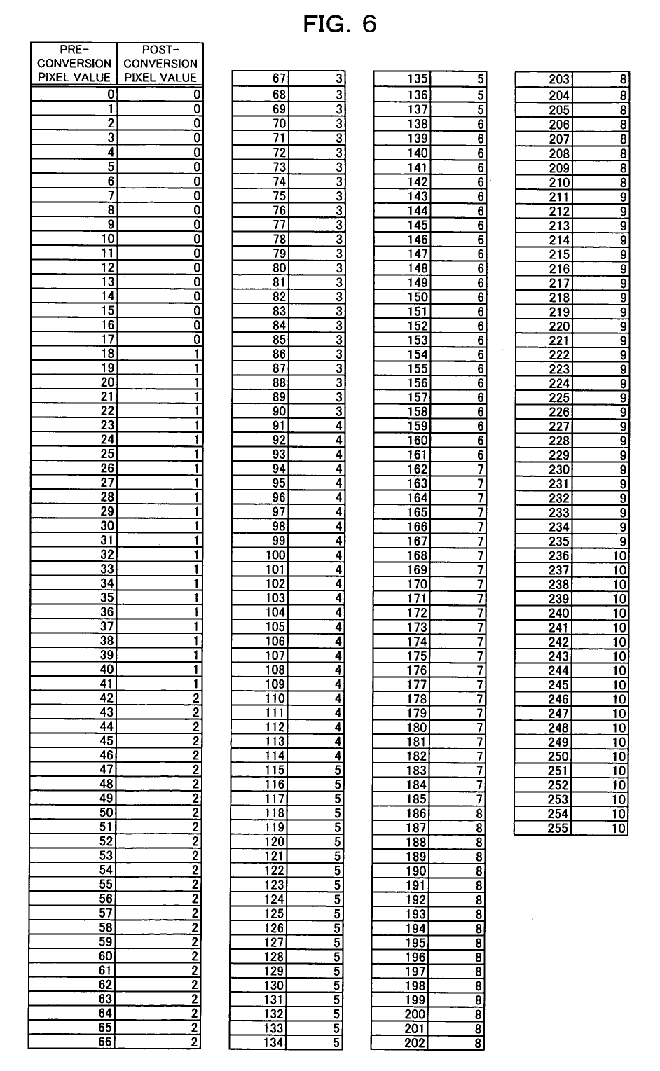

The gradation characteristic changing section 13 converts the pixel value of each of pixels in an image signal based on a one-dimensional lookup table (lookup table; refer to FIG. 6) provided in advance. FIG. 6 is a view showing an example of a one-dimensional lookup table used in the printing apparatus of the embodiment of the present invention. The gradation characteristic changing section 13 converts the pixel values of an image signal based on such a one-dimensional lookup table as shown in FIG. 6 and passes the converted pixel values to the dot data production section 14 thereby to change the turn-on order.

In particular, the gradation characteristic (characteristic of an image) can be arbitrarily changed by arbitrarily changing any value of the one-dimensional lookup table. It is to be noted that, the gradation characteristic changing section 13 functions as a turn-on order changing section for changing the turn-on order based on the lookup table.

Further, upon changing of the turn-on order based on the lookup table, if the turn-on order is set such that a color material is positioned adjacent a pixel on which the color material is fixed already (turned on already), then the color material is fixed easily, and as a result, the printing quality can be improved.

Further, the turn-on order can be arbitrarily changed through the one-dimensional lookup table. Consequently, adjustment of, for example, a tone curve or the like can be easily performed and moirés or artifacts can be reduced.

Further, while, in the present embodiment, the pixel values of an image signal are changed by the gradation characteristic changing section 13, the changing method of the pixel values is not limited to this, and variations and modifications can be used without departing from the scope of the present invention. For example, the gradation characteristic changing section 13 may change the pixel values based on a lookup table other than that shown in FIG. 3, or changing of the pixel values by the gradation characteristic changing section 13 may not be performed.

The dot data production section (binarization processing section) 14 binarizes an image signal inputted thereto from the gradation characteristic changing section 13 using the binarization pattern 12a recorded in the pattern memory 12 to produce data (dot data) for printing dots by means of the image forming section 15.

In particular, the dot data production section 14 compares a pixel value of an image signal (for example, ranging from 0 to 255) and a threshold value set in advance with each other to determine the number of pixels to be turned on in the binarization pattern 12a. Thereafter, the dot data production section 14 produces such dot data with which the pixels are turned on in accordance with the turn-on order set in the binarization pattern 12a until the number of turned on pixels becomes coincident with the determined number of pixels.

In particular, the dot data production section 14 selects (turns on), in accordance with the turn-on order set in the binarization pattern 12a, those pixels from the starting pixel of the turn-on order (in FIGS. 3(a) and 3(b), the pixel to which 1 is set as its turn-on order number) to a pixel to which the turn-on order number coincident with the determined number of pixels is set in accordance with the turn-on order (in the descending order). The dot data production section 14 thereby decides the pixels on which a color material is to be formed and produces dot data based on resulting information of the decision.

The image forming section 15 prints the dot data produced by the dot data production section 14. For example, in a printing apparatus of the electrostatic printing type, an exposure apparatus or the like functions as the image forming section 15, and, in this case, exposure data is produced as dot data by the dot data production section 14.

In particular, the dot data production section 14 performs binarization for a multi-value image expanded in the image signal memory 11, and thereafter, the image forming section 15 forms an image based on a result of the binarization.

In the printing system 1 of the embodiment of the present invention has the configuration described above, such a binarization pattern 12a as shown in FIG. 3(a) is prepared in advance in the pattern memory 12 (a preparation step). Then, the dot data production section 14 performs several processes such as color modification, gradation correction, ink plate generation, base color removal, sharpness emphasis and so forth for the inputted image signal and then expands the image signal for which the processes have been performed in the image signal memory 11 (an expanding step of expanding a multi-value image in a storage area). Further, the printing apparatus performs conversion of pixel values for the image signal expanded in the image signal memory 11 by means of the gradation characteristic changing section 13 when necessary.

Then, the dot data production section 14 binarizes the image signal using the binarization pattern 12a recorded in the pattern memory 12 (a binarization step), and then produces and inputs dot data to the image forming section 15.

Here, the binarization process in the printing apparatus as the embodiment of the present invention is described below with reference to FIGS. 3(a) and 3(b). In particular, as shown in FIGS. 3(a) and 3(b), the dot data production section 14 selects those pixels ranging from the starting pixel of the turn-on order to the pixel to which the predetermined turn-on order number is set in the binarization pattern 12a in accordance with the turn-on order (in the present embodiment, in the descending order) to decide picture elements on which a color material is to be formed, and then produces dot data. Thereafter, the image forming section 15 forms (prints) an image in accordance with the produced dot data (an image forming step).

In this manner, with the printing apparatus (binarization pattern) as the embodiment of the present invention, dot concentration type printing can be performed, and, in this instance, an image having minimized moirés and artifacts (artificial stripes) can be printed.

Further, since the binarization pattern 12a is configured as a rectangular pattern having ten rows and ten columns, the capacity of the pattern memory 12 into which the binarization pattern 12a is to be recorded can be suppressed small. Consequently, a higher speed binarization process can be achieved, and the fabrication cost of a printing apparatus can be reduced.

Further, by performing binarization using the binarization pattern 12a, concentration type image forming can be performed. Therefore, even where high-resolution printing is performed, a color material (such as toner, ink or the like) can be formed stably on a printing medium (such as printing paper).

Further, in the binarization pattern 12a, the dither angle is 18.4 degrees. Therefore, from a mechanical characteristic (such as, for example, expansion and contraction of an elastic member used for a printing engine) of the printing apparatus 3, stripe patterns, moirés and so forth which appear on a printed matter and do not exist on an original image can be made less conspicuous.

Further, the present invention is not limited to the embodiment specifically described above, and variations and modifications can be made without departing from the scope of the present invention.

For example, in the embodiment described above, the dot data production section 14 performs the binarization process using the binarization pattern 12a shown in FIGS. 3(a) and 3(b). However, the pattern used for a binarization process is not limited to the binarization pattern 12a, and variations and modifications can be made without departing from the scope of the present invention.

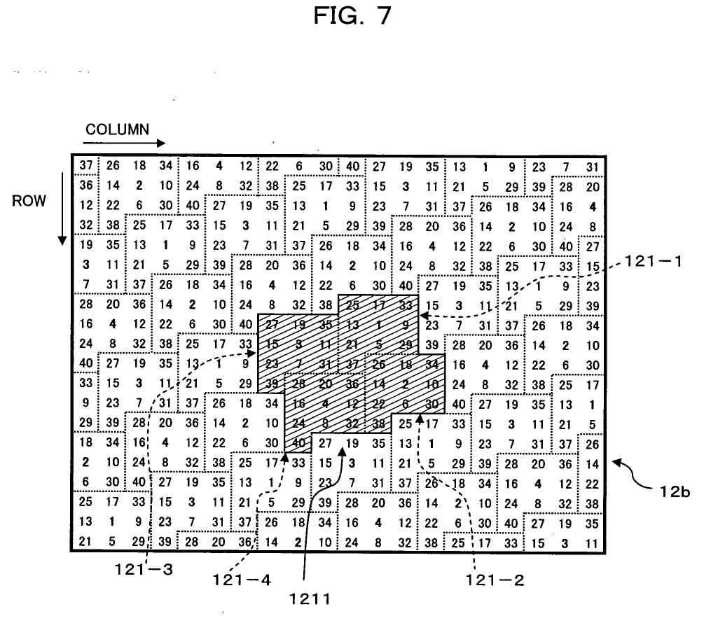

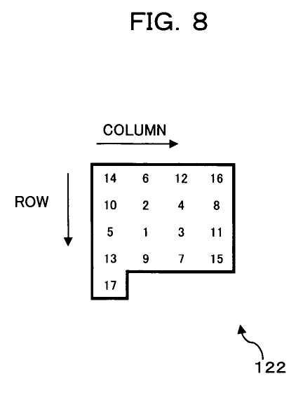

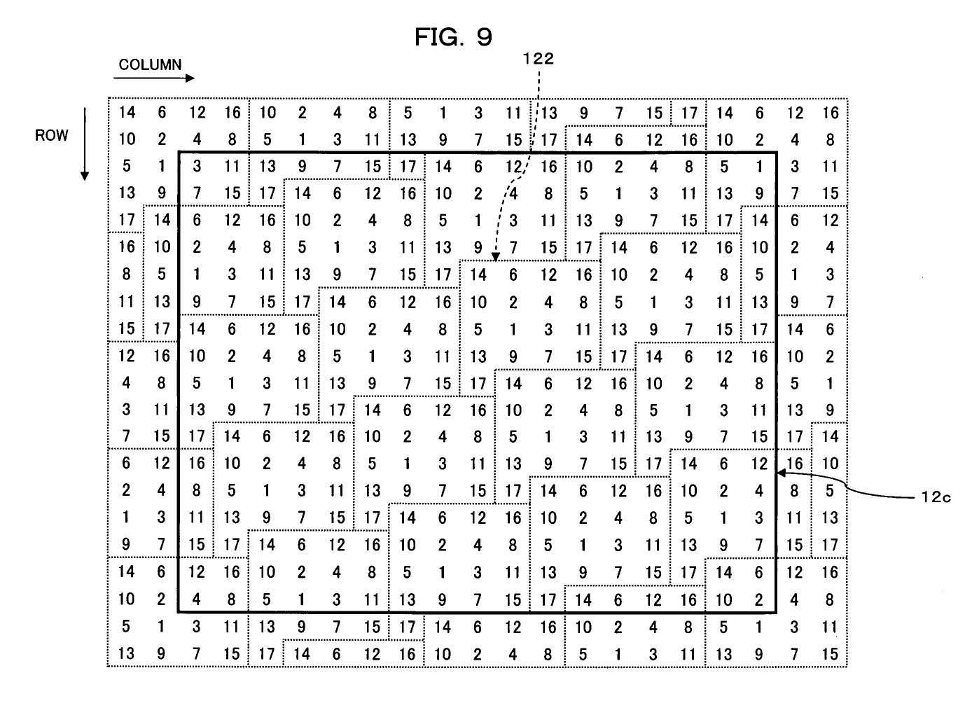

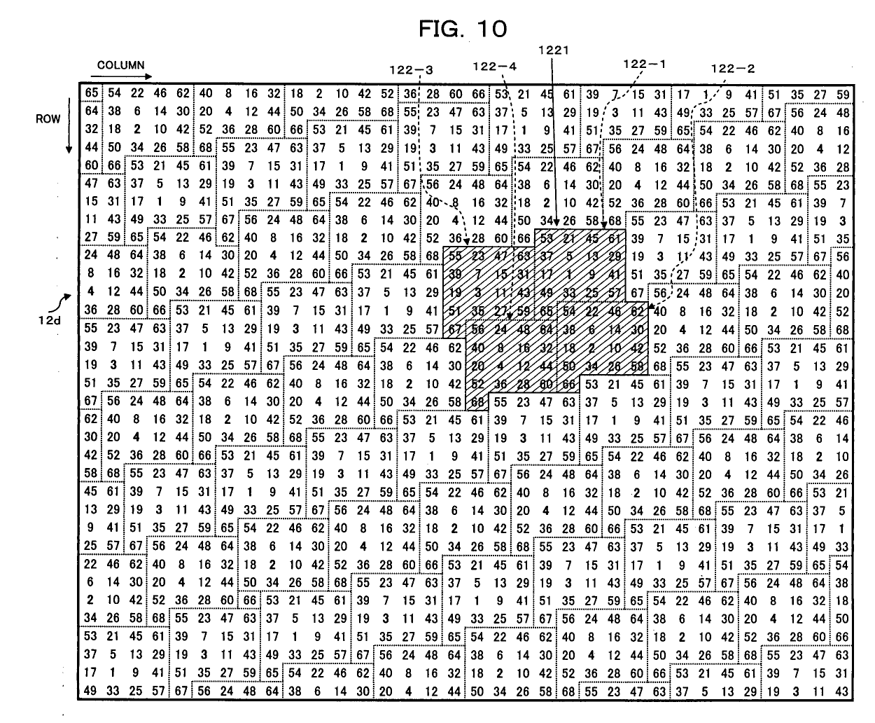

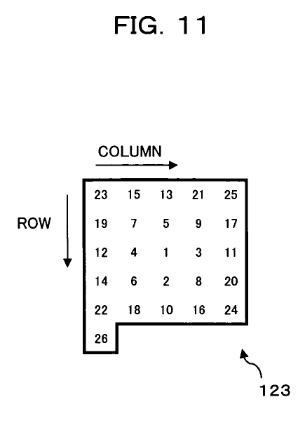

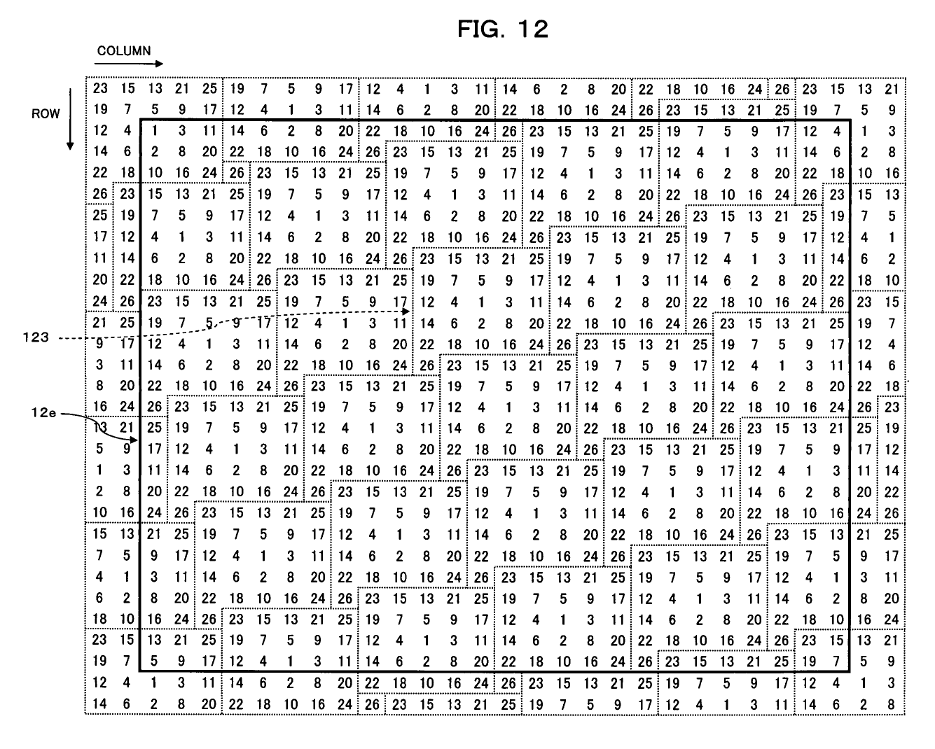

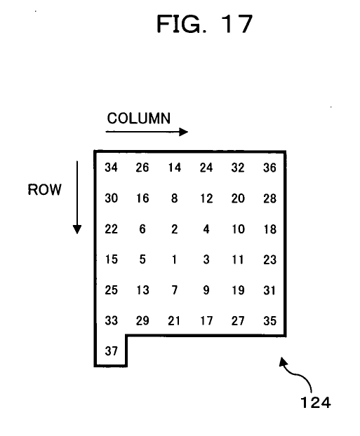

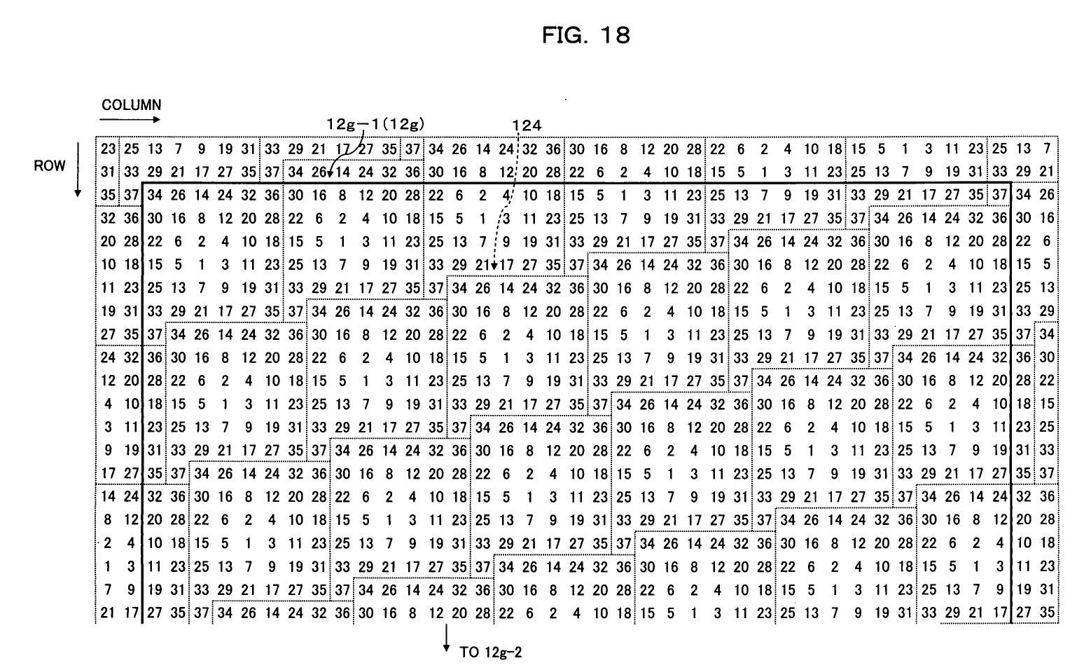

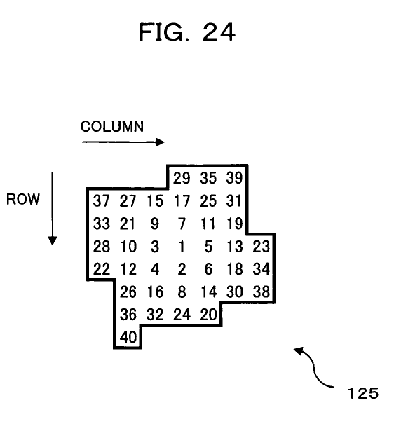

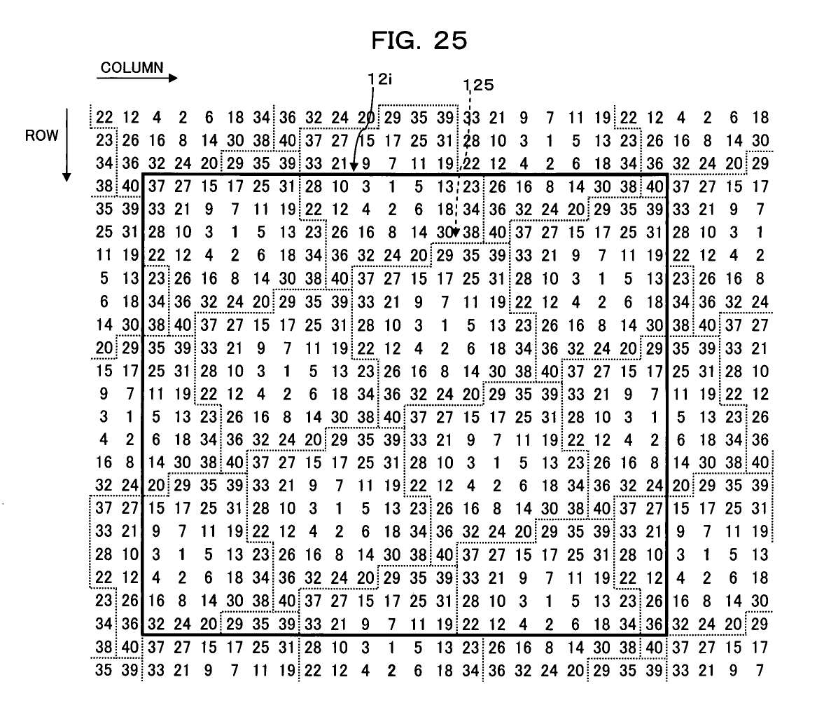

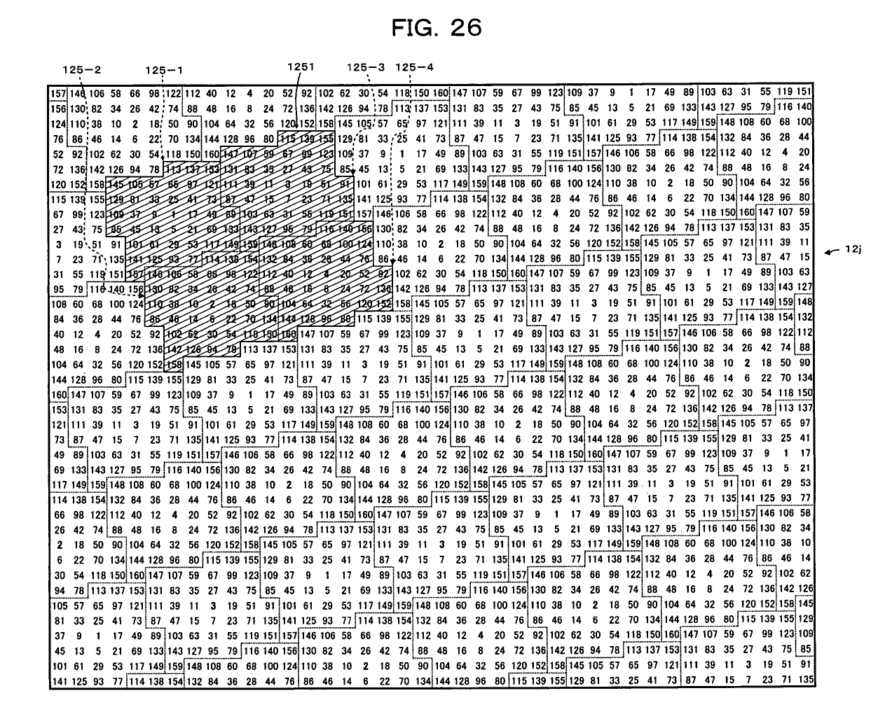

FIGS. 7 to 26 are views illustrating modifications to the binarization pattern used in the printing apparatus of the embodiment of the present invention. FIGS. 7, 9, 10, 12 to 16, 18 to 23, 25 and 26 individually show different binarization patterns. FIG. 8 shows a basic pattern used for binarization patterns 12c and 12d shown in FIGS. 9 and 10. FIG. 11 shows a basic pattern used for binarization patterns 12e and 12d shown in FIGS. 12 to 16. FIG. 17 shows a basic pattern used for binarization patterns 12g and 12h shown in FIGS. 18 to 23. FIG. 24 shows a basic pattern used for binarization patterns 12i and 12j shown in FIGS. 25 and 26. It is to be noted that, also in FIGS. 7 to 26, numerical values in the figures indicate turn-on order numbers of pixels.

The dot data production section 14 may perform the binarization process using the binarization patterns 12b to 12j shown in FIGS. 7, 9, 10, 12 to 16, 18 to 23, 25 and 26. Further, in FIGS. 7, 9, 10, 12 to 16, 18 to 23, 25 and 26, the basic patterns are shown surrounded by a dotted line.

The binarization pattern 12b as a first modification to the present invention shown in FIG. 7 is formed from four hundred pixels arranged in matrix of twenty rows and twenty columns, and is formed as a rectangular pattern wherein a plurality of pixels to be successively turned on are arranged in a matrix. Further, the binarization pattern 12b includes a plurality of sub patterns 1211 formed by arranging two basic patterns 121 shown in FIG. 4 in each of a vertical direction and a transverse direction (in the present modification, two basic patterns in a vertical direction and two basic patterns in a transverse direction, and hence totaling four basic patterns) such that the lacking portion of each basic pattern 121 is fitted with a portion of another basic pattern 121 at a point-symmetric position with respect to the center of the figure in the basic pattern 121 and a turn-on order appears repetitively and successively in a vertical direction (row arrangement direction) and a transverse direction (column arrangement direction) of the binarization pattern 12b without a clearance left therebetween. It is to be noted that, in FIG. 7, slanting lines are applied to several sub patterns 1211 for the convenience of illustration.

It is to be noted that, as a reference character which indicates the basic pattern, reference characters 121-1 to 121-n (n is a natural number) are used where one basic pattern must be specified from among a plurality of basic patterns, and reference numeral 121 is used when an arbitrary basic pattern is to be pointed to. Further, the number of basic patterns 121 which form a single sub pattern 1211 is represented by m. In particular, in the present modification, a relationship of 1≦n≦m (n and m are natural numbers) is satisfied.

In the binarization pattern 12b shown in FIG. 7, the sub pattern 1211 includes four basic patterns 121, that is, 121-1 to 121-4. Therefore, n is an arbitrary natural number from among 1, 2, 3 and 4, and m is equal to 4.

In particular, the sub pattern 1211 is formed by arranging m (m=4) basic patterns 121 (121-1 to 121-n; where 1≦n≦m) formed such that, in a partly lacking matrix 121 having four rows and three columns, the pixels of the first to third columns which form the first row of the partly lacking matrix are turned on n+6×mth, n+4×mth, and n+8×mth, respectively; the pixels of the first to third columns which form the second row of the partly lacking matrix are turned on n+3×mth, nth, and n+2×mth, respectively; the pixels of the first to third columns which form the third row of the partly lacking matrix are turned on n+5×mth, n+mth, and n+7×mth, respectively; and the pixel of the first column which forms the fourth row of the partly lacking matrix is turned on n+9×mth.

Further, in the sub pattern 1211 to which slanting lines are applied in FIG. 7, the basic pattern 121-2 is arranged on the lower side of the basic pattern 121-1; the basic pattern 121-3 is arranged on the left side of the basic pattern 121-1; and the basic pattern 121-4 is arranged on the lower side of the basic pattern 121-3. It is to be noted that the arrangement of the basic patterns 121-1 to 121-4 in the sub pattern 1211 is not limited to this, and variations and modifications can be made without departing from the scope of the present invention.

The binarization pattern 12b is formed by arranging a plurality of such sub patterns 1211 in a vertical direction and a transverse direction such that the basic patterns 121 are arranged in such a manner that the lacking portions of the basic patterns 121-2 and 121-4 in another sub pattern 1211 adjacent in a vertical direction are fitted with the basic patterns 121-1 and 121-3 and a turn-on order appears repetitively and successively in a vertical direction (row arrangement direction) and a transverse direction (column arrangement direction) of the binarization pattern 12b without a clearance left therebetween and then cutting out an arbitrary rectangular portion having twenty rows and twenty columns from the arranged basic patterns 121.

Further, the binarization pattern 12b includes a plurality of sub patterns 1211 described above, and the turn-on order of the pixels is set so that dots having shapes same as each other individually grow from a plurality of sub patterns 1211.

In particular, in the binarization pattern 12b, as shown in FIG. 7, the turn-on order of four hundred pixels is set such that:

(1) the pixels of the first to twentieth columns which form the first row of the rectangular pattern are turned on 37th, 26th, 18th, 34th, 16th, 4th, 12th, 22nd, 6th, 30th, 40th, 27th, 19th, 35th, 13th, 1st, 9th, 23rd, 7th, and 31st, respectively;

(2) the pixels of the first to twentieth columns which form the second row of the rectangular pattern are turned on 36th, 14th, 2nd, 10th, 24th, 8th, 32nd, 38th, 25th, 17th, 33rd, 15th, 3rd, 11th, 21st, 5th, 29th, 39th, 28th, and 20th, respectively;

(3) the pixels of the first to twentieth columns which form the third row of the rectangular pattern are turned on 12th, 22nd, 6th, 30th, 40th, 27th, 19th, 35th, 13th, 1st, 9th, 23rd, 7th, 31st, 37th, 26th, 18th, 34th, 16th, and 4th, respectively;

(4) the pixels of the first to twentieth columns which form the fourth row of the rectangular pattern are turned on 32nd, 38th, 25th, 17th, 33rd, 15th, 3rd, 11th, 21st, 5th, 29th, 39th, 28th, 20th, 36th, 14th, 2nd, 10th, 24th, and 8th, respectively;

(5) the pixels of the first to twentieth columns which form the fifth row of the rectangular pattern are turned on 19th, 35th, 13th, 1st, 9th, 23rd, 7th, 31st, 37th, 26th, 18th, 34th, 16th, 4th, 12th, 22nd, 6th, 30th, 40th, and 27th, respectively;

(6) the pixels of the first to twentieth columns which form the sixth row of the rectangular pattern are turned on 3rd, 11th, 21st, 5th, 29th, 39th, 28th, 20th, 36th, 14th, 2nd, 10th, 24th, 8th, 32nd, 38th, 25th, 17th, 33rd, and 15th, respectively;

(7) the pixels of the first to twentieth columns which form the seventh row of the rectangular pattern are turned on 7th, 31st, 37th, 26th, 18th, 34th, 16th, 4th, 12th, 22nd, 6th, 30th, 40th, 27th, 19th, 35th, 13th, 1st, 9th, and 23rd, respectively;

(8) the pixels of the first to twentieth columns which form the eighth row of the rectangular pattern are turned on 28th, 20th, 36th, 14th, 2nd, 10th, 24th, 8th, 32nd, 38th, 25th, 17th, 33rd, 15th, 3rd, 11th, 21st, 5th, 29th, and 39th, respectively;

(9) the pixels of the first to twentieth columns which form the ninth row of the rectangular pattern are turned on 16th, 4th, 12th, 22nd, 6th, 30th, 40th, 27th, 19th, 35th, 13th, 1st, 9th, 23rd, 7th, 31st, 37th, 26th, 18th, and 34th, respectively;

(10) the pixels of the first to twentieth columns which form the tenth row of the rectangular pattern are turned on 24th, 8th, 32nd, 38th, 25th, 17th, 33rd, 15th, 3rd, 11th, 21st, 5th, 29th, 39th, 28th, 20th, 36th, 14th, 2nd, and 10th, respectively;

(11) the pixels of the first to twentieth columns which form the eleventh row of the rectangular pattern are turned on 40th, 27th, 19th, 35th, 13th, 1st, 9th, 23rd, 7th, 31st, 37th, 26th, 18th, 34th, 16th, 4th, 12th, 22nd, 6th, and 30th, respectively;

(12) the pixels of the first to twentieth columns which form the twelfth row of the rectangular pattern are turned on 33rd, 15th, 3rd, 11th, 21st, 5th, 29th, 39th, 28th, 20th, 36th, 14th, 2nd, 10th, 24th, 8th, 32nd, 38th, 25th, and 17th, respectively;

(13) the pixels of the first to twentieth columns which form the thirteenth row of the rectangular pattern are turned on 9th, 23rd, 7th, 31st, 37th, 26th, 18th, 34th, 16th, 4th, 12th, 22nd, 6th, 30th, 40th, 27th, 19th, 35th, 13th, and 1st, respectively;

(14) the pixels of the first to twentieth columns which form the fourteenth row of the rectangular pattern are turned on 29th, 39th, 28th, 20th, 36th, 14th, 2nd, 10th, 24th, 8th, 32nd, 38th, 25th, 17th, 33rd, 15th, 3rd, 11th, 21st, and 5th, respectively;

(15) the pixels of the first to twentieth columns which form the fifteenth row of the rectangular pattern are turned on 18th, 34th, 16th, 4th, 12th, 22nd, 6th, 30th, 40th, 27th, 19th, 35th, 13th, 1st, 9th, 23rd, 7th, 31st, 37th, and 26th, respectively;

(16) the pixels of the first to twentieth columns which form the sixteenth row of the rectangular pattern are turned on 2nd, 10th, 24th, 8th, 32nd, 38th, 25th, 17th, 33rd, 15th, 3rd, 11th, 21st, 5th, 29th, 39th, 28th, 20th, 36th, and 14th, respectively;

(17) the pixels of the first to twentieth columns which form the seventeenth row of the rectangular pattern are turned on 6th, 30th, 40th, 27th, 19th, 35th, 13th, 1st, 9th, 23rd, 7th, 31st, 37th, 26th, 18th, 34th, 16th, 4th, 12th, and 22nd, respectively;

(18) the pixels of the first to twentieth columns which form the eighteenth row of the rectangular pattern are turned on 25th, 17th, 33rd, 15th, 3rd, 11th, 21st, 5th, 29th, 39th, 28th, 20th, 36th, 14th, 2nd, 10th, 24th, 8th, 32nd, and 38th, respectively;

(19) the pixels of the first to twentieth columns which form the nineteenth row of the rectangular pattern are turned on 13th, 1st, 9th, 23rd, 7th, 31st, 37th, 26th, 18th, 34th, 16th, 4th, 12th, 22nd, 6th, 30th, 40th, 27th, 19th, and 35th, respectively; and

(20) the pixels of the first to twentieth columns which form the twentieth row of the rectangular pattern are turned on 21st, 5th, 29th, 39th, 28th, 20th, 36th, 14th, 2nd, 10th, 24th, 8th, 32nd, 38th, 25th, 17th, 33rd, 15th, 3rd, and 11th, respectively.

Further, the turn-on order of the pixels is set so that dots having shapes same as each other individually grow in order from a plurality of points.

Similarly to the binarization pattern 12a, also the binarization pattern 12b is a binarization pattern having a dither angle (screen angle, half tone angle) of 18.4 degrees and an output line number (unit: lpi (line per inch)) of 190.0 lpi.

It is to be noted that, by using the binarization pattern 12b, the pixel value (for example, within a range from 0 to 255) of each of pixels which form a multi-value image (original image) to be printed can be represented in forty-one stages (gradations).

Also the binarization pattern 12c shown in FIG. 9 is a rectangular pattern wherein a plurality of pixels to be successively turned on are arranged in a matrix and is formed from two hundred eighty-nine pixels arranged in a matrix of seventeen rows and seventeen columns (rectangular pattern). Further, a turn-on order number is individually set to each of the pixels.

Further, in the binarization pattern 12c, as shown in FIG. 9, the turn-on order is set so that dots having shapes same as each other individually grow in order from a plurality of points (in the binarization pattern 12c, those pixels to which the number 1 is applied).

The binarization pattern 12c is formed by repetitively arranging the basic pattern 122 shown in FIG. 8 in a vertical direction and a transverse direction. As shown in FIG. 8, the basic pattern 122 is a partly lacking matrix formed by cutting away part of a rectangular matrix formed from twenty pixels of five rows and four columns. In the present modification, the basic pattern 122 is formed by cutting away three pixels at lower right positions (in particular, pixels of the second to fourth columns of the fifth row).

Further, in the basic pattern 122, where a pixel already turned on and positioned nearest to a specific point (in the present modification, the center of the figure of the basic pattern 122) in the basic pattern 122 exists as seen in FIG. 8, an unturned on pixel adjacent the turned on pixel is turned on and then a pixel at a point-symmetric position with respect to the specific point of the basic pattern 122 is turned on. Consequently, the turn-on order is set so that a dot grows in a substantially circular form.

In particular, in the basic pattern 122 shown in FIG. 8, a color material is placed on the pixels in order from a pixel having a low order number to another pixel having a higher order number. Therefore, a dot grows in a substantially circular form in order from the proximity of the center of the figure (specific point) of the basic pattern 122, and the binarization pattern 12c functions as a binarization pattern (binarization dither matrix pattern; dither pattern) of the dot concentration type.

In particular, the basic pattern 122 is formed such that, in a partly lacking matrix having five rows and four columns, the pixels of the first to fourth columns which form the first row of the partly lacking matrix are turned on 14th, 6th, 12th, and 16th, respectively; the pixels of the first to fourth columns which form the second row of the partly lacking matrix are turned on 10th, 2nd, 4th, and 8th, respectively; the pixels of the first to fourth columns which form the third row of the partly lacking matrix are turned on 5th, 1st, 3rd, and 11th, respectively; the pixels of the first to fourth columns which form the fourth row of the partly lacking matrix are turned on 13th, 9th, 7th, and 15th, respectively; and the pixel of the first column which forms the fifth row is turned on 17th.

As shown in FIG. 9, the binarization pattern 12c is formed by arranging such basic patterns (partly lacking matrixes) 122 such that the lacking portion (in FIG. 8, a lower right portion) of each basic pattern 122 is fitted with a portion (in FIG. 8, an upper left portion) of another basic pattern 122 at a point-symmetric position with respect to the center of the figure in the basic pattern 122 and a turn-on order appears repetitively and successively in a vertical direction (row arrangement direction) and a transverse direction (column arrangement direction) of the binarization pattern 12c without a clearance left therebetween and then cutting out an arbitrary rectangular portion (refer to a thick line of FIG. 9) having seventeen rows and seventeen columns from the arranged basic patterns 122.

Further, in the binarization pattern 12c, the turn-on order is set so that dots having shapes same as each other individually grow from the basic patterns 122 provided in the binarization pattern 12c.

In particular, in the binarization pattern 12c, the turn-on order of two hundred eighty-nine pixels is set such that:

(1) the pixels of the first to seventeenth columns which form the first row of the rectangular pattern are turned on 3rd, 11th, 13th, 9th, 7th, 15th, 17th, 14th, 6th, 12th, 16th, 10th, 2nd, 4th, 8th, 5th, and 1st, respectively;

(2) the pixels of the first to seventeenth columns which form the second row of the rectangular pattern are turned on 7th, 15th, 17th, 14th, 6th, 12th, 16th, 10th, 2nd, 4th, 8th, 5th, 1st, 3rd, 11th, 13th, and 9th, respectively;

(3) the pixels of the first to seventeenth columns which form the third row of the rectangular pattern are turned on 6th, 12th, 16th, 10th, 2nd, 4th, 8th, 5th, 1st, 3rd, 11th, 13th, 9th, 7th, 15th, 17th, and 14th, respectively;

(4) the pixels of the first to seventeenth columns which form the fourth row of the rectangular pattern are turned on 2nd, 4th, 8th, 5th, 1st, 3rd, 11th, 13th, 9th, 7th, 15th, 17th, 14th, 6th, 12th, 16th, and 10th, respectively;

(5) the pixels of the first to seventeenth columns which form the fifth row of the rectangular pattern are turned on 1st, 3rd, 11th, 13th, 9th, 7th, 15th, 17th, 14th, 6th, 12th, 16th, 10th, 2nd, 4th, 8th, and 5th, respectively;

(6) the pixels of the first to seventeenth columns which form the sixth row of the rectangular pattern are turned on 9th, 7th, 15th, 17th, 14th, 6th, 12th, 16th, 10th, 2nd, 4th, 8th, 5th, 1st, 3rd, 11th, and 13th, respectively;

(7) the pixels of the first to seventeenth columns which form the seventh row of the rectangular pattern are turned on 14th, 6th, 12th, 16th, 10th, 2nd, 4th, 8th, 5th, 1st, 3rd, 11th, 13th, 9th, 7th, 15th, and 17th, respectively;

(8) the pixels of the first to seventeenth columns which form the eighth row of the rectangular pattern are turned on 10th, 2nd, 4th, 8th, 5th, 1st, 3rd, 11th, 13th, 9th, 7th, 15th, 17th, 14th, 6th, 12th, and 16th, respectively;

(9) the pixels of the first to seventeenth columns which form the ninth row of the rectangular pattern are turned on 5th, 1st, 3rd, 11th, 13th, 9th, 7th, 15th, 17th, 14th, 6th, 12th, 16th, 10th, 2nd, 4th, and 8th, respectively;

(10) the pixels of the first to seventeenth columns which form the tenth row of the rectangular pattern are turned on 13th, 9th, 7th, 15th, 17th, 14th, 6th, 12th, 16th, 10th, 2nd, 4th, 8th, 5th, 1st, 3rd, and 11th, respectively;

(11) the pixels of the first to seventeenth columns which form the eleventh row of the rectangular pattern are turned on 17th, 14th, 6th, 12th, 16th, 10th, 2nd, 4th, 8th, 5th, 1st, 3rd, 11th, 13th, 9th, 7th, and 15th, respectively;

(12) the pixels of the first to seventeenth columns which form the twelfth row of the rectangular pattern are turned on 16th, 10th, 2nd, 4th, 8th, 5th, 1st, 3rd, 11th, 13th, 9th, 7th, 15th, 17th, 14th, 6th, and 12th, respectively;

(13) the pixels of the first to seventeenth columns which form the thirteenth row of the rectangular pattern are turned on 8th, 5th, 1st, 3rd, 11th, 13th, 9th, 7th, 15th, 17th, 14th, 6th, 12th, 16th, 10th, 2nd, and 4th, respectively;

(14) the pixels of the first to seventeenth columns which form the fourteenth row of the rectangular pattern are turned on 11th, 13th, 9th, 7th, 15th, 17th, 14th, 6th, 12th, 16th, 10th, 2nd, 4th, 8th, 5th, 1st, and 3rd, respectively;

(15) the pixels of the first to seventeenth columns which form the fifteenth row of the rectangular pattern are turned on 15th, 17th, 14th, 6th, 12th, 16th, 10th, 2nd, 4th, 8th, 5th, 1st, 3rd, 11th, 13th, 9th, and 7th, respectively;

(16) the pixels of the first to seventeenth columns which form the sixteenth row of the rectangular pattern are turned on 12th, 16th, 10th, 2nd, 4th, 8th, 5th, 1st, 3rd, 11th, 13th, 9th, 7th, 15th, 17th, 14th, and 6th, respectively; and

(17) the pixels of the first to seventeenth columns which form the seventeenth row of the rectangular pattern are turned on 4th, 8th, 5th, 1st, 3rd, 11th, 13th, 9th, 7th, 15th, 17th, 14th, 6th, 12th, 16th, 10th, and 2nd, respectively.

Further, in the binarization pattern 12c, the dither angle (screen angle, halftone dot angle) is 14.0 degrees.

In particular, the binarization pattern 12c shown in FIG. 9 is a binarization pattern having a dither angle of 14.0 degrees and an output line number of 145.5 lpi.

It is to be noted that, by using the binarization pattern 12c, the pixel value (for example, in a range from 0 to 255) of each of pixels which form a multi-value image (original image) to be printed can be represented in eighteen stages (gradations).

The binarization pattern 12d shown in FIG. 10 is formed from one thousand one hundred fifty-six pixels arranged in a matrix of thirty-four rows and thirty-four columns, and is formed as a rectangular pattern wherein a plurality of pixels to be successively turned on are arranged in a matrix. Further, the binarization pattern 12d includes a plurality of sub patterns 1221 formed by arranging two basic patterns 122 shown in FIG. 8 in each of a vertical direction and a transverse direction, (in the present modification, two basic patterns in a vertical direction and two basic patterns in a transverse direction, and hence totaling four basic patterns) such that the lacking portion of each basic pattern 122 is fitted with a portion of another basic pattern 122 at a point-symmetric position with respect to the center of the figure in the basic pattern 122 and a turn-on order appears repetitively and successively in a vertical direction (row arrangement direction) and a transverse direction (column arrangement direction) of the binarization pattern 12d without a clearance left therebetween. It is to be noted that, in FIG. 10, slanting lines are applied to several sub patterns 1221 for the convenience of illustration.

It is to be noted that, as a reference character which indicates a basic pattern, reference characters 122-1 to 122-n (n is a natural number) are used where one basic pattern must be specified from among a plurality of basic patterns, but reference numeral 122 is used when an arbitrary basic pattern is to be pointed to. Further, the number of basic patterns 122 which form a single sub pattern 1221 is represented by m. In particular, in the present modification, a relationship of 1≦n≦m (n and m are natural numbers) is satisfied.

In the binarization pattern 12d shown in FIG. 10, the sub pattern 1221 includes four basic patterns 122, that is, 122-1 to 122-4. Therefore, n is an arbitrary natural number from among 1, 2, 3 and 4, and m is equal to 4.

In particular, the sub pattern 1221 is formed by arranging m (m=4) basic patterns 122 (122-1 to 122-n; where 1≦n≦m) formed such that, in a partly lacking matrix 121 having five rows and four columns, the pixels of the first to fourth columns which form the first row of the partly lacking matrix are turned on n+13×mth, n+5×mth, n+11×mth, and n+15×mth, respectively; the pixels of the first to fourth columns which form the second row of the partly lacking matrix are turned on n+9×mth, n+mth, n+3×mth, and n+7×mth, respectively; the pixels of the first to fourth columns which form the third row of the partly lacking matrix are turned on n+4×mth, nth, n+2×mth, and n+10×mth, respectively; the pixels of the first to fourth columns which form the fourth row of the partly lacking matrix are turned on n+12×mth, n+8×mth, n+6×mth, and n+14×mth, respectively; and the pixel of the first column which forms the fifth row of the partly lacking matrix is turned on n+16×mth.

Further, in the sub pattern 1221 to which slanting lines are applied in FIG. 10, the basic pattern 122-2 is arranged on the lower side of the basic pattern 122-1; the basic pattern 122-3 is arranged on the left side of the basic pattern 122-1; and the basic pattern 122-4 is arranged on the lower side of the basic pattern 122-3. It is to be noted that the arrangement of the basic patterns 122-1 to 122-4 in the sub pattern 1221 is not limited to this, and variations and modifications can be made without departing from the scope of the present invention.

The binarization pattern 12d is formed by arranging a plurality of such sub patterns 1221 in a vertical direction and a transverse direction such that the basic patterns 122-1 and 122-3 of each sub pattern 1221 are fitted with the lacking portions of the basic patterns 122-2 and 122-4 in another sub pattern 1221 adjacent in a vertical direction and a turn-on order appears repetitively and successively in a vertical direction (row arrangement direction) and a transverse direction (column arrangement direction) of the binarization pattern 12d without a clearance left therebetween and then cutting out an arbitrary rectangular portion having thirty-four rows and thirty-four columns from the arranged basic patterns 122.

Further, the binarization pattern 12d includes a plurality of sub patterns 1221 described above, and the turn-on order of the pixels is set so that dots having shapes same as each other individually grow in order from a plurality of sub patterns 1221.

In particular, in the binarization pattern 12d, as shown in FIG. 10, the turn-on order of one thousand one hundred fifty-six pixels is set such that:

(1) the pixels of the first to thirty-fourth columns which form the first row of the rectangular pattern are turned on 65th, 54th, 22nd, 46th, 62nd, 40th, 8th, 16th, 32nd, 18th, 2nd, 10th, 42nd, 52nd, 36th, 28th, 60th, 66th, 53rd, 21st, 45th, 61st, 39th, 7th, 15th, 31st, 17th, 1st, 9th, 41st, 51st, 35th, 27th, and 59th, respectively;

(2) the pixels of the first to thirty-fourth columns which form the second row of the rectangular pattern are turned on 64th, 38th, 6th, 14th, 30th, 20th, 4th, 12th, 44th, 50th, 34th, 26th, 58th, 68th, 55th, 23rd, 47th, 63rd, 37th, 5th, 13th, 29th, 19th, 3rd, 11th, 43rd, 49th, 33rd, 25th, 57th, 67th, 56th, 24th, and 48th, respectively;

(3) the pixels of the first to thirty-fourth columns which form the third row of the rectangular pattern are turned on 32nd, 18th, 2nd, 10th, 42nd, 52nd, 36th, 28th, 60th, 66th, 53rd, 21st, 45th, 61st, 39th, 7th, 15th, 31st, 17th, 1st, 9th, 41st, 51st, 35th, 27th, 59th, 65th, 54th, 22nd, 46th, 62nd, 40th, 8th, and 16th, respectively;

(4) the pixels of the first to thirty-fourth columns which form the fourth row of the rectangular pattern are turned on 44th, 50th, 34th, 26th, 58th, 68th, 55th, 23rd, 47th, 63rd, 37th, 5th, 13th, 29th, 19th, 3rd, 11th, 43rd, 49th, 33rd, 25th, 57th, 67th, 56th, 24th, 48th, 64th, 38th, 6th, 14th, 30th, 20th, 4th, and 12th, respectively;

(5) the pixels of the first to thirty-fourth columns which form the fifth row of the rectangular pattern are turned on 60th, 66th, 53rd, 21st, 45th, 61st, 39th, 7th, 15th, 31st, 17th, 1st, 9th, 41st, 51st, 35th, 27th, 59th, 65th, 54th, 22nd, 46th, 62nd, 40th, 8th, 16th, 32nd, 18th, 2nd, 10th, 42nd, 52nd, 36th, and 28th, respectively;

(6) the pixels of the first to thirty-fourth columns which form the sixth row of the rectangular pattern are turned on 47th, 63rd, 37th, 5th, 13th, 29th, 19th, 3rd, 11th, 43rd, 49th, 33rd, 25th, 57th, 67th, 56th, 24th, 48th, 64th, 38th, 6th, 14th, 30th, 20th, 4th, 12th, 44th, 50th, 34th, 26th, 58th, 68th, 55th, and 23rd, respectively;

(7) the pixels of the first to thirty-fourth columns which form the seventh row of the rectangular pattern are turned on 15th, 31st, 17th, 1st, 9th, 41st, 51st, 35th, 27th, 59th, 65th, 54th, 22nd, 46th, 62nd, 40th, 8th, 16th, 32nd, 18th, 2nd, 10th, 42nd, 52nd, 36th, 28th, 60th, 66th, 53rd, 21st, 45th, 61st, 39th, and 7th, respectively;

(8) the pixels of the first to thirty-fourth columns which form the eighth row of the rectangular pattern are turned on 11th, 43rd, 49th, 33rd, 25th, 57th, 67th, 56th, 24th, 48th, 64th, 38th, 6th, 14th, 30th, 20th, 4th, 12th, 44th, 50th, 34th, 26th, 58th, 68th, 55th, 23rd, 47th, 63rd, 37th, 5th, 13th, 29th, 19th, and 3rd, respectively;

(9) the pixels of the first to thirty-fourth columns which form the ninth row of the rectangular pattern are turned on 27th, 59th, 65th, 54th, 22nd, 46th, 62nd, 40th, 8th, 16th, 32nd, 18th, 2nd, 10th, 42nd, 52nd, 36th, 28th, 60th, 66th, 53rd, 21st, 45th, 61st, 39th, 7th, 15th, 31st, 17th, 1st, 9th, 41st, 51st, and 35th, respectively;

(10) the pixels of the first to thirty-fourth columns which form the tenth row of the rectangular pattern are turned on 24th, 48th, 64th, 38th, 6th, 14th, 30th, 20th, 4th, 12th, 44th, 50th, 34th, 26th, 58th, 68th, 55th, 23rd, 47th, 63rd, 37th, 5th, 13th, 29th, 19th, 3rd, 11th, 43rd, 49th, 33rd, 25th, 57th, 67th, and 56th, respectively;

(11) the pixels of the first to thirty-fourth columns which form the eleventh row of the rectangular pattern are turned on 8th, 16th, 32nd, 18th, 2nd, 10th, 42nd, 52nd, 36th, 28th, 60th, 66th, 53rd, 21st, 45th, 61st, 39th, 7th, 15th, 31st, 17th, 1st, 9th, 41st, 51st, 35th, 27th, 59th, 65th, 54th, 22nd, 46th, 62nd, and 40th, respectively;

(12) the pixels of the first to thirty-fourth columns which form the twelfth row of the rectangular pattern are turned on 4th, 12th, 44th, 50th, 34th, 26th, 58th, 68th, 55th, 23rd, 47th, 63rd, 37th, 5th, 13th, 29th, 19th, 3rd, 11th, 43rd, 49th, 33rd, 25th, 57th, 67th, 56th, 24th, 48th, 64th, 38th, 6th, 14th, 30th, and 20th, respectively;

(13) the pixels of the first to thirty-fourth columns which form the thirteenth row of the rectangular pattern are turned on 36th, 28th, 60th, 66th, 53rd, 21st, 45th, 61st, 39th, 7th, 15th, 31st, 17th, 1st, 9th, 41st, 51st, 35th, 27th, 59th, 65th, 54th, 22nd, 46th, 62nd, 40th, 8th, 16th, 32nd, 18th, 2nd, 10th, 42nd, and 52nd, respectively;

(14) the pixels of the first to thirty-fourth columns which form the fourteenth row of the rectangular pattern are turned on 55th, 23rd, 47th, 63rd, 37th, 5th, 13th, 29th, 19th, 3rd, 11th, 43rd, 49th, 33rd, 25th, 57th, 67th, 56th, 24th, 48th, 64th, 38th, 6th, 14th, 30th, 20th, 4th, 12th, 44th, 50th, 34th, 26th, 58th, and 68th, respectively;

(15) the pixels of the first to thirty-fourth columns which form the fifteenth row of the rectangular pattern are turned on 39th, 7th, 15th, 31st, 17th, 1st, 9th, 41st, 51st, 35th, 27th, 59th, 65th, 54th, 22nd, 46th, 62nd, 40th, 8th, 16th, 32nd, 18th, 2nd, 10th, 42nd, 52nd, 36th, 28th, 60th, 66th, 53rd, 21st, 45th, and 61st, respectively;

(16) the pixels of the first to thirty-fourth columns which form the sixteenth row of the rectangular pattern are turned on 19th, 3rd, 11th, 43rd, 49th, 33rd, 25th, 57th, 67th, 56th, 24th, 48th, 64th, 38th, 6th, 14th, 30th, 20th, 4th, 12th, 44th, 50th, 34th, 26th, 58th, 68th, 55th, 23rd, 47th, 63rd, 37th, 5th, 13th, and 29th, respectively;

(17) the pixels of the first to thirty-fourth columns which form the seventeenth row of the rectangular pattern are turned on 51st, 35th, 27th, 59th, 65th, 54th, 22nd, 46th, 62nd, 40th, 8th, 16th, 32nd, 18th, 2nd, 10th, 42nd, 52nd, 36th, 28th, 60th, 66th, 53rd, 21st, 45th, 61st, 39th, 7th, 15th, 31st, 17th, 1st, 9th, and 41st, respectively;

(18) the pixels of the first to thirty-fourth columns which form the eighteenth row of the rectangular pattern are turned on 67th, 56th, 24th, 48th, 64th, 38th, 6th, 14th, 30th, 20th, 4th, 12th, 44th, 50th, 34th, 26th, 58th, 68th, 55th, 23rd, 47th, 63rd, 37th, 5th, 13th, 29th, 19th, 3rd, 11th, 43rd, 49th, 33rd, 25th, and 57th, respectively;

(19) the pixels of the first to thirty-fourth columns which form the nineteenth row of the rectangular pattern are turned on 62nd, 40th, 8th, 16th, 32nd, 18th, 2nd, 10th, 42nd, 52nd, 36th, 28th, 60th, 66th, 53rd, 21st, 45th, 61st, 39th, 7th, 15th, 31st, 17th, 1st, 9th, 41st, 51st, 35th, 27th, 59th, 65th, 54th, 22nd, and 46th, respectively;

(20) the pixels of the first to thirty-fourth columns which form the twentieth row of the rectangular pattern are turned on 30th, 20th, 4th, 12th, 44th, 50th, 34th, 26th, 58th, 68th, 55th, 23rd, 47th, 63rd, 37th, 5th, 13th, 29th, 19th, 3rd, 11th, 43rd, 49th, 33rd, 25th, 57th, 67th, 56th, 24th, 48th, 64th, 38th, 6th, and 14th, respectively;

(21) the pixels of the first to thirty-fourth columns which form the twenty-first row of the rectangular pattern are turned on 42nd, 52nd, 36th, 28th, 60th, 66th, 53rd, 21st, 45th, 61st, 39th, 7th, 15th, 31st, 17th, 1st, 9th, 41st, 51st, 35th, 27th, 59th, 65th, 54th, 22nd, 46th, 62nd, 40th, 8th, 16th, 32nd, 18th, 2nd, and 10th, respectively;

(22) the pixels of the first to thirty-fourth columns which form the twenty-second row of the rectangular pattern are turned on 58th, 68th, 55th, 23rd, 47th, 63rd, 37th, 5th, 13th, 29th, 19th, 3rd, 11th, 43rd, 49th, 33rd, 25th, 57th, 67th, 56th, 24th, 48th, 64th, 38th, 6th, 14th, 30th, 20th, 4th, 12th, 44th, 50th, 34th, and 26th, respectively;

(23) the pixels of the first to thirty-fourth columns which form the twenty-third row of the rectangular pattern are turned on 45th, 61st, 39th, 7th, 15th, 31st, 17th, 1st, 9th, 41st, 51st, 35th, 27th, 59th, 65th, 54th, 22nd, 46th, 62nd, 40th, 8th, 16th, 32nd, 18th, 2nd, 10th, 42nd, 52nd, 36th, 28th, 60th, 66th, 53rd, and 21st, respectively;

(24) the pixels of the first to thirty-fourth columns which form the twenty-fourth row of the rectangular pattern are turned on 13th, 29th, 19th, 3rd, 11th, 43rd, 49th, 33rd, 25th, 57th, 67th, 56th, 24th, 48th, 64th, 38th, 6th, 14th, 30th, 20th, 4th, 12th, 44th, 50th, 34th, 26th, 58th, 68th, 55th, 23rd, 47th, 63rd, 37th, and 5th, respectively;

(25) the pixels of the first to thirty-fourth columns which form the twenty-fifth row of the rectangular pattern are turned on 9th, 41st, 51st, 35th, 27th, 59th, 65th, 54th, 22nd, 46th, 62nd, 40th, 8th, 16th, 32nd, 18th, 2nd, 10th, 42nd, 52nd, 36th, 28th, 60th, 66th, 53rd, 21st, 45th, 61st, 39th, 7th, 15th, 31st, 17th, and 1st, respectively;

(26) the pixels of the first to thirty-fourth columns which form the twenty-sixth row of the rectangular pattern are turned on 25th, 57th, 67th, 56th, 24th, 48th, 64th, 38th, 6th, 14th, 30th, 20th, 4th, 12th, 44th, 50th, 34th, 26th, 58th, 68th, 55th, 23rd, 47th, 63rd, 37th, 5th, 13th, 29th, 19th, 3rd, 11th, 43rd, 49th, and 33rd, respectively;

(27) the pixels of the first to thirty-fourth columns which form the twenty-seventh row of the rectangular pattern are turned on 22nd, 46th, 62nd, 40th, 8th, 16th, 32nd, 18th, 2nd, 10th, 42nd, 52nd, 36th, 28th, 60th, 66th, 53rd, 21st, 45th, 61st, 39th, 7th, 15th, 31st, 17th, 1st, 9th, 41st, 51st, 35th, 27th, 59th, 65th, and 54th, respectively;

(28) the pixels of the first to thirty-fourth columns which form the twenty-eighth row of the rectangular pattern are turned on 6th, 14th, 30th, 20th, 4th, 12th, 44th, 50th, 34th, 26th, 58th, 68th, 55th, 23rd, 47th, 63rd, 37th, 5th, 13th, 29th, 19th, 3rd, 11th, 43rd, 49th, 33rd, 25th, 57th, 67th, 56th, 24th, 48th, 64th, and 38th, respectively;

(29) the pixels of the first to thirty-fourth columns which form the twenty-ninth row of the rectangular pattern are turned on 2nd, 10th, 42nd, 52nd, 36th, 28th, 60th, 66th, 53rd, 21st, 45th, 61st, 39th, 7th, 15th, 31st, 17th, 1st, 9th, 41st, 51st, 35th, 27th, 59th, 65th, 54th, 22nd, 46th, 62nd, 40th, 8th, 16th, 32nd, and 18th, respectively;

(30) the pixels of the first to thirty-fourth columns which form the thirtieth row of the rectangular pattern are turned on 34th, 26th, 58th, 68th, 55th, 23rd, 47th, 63rd, 37th, 5th, 13th, 29th, 19th, 3rd, 11th, 43rd, 49th, 33rd, 25th, 57th, 67th, 56th, 24th, 48th, 64th, 38th, 6th, 14th, 30th, 20th, 4th, 12th, 44th, and 50th, respectively;

(31) the pixels of the first to thirty-fourth columns which form the thirty-first row of the rectangular pattern are turned on 53rd, 21st, 45th, 61st, 39th, 7th, 15th, 31st, 17th, 1st, 9th, 41st, 51st, 35th, 27th, 59th, 65th, 54th, 22nd, 46th, 62nd, 40th, 8th, 16th, 32nd, 18th, 2nd, 10th, 42nd, 52nd, 36th, 28th, 60th, and 66th, respectively;

(32) the pixels of the first to thirty-fourth columns which form the thirty-second row of the rectangular pattern are turned on 37th, 5th, 13th, 29th, 19th, 3rd, 11th, 43rd, 49th, 33rd, 25th, 57th, 67th, 56th, 24th, 48th, 64th, 38th, 6th, 14th, 30th, 20th, 4th, 12th, 44th, 50th, 34th, 26th, 58th, 68th, 55th, 23rd, 47th, and 63rd, respectively;

(33) the pixels of the first to thirty-fourth columns which form the thirty-third row of the rectangular pattern are turned on 17th, 1st, 9th, 41st, 51st, 35th, 27th, 59th, 65th, 54th, 22nd, 46th, 62nd, 40th, 8th, 16th, 32nd, 18th, 2nd, 10th, 42nd, 52nd, 36th, 28th, 60th, 66th, 53rd, 21st, 45th, 61st, 39th, 7th, 15th, and 31st, respectively; and

(34) the pixels of the first to thirty-fourth columns which form the thirty-fourth row of the rectangular pattern are turned on 49th, 33rd, 25th, 57th, 67th, 56th, 24th, 48th, 64th, 38th, 6th, 14th, 30th, 20th, 4th, 12th, 44th, 50th, 34th, 26th, 58th, 68th, 55th, 23rd, 47th, 63rd, 37th, 5th, 13th, 29th, 19th, 3rd, 11th, and 43rd, respectively.

Further, the turn-on order of the pixels is set so that dots having shapes same as each other individually grow in order from a plurality of points.

Similarly to the binarization pattern 12c, also the binarization pattern 12d is a binarization pattern having a dither angle (screen angle, half tone angle) of 14.0 degrees and an output line number of 145.5 lpi.

It is to be noted that, by using the binarization pattern 12d, the pixel value (for example, in a range from 0 to 255) of each of pixels which form a multi-value image (original image) to be printed can be represented in sixty-nine stages (gradations).

Also the binarization pattern 12e shown in FIG. 12 is a rectangular pattern wherein a plurality of pixels to be successively turned on are arranged in a matrix, and is formed from six hundred seventy-six pixels which are arranged in a matrix of twenty-six rows and twenty-six columns (rectangular pattern). Further, a turn-on order number is individually set to each of the pixels.

Further, in the binarization pattern 12e, as shown in FIG. 12, the turn-on order is set so that dots having shapes same as each other individually grow in order from a plurality of points (in the binarization pattern 12e, pixels to which the number 1 is applied).

The binarization pattern 12e is formed by repetitively arranging the basic pattern 123 shown in FIG. 11 in a vertical direction and a transverse direction. As shown in FIG. 11, the basic pattern 123 is a partly lacking matrix formed by cutting away part of a rectangular matrix formed from thirty pixels of six rows and five columns. In the present modification, the basic pattern 123 is formed by cutting away four pixels at lower right positions (in particular, pixels of the second to fifth columns of the sixth row).

Further, in the basic pattern 123, where a pixel already turned on and positioned nearest to a specific point (in the present modification, the center of the figure of the basic pattern 123) in the basic pattern 123 exists as shown in FIG. 11, an unturned on pixel adjacent the turned on pixel is turned on and then a pixel at a point-symmetric position with respect to the specific point of the basic pattern 123 is turned on. Consequently, the turn-on order is set so that a dot grows in a substantially circular form.

In particular, in the basic pattern 123 shown in FIG. 11, a color material is placed on the pixels in order from a pixel having a low order number to another pixel having a higher order number. Therefore, a dot grows in a substantially circular form in order from the proximity of the center of the figure (specific point) of the basic pattern 123, and the binarization pattern 12e functions as a binarization pattern (binarization dither matrix pattern; dither pattern) of the dot concentration type.

In particular, the basic pattern 123 is formed such that, in a partly lacking matrix having six rows and five columns, the pixels of the first to fifth columns which form the first row of the partly lacking matrix are turned on 23rd, 15th, 13th, 21st, and 25th, respectively; the pixels of the first to fifth columns which form the second row of the partly lacking matrix are turned on 19th, 7th, 5th, 9th, and 17th, respectively; the pixels of the first to fifth columns which form the third row of the partly lacking matrix are turned on 12th, 4th, 1st, 3rd, and 11th, respectively; the pixel of the first to fifth columns which for the fourth row of the partly lacking matrix are turned on 14th, 6th, 2nd, 8th, and 20th, respectively; the pixel of the first to fifth columns which form the fifth row of the partly lacking matrix are turned on 22nd, 18th, 10th, 16th, and 24th, respectively; and the pixel of the first column which forms the sixth row of the partly lacking matrix is turned on 26th.

As shown in FIG. 12, the binarization pattern 12e is formed by arranging such basic patterns (partly lacking matrixes) 123 such that the lacking portion (in FIG. 11, a lower right portion) of each basic pattern 123 is fitted with a portion (in FIG. 11, an upper left portion) of another basic pattern 123 at a point-symmetric position with respect to the center of the figure in the basic pattern 123 and a turn-on order appears repetitively and successively in a vertical direction (row arrangement direction) and a transverse direction (column arrangement direction) of the binarization pattern 12e without a clearance left therebetween and then cutting out an arbitrary rectangular portion (refer to a thick line of FIG. 12) having twenty-six rows and twenty-six columns from the arranged basic patterns 123.

Further, in the binarization pattern 12e, the turn-on order is set so that dots having shapes same as each other individually grow in order from the basic patterns 123 provided in the binarization pattern 12e.

In particular, in the binarization pattern 12e, the turn-on order of six hundred seventy-six pixels is set such that:

(1) the pixels of the first to twenty-sixth columns which form the first row of the rectangular pattern are turned on 1st, 3rd, 11th, 14th, 6th, 2nd, 8th, 20th, 22nd, 18th, 10th, 16th, 24th, 26th, 23rd, 15th, 13th, 21st, 25th, 19th, 7th, 5th, 9th, 17th, 12th, and 4th, respectively;

(2) the pixels of the first to twenty-sixth columns which form the second row of the rectangular pattern are turned on 2nd, 8th, 20th, 22nd, 18th, 10th, 16th, 24th, 26th, 23rd, 15th, 13th, 21st, 25th, 19th, 7th, 5th, 9th, 17th, 12th, 4th, 1st, 3rd, 11th, 14th, and 6th, respectively;

(3) the pixels of the first to twenty-sixth columns which form the third row of the rectangular pattern are turned on 10th, 16th, 24th, 26th, 23rd, 15th, 13th, 21st, 25th, 19th, 7th, 5th, 9th, 17th, 12th, 4th, 1st, 3rd, 11th, 14th, 6th, 2nd, 8th, 20th, 22nd, and 18th, respectively;

(4) the pixels of the first to twenty-sixth columns which form the fourth row of the rectangular pattern are turned on 15th, 13th, 21st, 25th, 19th, 7th, 5th, 9th, 17th, 12th, 4th, 1st, 3rd, 11th, 14th, 6th, 2nd, 8th, 20th, 22nd, 18th, 10th, 16th, 24th, 26th, and 23rd, respectively;

(5) the pixels of the first to twenty-sixth columns which form the fifth row of the rectangular pattern are turned on 7th, 5th, 9th, 17th, 12th, 4th, 1st, 3rd, 11th, 14th, 6th, 2nd, 8th, 20th, 22nd, 18th, 10th, 16th, 24th, 26th, 23rd, 15th, 13th, 21st, 25th, and 19th, respectively;

(6) the pixels of the first to twenty-sixth columns which form the sixth row of the rectangular pattern are turned on 4th, 1st, 3rd, 11th, 14th, 6th, 2nd, 8th, 20th, 22nd, 18th, 10th, 16th, 24th, 26th, 23rd, 15th, 13th, 21st, 25th, 19th, 7th, 5th, 9th, 17th, and 12th, respectively;

(7) the pixels of the first to twenty-sixth columns which form the seventh row of the rectangular pattern are turned on 6th, 2nd, 8th, 20th, 22nd, 18th, 10th, 16th, 24th, 26th, 23rd, 15th, 13th, 21st, 25th, 19th, 7th, 5th, 9th, 17th, 12th, 4th, 1st, 3rd, 11th, and 14th, respectively;

(8) the pixels of the first to twenty-sixth columns which form the eighth row of the rectangular pattern are turned on 18th, 10th, 16th, 24th, 26th, 23rd, 15th, 13th, 21st, 25th, 19th, 7th, 5th, 9th, 17th, 12th, 4th, 1st, 3rd, 11th, 14th, 6th, 2nd, 8th, 20th, and 22nd, respectively;

(9) the pixels of the first to twenty-sixth columns which form the ninth row of the rectangular pattern are turned on 23rd, 15th, 13th, 21st, 25th, 19th, 7th, 5th, 9th, 17th, 12th, 4th, 1st, 3rd, 11th, 14th, 6th, 2nd, 8th, 20th, 22nd, 18th, 10th, 16th, 24th, and 26th, respectively;

(10) the pixels of the first to twenty-sixth columns which form the tenth row of the rectangular pattern are turned on 19th, 7th, 5th, 9th, 17th, 12th, 4th, 1st, 3rd, 11th, 14th, 6th, 2nd, 8th, 20th, 22nd, 18th, 10th, 16th, 24th, 26th, 23rd, 15th, 13th, 21st, and 25th, respectively;

(11) the pixels of the first to twenty-sixth columns which form the eleventh row of the rectangular pattern are turned on 12th, 4th, 1st, 3rd, 11th, 14th, 6th, 2nd, 8th, 20th, 22nd, 18th, 10th, 16th, 24th, 26th, 23rd, 15th, 13th, 21st, 25th, 19th, 7th, 5th, 9th, and 17th, respectively;

(12) the pixels of the first to twenty-sixth columns which form the twelfth row of the rectangular pattern are turned on 14th, 6th, 2nd, 8th, 20th, 22nd, 18th, 10th, 16th, 24th, 26th, 23rd, 15th, 13th, 21st, 25th, 19th, 7th, 5th, 9th, 17th, 12th, 4th, 1st, 3rd, and 11th, respectively;

(13) the pixels of the first to twenty-sixth columns which form the thirteenth row of the rectangular pattern are turned on 22nd, 18th, 10th, 16th, 24th, 26th, 23rd, 15th, 13th, 21st, 25th, 19th, 7th, 5th, 9th, 17th, 12th, 4th, 1st, 3rd, 11th, 14th, 6th, 2nd, 8th, and 20th, respectively;

(14) the pixels of the first to twenty-sixth columns which form the fourteenth row of the rectangular pattern are turned on 26th, 23rd, 15th, 13th, 21st, 25th, 19th, 7th, 5th, 9th, 17th, 12th, 4th, 1st, 3rd, 11th, 14th, 6th, 2nd, 8th, 20th, 22nd, 18th, 10th, 16th, and 24th, respectively;

(15) the pixels of the first to twenty-sixth columns which form the fifteenth row of the rectangular pattern are turned on 25th, 19th, 7th, 5th, 9th, 17th, 12th, 4th, 1st, 3rd, 11th, 14th, 6th, 2nd, 8th, 20th, 22nd, 18th, 10th, 16th, 24th, 26th, 23rd, 15th, 13th, and 21st, respectively;

(16) the pixels of the first to twenty-sixth columns which form the sixteenth row of the rectangular pattern are turned on 17th, 12th, 4th, 1st, 3rd, 11th, 14th, 6th, 2nd, 8th, 20th, 22nd, 18th, 10th, 16th, 24th, 26th, 23rd, 15th, 13th, 21st, 25th, 19th, 7th, 5th, and 9th, respectively;

(17) the pixels of the first to twenty-sixth columns which form the seventeenth row of the rectangular pattern are turned on 11th, 14th, 6th, 2nd, 8th, 20th, 22nd, 18th, 10th, 16th, 24th, 26th, 23rd, 15th, 13th, 21st, 25th, 19th, 7th, 5th, 9th, 17th, 12th, 4th, 1st, and 3rd, respectively;

(18) the pixels of the first to twenty-sixth columns which form the eighteenth row of the rectangular pattern are turned on 20th, 22nd, 18th, 10th, 16th, 24th, 26th, 23rd, 15th, 13th, 21st, 25th, 19th, 7th, 5th, 9th, 17th, 12th, 4th, 1st, 3rd, 11th, 14th, 6th, 2nd, and 8th, respectively;

(19) the pixels of the first to twenty-sixth columns which form the nineteenth row of the rectangular pattern are turned on 24th, 26th, 23rd, 15th, 13th, 21st, 25th, 19th, 7th, 5th, 9th, 17th, 12th, 4th, 1st, 3rd, 11th, 14th, 6th, 2nd, 8th, 20th, 22nd, 18th, 10th, and 16th, respectively;

(20) the pixels of the first to twenty-sixth columns which form the twentieth row of the rectangular pattern are turned on 21st, 25th, 19th, 7th, 5th, 9th, 17th, 12th, 4th, 1st, 3rd, 11th, 14th, 6th, 2nd, 8th, 20th, 22nd, 18th, 10th, 16th, 24th, 26th, 23rd, 15th, and 13th, respectively;

(21) the pixels of the first to twenty-sixth columns which form the twenty-first row of the rectangular pattern are turned on 9th, 17th, 12th, 4th, 1st, 3rd, 11th, 14th, 6th, 2nd, 8th, 20th, 22nd, 18th, 10th, 16th, 24th, 26th, 23rd, 15th, 13th, 21st, 25th, 19th, 7th, and 5th, respectively;

(22) the pixels of the first to twenty-sixth columns which from the twenty-second row of the rectangular pattern are turned on 3rd, 11th, 14th, 6th, 2nd, 8th, 20th, 22nd, 18th, 10th, 16th, 24th, 26th, 23rd, 15th, 13th, 21st, 25th, 19th, 7th, 5th, 9th, 17th, 12th, 4th, and 1st, respectively;

(23) the pixels of the first to twenty-sixth columns which form the twenty-third row of the rectangular pattern are turned on 8th, 20th, 22nd, 18th, 10th, 16th, 24th, 26th, 23rd, 15th, 13th, 21st, 25th, 19th, 7th, 5th, 9th, 17th, 12th, 4th, 1st, 3rd, 11th, 14th, 6th, and 2nd, respectively;

(24) the pixels of the first to twenty-sixth columns which form the twenty-fourth row of the rectangular pattern are turned on 16th, 24th, 26th, 23rd, 15th, 13th, 21st, 25th, 19th, 7th, 5th, 9th, 17th, 12th, 4th, 1st, 3rd, 11th, 14th, 6th, 2nd, 8th, 20th, 22nd, 18th, and 10th, respectively;

(25) the pixels of the first to twenty-sixth columns which form the twenty-fifth row of the rectangular pattern are turned on 13th, 21st, 25th, 19th, 7th, 5th, 9th, 17th, 12th, 4th, 1st, 3rd, 11th, 14th, 6th, 2nd, 8th, 20th, 22nd, 18th, 10th, 16th, 24th, 26th, 23rd, and 15th, respectively; and

(26) the pixels of the first to twenty-sixth columns which form the twenty-sixth row of the rectangular pattern are turned on 5th, 9th, 17th, 12th, 4th, 1st, 3rd, 11th, 14th, 6th, 2nd, 8th, 20th, 22nd, 18th, 10th, 16th, 24th, 26th, 23rd, 15th, 13th, 21st, 25th, 19th, and 7th, respectively.

Further, in the binarization pattern 12e, the dither angle (screen angle, halftone dot angle) is 11.3 degrees.

In particular, the binarization pattern 12e shown in FIG. 12 is a binarization pattern having a dither angle of 11.3 degrees and an output line number of 117.7 lpi.

It is to be noted that, by using the binarization pattern 12e, the pixel value (for example, within a range from 0 to 255) of each of pixels which form a multi-value image (original image) to be printed can be individually represented in twenty-seven stages (gradations).

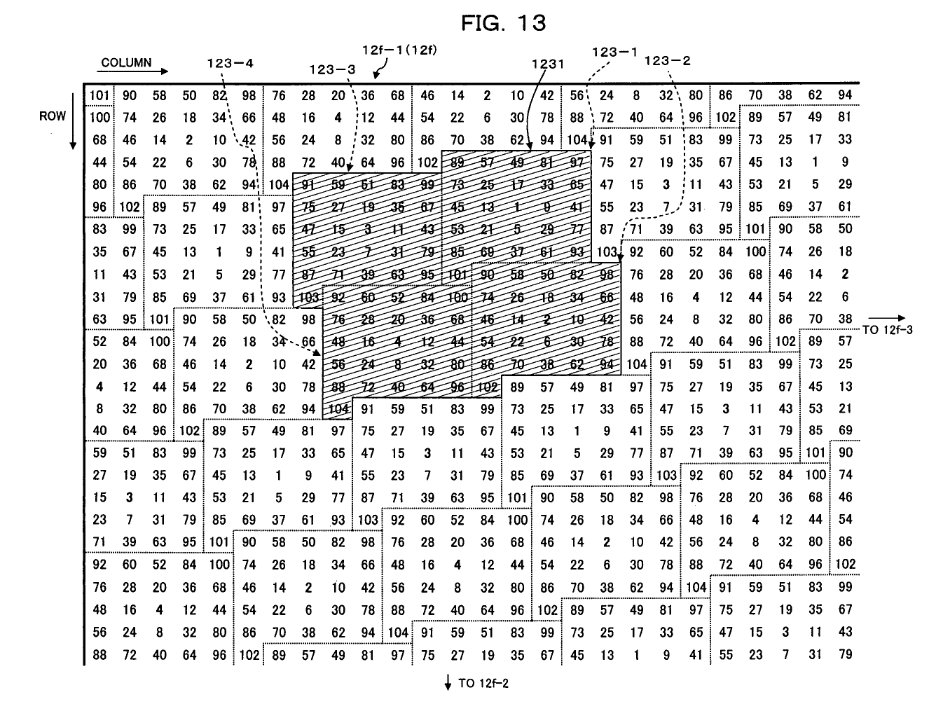

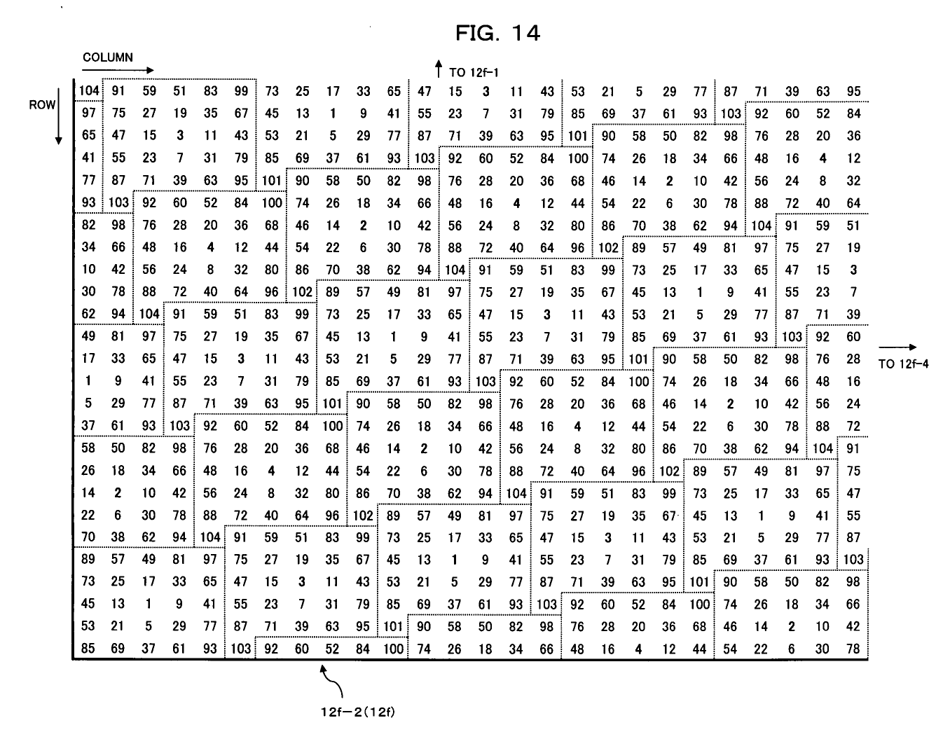

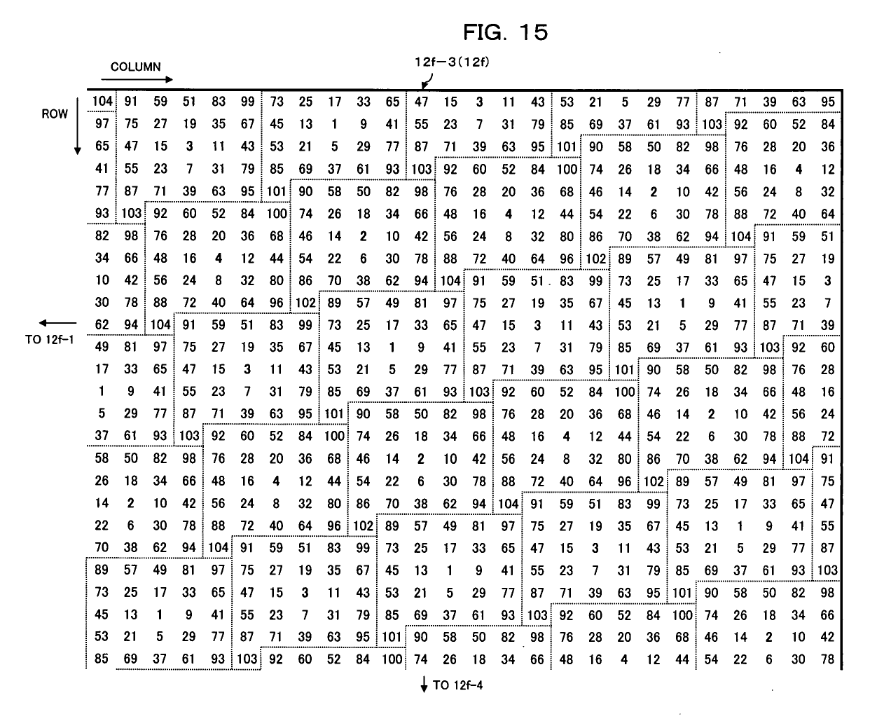

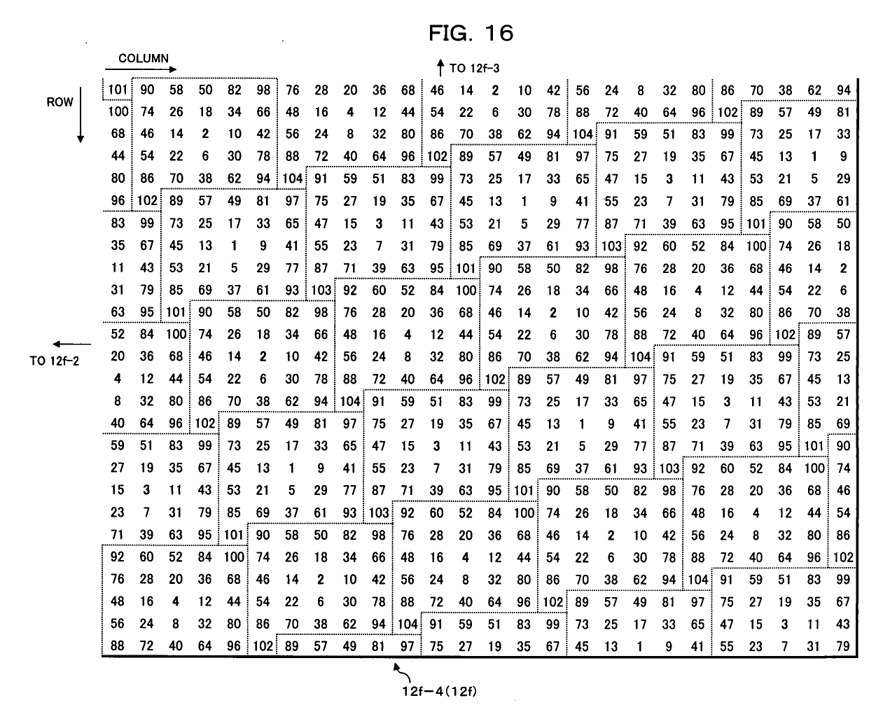

In the drawings, for the convenience of illustration, the binarization pattern 12f is shown divisionally in four figures, that is, FIGS. 13 to 16. In particular, if the binarization pattern 12f-1 shown in FIG. 13, binarization pattern 12f-2 shown in FIG. 14, binarization pattern 12f-3 shown in FIG. 15 and binarization pattern 12f-4 shown in FIG. 16 are combined, then the single binarization pattern 12f is indicated.

The binarization pattern 12f (12f-1, 12f-2, 12f-3, and 12f-4) shown in FIGS. 13 to 16 is formed from two thousand seven hundred four pixels arranged in a matrix of fifty-two rows and fifty-two columns, and is formed as a rectangular pattern wherein a plurality of pixels to be successively turned on are arranged in a matrix. Further, the binarization pattern 12f includes a plurality of sub patterns 1231 formed by arranging two basic patterns 123 shown in FIG. 11 in each of a vertical direction and a transverse direction (in the present modification, two basic patterns in a vertical direction and two basic patterns in a transverse direction, and hence totaling four basic patterns) such that the lacking portion of each basic pattern 123 is fitted with a portion of another basic pattern 123 at a point-symmetric position with respect to the center of the figure in the basic pattern 123 and a turn-on order appears repetitively and successively in a vertical direction (row arrangement direction) and a transverse direction (column arrangement direction) of the binarization pattern 12f without a clearance left therebetween. It is to be noted that, in FIG. 13, slanting lines are applied to several sub patterns 1231 for the convenience of illustration.

It is to be noted that, as a reference character which indicates a basic pattern, reference characters 123-1 to 123-n (n is a natural number) are used where one basic pattern must be specified from among a plurality of basic patterns, but reference numeral 123 is used when an arbitrary basic pattern is to be pointed to. Further, the number of basic patterns 123 which form a single sub pattern 1231 is represented by m. In particular, in the present modification, a relationship of 1≦n≦m (n and m are natural numbers) is satisfied.

In the binarization pattern 12f shown in FIGS. 13 to 16, the sub pattern 1231 includes four basic patterns 123, that is, 123-1 to 123-4. Therefore, n is an arbitrary natural number from among 1, 2, 3 and 4, and m is equal to 4.

In particular, the sub pattern 1231 is formed by arranging m (m=4) basic patterns 123 (123-1 to 123-n; where 1≦n≦m) formed such that, in a partly lacking matrix having six rows and five columns, the pixels of the first to fifth columns which form the first row of the partly lacking matrix are turned on n+22×mth, n+14×mth, n+12×mth, n+20×mth, and n+24×mth, respectively; the pixels of the first to fifth columns which form the second row of the partly lacking matrix are turned on n+18×mth, n+6×mth, n+4×mth, n+8×mth, and n+16×mth, respectively; the pixels of the first to fifth columns which form the third row of the partly lacking matrix are turned on n+11×mth, n+3×mth, nth, n+2×mth, and n+10×mth, respectively; the pixels of the first to fifth columns which form the fourth row of the partly lacking matrix are turned on n+13×mth, n+5×mth, n+mth, n+7×mth, and n+19×mth, respectively; the pixels of the first to fifth columns which form the fifth row of the partly lacking matrix are turned on n+21×mth, n+17×mth, n+9×mth, n+15×mth, and n+23×mth, respectively; and the pixel of the first column which forms the sixth row of the partly lacking matrix is turned on n+25×mth.

Further, in the sub pattern 1231 to which slanting lines are applied in FIG. 13, the basic pattern 123-2 is arranged on the lower side of the basic pattern 123-1; the basic pattern 123-3 is arranged on the left side of the basic pattern 123-1; and the basic pattern 123-4 is arranged on the lower side of the basic pattern 123-3. It is to be noted that the arrangement of the basic patterns 123-1 to 123-4 in the sub pattern 1231 is not limited to this, and variations and modifications can be made without departing from the scope of the present invention.

The binarization pattern 12f is formed by arranging a plurality of such sub patterns 1231 in a vertical direction and a transverse direction such that the basic patterns 123-1 and 123-3 of each sub pattern 1231 are fitted with the lacking portions of the basic patterns 123-2 and 123-4 in another sub pattern 1231 adjacent in a vertical direction and a turn-on order appears repetitively and successively in a vertical direction (row arrangement direction) and a transverse direction (column arrangement direction) of the binarization pattern 12f without a clearance left therebetween and then cutting out an arbitrary rectangular portion having fifty-two rows and fifty-two columns from the arranged basic patterns 123.

Further, the binarization pattern 12f includes a plurality of sub patterns 1231, and the turn-on order is set so that dots having shapes same as each other individually grow in order from the plural sub patterns 1231.

In particular, in the binarization pattern 12f, as shown in FIGS. 13 to 16, the turn-on order of the two thousand seven hundred four pixels is set such that:

(1) the pixels of the first to fifty-second columns which form the first row of the rectangular pattern are turned on 101st, 90th, 58th, 50th, 82nd, 98th, 76th, 28th, 20th, 36th, 68th, 46th, 14th, 2nd, 10th, 42nd, 56th, 24th, 8th, 32nd, 80th, 86th, 70th, 38th, 62nd, 94th, 104th, 91st, 59th, 51st, 83rd, 99th, 73rd, 25th, 17th, 33rd, 65th, 47th, 15th, 3rd, 11th, 43rd, 53rd, 21st, 5th, 29th, 77th, 87th, 71st, 39th, 63rd, and 95th, respectively;

(2) the pixels of the first to fifty-second columns which form the second row of the rectangular pattern are turned on 100th, 74th, 26th, 18th, 34th, 66th, 48th, 16th, 4th, 12th, 44th, 54th, 22nd, 6th, 30th, 78th, 88th, 72nd, 40th, 64th, 96th, 102nd, 89th, 57th, 49th, 81st, 97th, 75th, 27th, 19th, 35th, 67th, 45th, 13th, 1st, 9th, 41st, 55th, 23rd, 7th, 31st, 79th, 85th, 69th, 37th, 61st, 93rd, 103rd, 92nd, 60th, 52nd, and 84th, respectively;

(3) the pixels of the first to fifty-second columns which form the third row of the rectangular pattern are turned on 68th, 46th, 14th, 2nd, 10th, 42nd, 56th, 24th, 8th, 32nd, 80th, 86th, 70th, 38th, 62nd, 94th, 104th, 91st, 59th, 51st, 83rd, 99th, 73rd, 25th, 17th, 33rd, 65th, 47th, 15th, 3rd, 11th, 43rd, 53rd, 21st, 5th, 29th, 77th, 87th, 71st, 39th, 63rd, 95th, 101st, 90th, 58th, 50th, 82nd, 98th, 76th, 28th, 20th, and 36th, respectively;

(4) the pixels of the first to fifty-second columns which form the fourth row of the rectangular pattern are turned on 44th, 54th, 22nd, 6th, 30th, 78th, 88th, 72nd, 40th, 64th, 96th, 102nd, 89th, 57th, 49th, 81st, 97th, 75th, 27th, 19th, 35th, 67th, 45th, 13th, 1st, 9th, 41st, 55th, 23rd, 7th, 31st, 79th, 85th, 69th, 37th, 61st, 93rd, 103rd, 92nd, 60th, 52nd, 84th, 100th, 74th, 26th, 18th, 34th, 66th, 48th, 16th, 4th, and 12th, respectively;

(5) the pixels of the first to fifty-second columns which form the fifth row of the rectangular pattern are turned on 80th, 86th, 70th, 38th, 62nd, 94th, 104th, 91st, 59th, 51st, 83rd, 99th, 73rd, 25th, 17th, 33rd, 65th, 47th, 15th, 3rd, 11th, 43rd, 53rd, 21st, 5th, 29th, 77th, 87th, 71st, 39th, 63rd, 95th, 101st, 90th, 58th, 50th, 82nd, 98th, 76th, 28th, 20th, 36th, 68th, 46th, 14th, 2nd, 10th, 42nd, 56th, 24th, 8th, and 32nd, respectively;

(6) the pixels of the first to fifty-second columns which form the sixth row of the rectangular pattern are turned on 96th, 102nd, 89th, 57th, 49th, 81st, 97th, 75th, 27th, 19th, 35th, 67th, 45th, 13th, 1st, 9th, 41st, 55th, 23rd, 7th, 31st, 79th, 85th, 69th, 37th, 61st, 93rd, 103rd, 92nd, 60th, 52nd, 84th, 100th, 74th, 26th, 18th, 34th, 66th, 48th, 16th, 4th, 12th, 44th, 54th, 22nd, 6th, 30th, 78th, 88th, 72nd, 40th, and 64th, respectively;

(7) the pixels of the first to fifty-second columns which form the seventh row of the rectangular pattern are turned on 83rd, 99th, 73rd, 25th, 17th, 33rd, 65th, 47th, 15th, 3rd, 11th, 43rd, 53rd, 21st, 5th, 29th, 77th, 87th, 71st, 39th, 63rd, 95th, 101st, 90th, 58th, 50th, 82nd, 98th, 76th, 28th, 20th, 36th, 68th, 46th, 14th, 2nd, 10th, 42nd, 56th, 24th, 8th, 32nd, 80th, 86th, 70th, 38th, 62nd, 94th, 104th, 91st, 59th, and 51st, respectively;

(8) the pixels of the first to fifty-second columns which form the eighth row of the rectangular pattern are turned on 35th, 67th, 45th, 13th, 1st, 9th, 41st, 55th, 23rd, 7th, 31st, 79th, 85th, 69th, 37th, 61st, 93rd, 103rd, 92nd, 60th, 52nd, 84th, 100th, 74th, 26th, 18th, 34th, 66th, 48th, 16th, 4th, 12th, 44th, 54th, 22nd, 6th, 30th, 78th, 88th, 72nd, 40th, 64th, 96th, 102nd, 89th, 57th, 49th, 81st, 97th, 75th, 27th, and 19th, respectively;

(9) the pixels of the first to fifty-second columns which form the ninth row of the rectangular pattern are turned on 11th, 43rd, 53rd, 21st, 5th, 29th, 77th, 87th, 71st, 39th, 63rd, 95th, 101st, 90th, 58th, 50th, 82nd, 98th, 76th, 28th, 20th, 36th, 68th, 46th, 14th, 2nd, 10th, 42nd, 56th, 24th, 8th, 32nd, 80th, 86th, 70th, 38th, 62nd, 94th, 104th, 91st, 59th, 51st, 83rd, 99th, 73rd, 25th, 17th, 33rd, 65th, 47th, 15th, and 3rd, respectively;

(10) the pixels of the first to fifty-second columns which form the tenth row of the rectangular pattern are turned on 31st, 79th, 85th, 69th, 37th, 61st, 93rd, 103rd, 92nd, 60th, 52nd, 84th, 100th, 74th, 26th, 18th, 34th, 66th, 48th, 16th, 4th, 12th, 44th, 54th, 22nd, 6th, 30th, 78th, 88th, 72nd, 40th, 64th, 96th, 102nd, 89th, 57th, 49th, 81st, 97th, 75th, 27th, 19th, 35th, 67th, 45th, 13th, 1st, 9th, 41st, 55th, 23rd, and 7th, respectively;

(11) the pixels of the first to fifty-second columns which form the eleventh row of the rectangular pattern are turned on 63rd, 95th, 101st, 90th, 58th, 50th, 82nd, 98th, 76th, 28th, 20th, 36th, 68th, 46th, 14th, 2nd, 10th, 42nd, 56th, 24th, 8th, 32nd, 80th, 86th, 70th, 38th, 62nd, 94th, 104th, 91st, 59th, 51st, 83rd, 99th, 73rd, 25th, 17th, 33rd, 65th, 47th, 15th, 3rd, 11th, 43rd, 53rd, 21st, 5th, 29th, 77th, 87th, 71st, and 39th, respectively;

(12) the pixels of the first to fifty-second columns which form the twelfth row of the rectangular pattern are turned on 52nd, 84th, 100th, 74th, 26th, 18th, 34th, 66th, 48th, 16th, 4th, 12th, 44th, 54th, 22nd, 6th, 30th, 78th, 88th, 72nd, 40th, 64th, 96th, 102nd, 89th, 57th, 49th, 81st, 97th, 75th, 27th, 19th, 35th, 67th, 45th, 13th, 1st, 9th, 41st, 55th, 23rd, 7th, 31st, 79th, 85th, 69th, 37th, 61st, 93rd, 103rd, 92nd, and 60th, respectively;

(13) the pixels of the first to fifty-second columns which form the thirteenth row of the rectangular pattern are turned on 20th, 36th, 68th, 46th, 14th, 2nd, 10th, 42nd, 56th, 24th, 8th, 32nd, 80th, 86th, 70th, 38th, 62nd, 94th, 104th, 91st, 59th, 51st, 83rd, 99th, 73rd, 25th, 17th, 33rd, 65th, 47th, 15th, 3rd, 11th, 43rd, 53rd, 21st, 5th, 29th, 77th, 87th, 71st, 39th, 63rd, 95th, 101st, 90th, 58th, 50th, 82nd, 98th, 76th, and 28th, respectively;

(14) the pixels of the first to fifty-second columns which form the fourteenth row of the rectangular pattern are turned on 4th, 12th, 44th, 54th, 22nd, 6th, 30th, 78th, 88th, 72nd, 40th, 64th, 96th, 102nd, 89th, 57th, 49th, 81st, 97th, 75th, 27th, 19th, 35th, 67th, 45th, 13th, 1st, 9th, 41st, 55th, 23rd, 7th, 31st, 79th, 85th, 69th, 37th, 61st, 93rd, 103rd, 92nd, 60th, 52nd, 84th, 100th, 74th, 26th, 18th, 34th, 66th, 48th, and 16th, respectively;

(15) the pixels of the first to fifty-second columns which form the fifteenth row of the rectangular pattern are turned on 8th, 32nd, 80th, 86th, 70th, 38th, 62nd, 94th, 104th, 91st, 59th, 51st, 83rd, 99th, 73rd, 25th, 17th, 33rd, 65th, 47th, 15th, 3rd, 11th, 43rd, 53rd, 21st, 5th, 29th, 77th, 87th, 71st, 39th, 63rd, 95th, 101st, 90th, 58th, 50th, 82nd, 98th, 76th, 28th, 20th, 36th, 68th, 46th, 14th, 2nd, 10th, 42nd, 56th, and 24th, respectively;

(16) the pixels of the first to fifty-second columns which form the sixteenth row of the rectangular pattern are turned on 40th, 64th, 96th, 102nd, 89th, 57th, 49th, 81st, 97th, 75th, 27th, 19th, 35th, 67th, 45th, 13th, 1st, 9th, 41st, 55th, 23rd, 7th, 31st, 79th, 85th, 69th, 37th, 61st, 93rd, 103rd, 92nd, 60th, 52nd, 84th, 100th, 74th, 26th, 18th, 34th, 66th, 48th, 16th, 4th, 12th, 44th, 54th, 22nd, 6th, 30th, 78th, 88th, and 72nd, respectively;

(17) the pixels of the first to fifty-second columns which form the seventeenth row of the rectangular pattern are turned on 59th, 51st, 83rd, 99th, 73rd, 25th, 17th, 33rd, 65th, 47th, 15th, 3rd, 11th, 43rd, 53rd, 21st, 5th, 29th, 77th, 87th, 71st, 39th, 63rd, 95th, 101st, 90th, 58th, 50th, 82nd, 98th, 76th, 28th, 20th, 36th, 68th, 46th, 14th, 2nd, 10th, 42nd, 56th, 24th, 8th, 32nd, 80th, 86th, 70th, 38th, 62nd, 94th, 104th, and 91st, respectively;

(18) the pixels of the first to fifty-second columns which form the eighteenth row of the rectangular pattern are turned on 27th, 19th, 35th, 67th, 45th, 13th, 1st, 9th, 41st, 55th, 23rd, 7th, 31st, 79th, 85th, 69th, 37th, 61st, 93rd, 103rd, 92nd, 60th, 52nd, 84th, 100th, 74th, 26th, 18th, 34th, 66th, 48th, 16th, 4th, 12th, 44th, 54th, 22nd, 6th, 30th, 78th, 88th, 72nd, 40th, 64th, 96th, 102nd, 89th, 57th, 49th, 81st, 97th, and 75th, respectively;

(19) the pixels of the first to fifty-second columns which form the nineteenth row of the rectangular pattern are turned on 15th, 3rd, 11th, 43rd, 53rd, 21st, 5th, 29th, 77th, 87th, 71st, 39th, 63rd, 95th, 101st, 90th, 58th, 50th, 82nd, 98th, 76th, 28th, 20th, 36th, 68th, 46th, 14th, 2nd, 10th, 42nd, 56th, 24th, 8th, 32nd, 80th, 86th, 70th, 38th, 62nd, 94th, 104th, 91st, 59th, 51st, 83rd, 99th, 73rd, 25th, 17th, 33rd, 65th, and 47th, respectively;

(20) the pixels of the first to fifty-second columns which form the twentieth row of the rectangular pattern are turned on 23rd, 7th, 31st, 79th, 85th, 69th, 37th, 61st, 93rd, 103rd, 92nd, 60th, 52nd, 84th, 100th, 74th, 26th, 18th, 34th, 66th, 48th, 16th, 4th, 12th, 44th, 54th, 22nd, 6th, 30th, 78th, 88th, 72nd, 40th, 64th, 96th, 102nd, 89th, 57th, 49th, 81st, 97th, 75th, 27th, 19th, 35th, 67th, 45th, 13th, 1st, 9th, 41st, and 55th, respectively;

(21) the pixels of the first to fifty-second columns which form the twenty-first row of the rectangular pattern are turned on 71st, 39th, 63rd, 95th, 101st, 90th, 58th, 50th, 82nd, 98th, 76th, 28th, 20th, 36th, 68th, 46th, 14th, 2nd, 10th, 42nd, 56th, 24th, 8th, 32nd, 80th, 86th, 70th, 38th, 62nd, 94th, 104th, 91st, 59th, 51st, 83rd, 99th, 73rd, 25th, 17th, 33rd, 65th, 47th, 15th, 3rd, 11th, 43rd, 53rd, 21st, 5th, 29th, 77th, and 87th, respectively;

(22) the pixels of the first to fifty-second columns which form the twenty-second row of the rectangular pattern are turned on 92nd, 60th, 52nd, 84th, 100th, 74th, 26th, 18th, 34th, 66th, 48th, 16th, 4th, 12th, 44th, 54th, 22nd, 6th, 30th, 78th, 88th, 72nd, 40th, 64th, 96th, 102nd, 89th, 57th, 49th, 81st, 97th, 75th, 27th, 19th, 35th, 67th, 45th, 13th, 1st, 9th, 41st, 55th, 23rd, 7th, 31st, 79th, 85th, 69th, 37th, 61st, 93rd, and 103rd, respectively;

(23) the pixels of the first to fifty-second columns which form the twenty-third row of the rectangular pattern are turned on 76th, 28th, 20th, 36th, 68th, 46th, 14th, 2nd, 10th, 42nd, 56th, 24th, 8th, 32nd, 80th, 86th, 70th, 38th, 62nd, 94th, 104th, 91st, 59th, 51st, 83rd, 99th, 73rd, 25th, 17th, 33rd, 65th, 47th, 15th, 3rd, 11th, 43rd, 53rd, 21st, 5th, 29th, 77th, 87th, 71st, 39th, 63rd, 95th, 101st, 90th, 58th, 50th, 82nd, and 98th, respectively;

(24) the pixels of the first to fifty-second columns which form the twenty-fourth row of the rectangular pattern are turned on 48th, 16th, 4th, 12th, 44th, 54th, 22nd, 6th, 30th, 78th, 88th, 72nd, 40th, 64th, 96th, 102nd, 89th, 57th, 49th, 81st, 97th, 75th, 27th, 19th, 35th, 67th, 45th, 13th, 1st, 9th, 41st, 55th, 23rd, 7th, 31st, 79th, 85th, 69th, 37th, 61st, 93rd, 103rd, 92nd, 60th, 52nd, 84th, 100th, 74th, 26th, 18th, 34th, and 66th, respectively;

(25) the pixels of the first to fifty-second columns which form the twenty-fifth row of the rectangular pattern are turned on 56th, 24th, 8th, 32nd, 80th, 86th, 70th, 38th, 62nd, 94th, 104th, 91st, 59th, 51st, 83rd, 99th, 73rd, 25th, 17th, 33rd, 65th, 47th, 15th, 3rd, 11th, 43rd, 53rd, 21st, 5th, 29th, 77th, 87th, 71st, 39th, 63rd, 95th, 101st, 90th, 58th, 50th, 82nd, 98th, 76th, 28th, 20th, 36th, 68th, 46th, 14th, 2nd, 10th, and 42nd, respectively;

(26) the pixels of the first to fifty-second columns which form the twenty-sixth row of the rectangular pattern are turned on 88th, 72nd, 40th, 64th, 96th, 102nd, 89th, 57th, 49th, 81st, 97th, 75th, 27th, 19th, 35th, 67th, 45th, 13th, 1st, 9th, 41st, 55th, 23rd, 7th, 31st, 79th, 85th, 69th, 37th, 61st, 93rd, 103rd, 92nd, 60th, 52nd, 84th, 100th, 74th, 26th, 18th, 34th, 66th, 48th, 16th, 4th, 12th, 44th, 54th, 22nd, 6th, 30th, and 78th, respectively;

(27) the pixels of the first to fifty-second columns which form the twenty-seventh row of the rectangular pattern are turned on 104th, 91st, 59th, 51st, 83rd, 99th, 73rd, 25th, 17th, 33rd, 65th, 47th, 15th, 3rd, 11th, 43rd, 53rd, 21st, 5th, 29th, 77th, 87th, 71st, 39th, 63rd, 95th, 101st, 90th, 58th, 50th, 82nd, 98th, 76th, 28th, 20th, 36th, 68th, 46th, 14th, 2nd, 10th, 42nd, 56th, 24th, 8th, 32nd, 80th, 86th, 70th, 38th, 62nd, and 94th, respectively;

(28) the pixels of the first to fifty-second columns which form the twenty-eighth row of the rectangular pattern are turned on 97th, 75th, 27th, 19th, 35th, 67th, 45th, 13th, 1st, 9th, 41st, 55th, 23rd, 7th, 31st, 79th, 85th, 69th, 37th, 61st, 93rd, 103rd, 92nd, 60th, 52nd, 84th, 100th, 74th, 26th, 18th, 34th, 66th, 48th, 16th, 4th, 12th, 44th, 54th, 22nd, 6th, 30th, 78th, 88th, 72nd, 40th, 64th, 96th, 102nd, 89th, 57th, 49th, and 81st, respectively;

(29) the pixels of the first to fifty-second columns which form the twenty-ninth row of the rectangular pattern are turned on 65th, 47th, 15th, 3rd, 11th, 43rd, 53rd, 21st, 5th, 29th, 77th, 87th, 71st, 39th, 63rd, 95th, 101st, 90th, 58th, 50th, 82nd, 98th, 76th, 28th, 20th, 36th, 68th, 46th, 14th, 2nd, 10th, 42nd, 56th, 24th, 8th, 32nd, 80th, 86th, 70th, 38th, 62nd, 94th, 104th, 91st, 59th, 51st, 83rd, 99th, 73rd, 25th, 17th, and 33rd, respectively;

(30) the pixels of the first to fifty-second columns which form the thirtieth row of the rectangular pattern are turned on 41st, 55th, 23rd, 7th, 31st, 79th, 85th, 69th, 37th, 61st, 93rd, 103rd, 92nd, 60th, 52nd, 84th, 100th, 74th, 26th, 18th, 34th, 66th, 48th, 16th, 4th, 12th, 44th, 54th, 22nd, 6th, 30th, 78th, 88th, 72nd, 40th, 64th, 96th, 102nd, 89th, 57th, 49th, 81st, 97th, 75th, 27th, 19th, 35th, 67th, 45th, 13th, 1st, and 9th, respectively;

(31) the pixels of the first to fifty-second columns which form the thirty-first row of the rectangular pattern are turned on 77th, 87th, 71st, 39th, 63rd, 95th, 101st, 90th, 58th, 50th, 82nd, 98th, 76th, 28th, 20th, 36th, 68th, 46th, 14th, 2nd, 10th, 42nd, 56th, 24th, 8th, 32nd, 80th, 86th, 70th, 38th, 62nd, 94th, 104th, 91st, 59th, 51st, 83rd, 99th, 73rd, 25th, 17th, 33rd, 65th, 47th, 15th, 3rd, 11th, 43rd, 53rd, 21st, 5th, and 29th, respectively;

(32) the pixels of the first to fifty-second columns which form the thirty-second row of the rectangular pattern are turned on 93rd, 103rd, 92nd, 60th, 52nd, 84th, 100th, 74th, 26th, 18th, 34th, 66th, 48th, 16th, 4th, 12th, 44th, 54th, 22nd, 6th, 30th, 78th, 88th, 72nd, 40th, 64th, 96th, 102nd, 89th, 57th, 49th, 81st, 97th, 75th, 27th, 19th, 35th, 67th, 45th, 13th, 1st, 9th, 41st, 55th, 23rd, 7th, 31st, 79th, 85th, 69th, 37th, and 61st, respectively;

(33) the pixels of the first to fifty-second columns which form the thirty-third row of the rectangular pattern are turned on 82nd, 98th, 76th, 28th, 20th, 36th, 68th, 46th, 14th, 2nd, 10th, 42nd, 56th, 24th, 8th, 32nd, 80th, 86th, 70th, 38th, 62nd, 94th, 104th, 91st, 59th, 51st, 83rd, 99th, 73rd, 25th, 17th, 33rd, 65th, 47th, 15th, 3rd, 11th, 43rd, 53rd, 21st, 5th, 29th, 77th, 87th, 71st, 39th, 63rd, 95th, 101st, 90th, 58th, and 50th, respectively;

(34) the pixels of the first to fifty-second columns which form the thirty-fourth row of the rectangular pattern are turned on 34th, 66th, 48th, 16th, 4th, 12th, 44th, 54th, 22nd, 6th, 30th, 78th, 88th, 72nd, 40th, 64th, 96th, 102nd, 89th, 57th, 49th, 81st, 97th, 75th, 27th, 19th, 35th, 67th, 45th, 13th, 1st, 9th, 41st, 55th, 23rd, 7th, 31st, 79th, 85th, 69th, 37th, 61st, 93rd, 103rd, 92nd, 60th, 52nd, 84th, 100th, 74th, 26th, and 18th, respectively;

(35) the pixels of the first to fifty-second columns which form the thirty-fifth row of the rectangular pattern are turned on 10th, 42nd, 56th, 24th, 8th, 32nd, 80th, 86th, 70th, 38th, 62nd, 94th, 104th, 91st, 59th, 51st, 83rd, 99th, 73rd, 25th, 17th, 33rd, 65th, 47th, 15th, 3rd, 11th, 43rd, 53rd, 21st, 5th, 29th, 77th, 87th, 71st, 39th, 63rd, 95th, 101st, 90th, 58th, 50th, 82nd, 98th, 76th, 28th, 20th, 36th, 68th, 46th, 14th, and 2nd, respectively;

(36) the pixels of the first to fifty-second columns which form the thirty-sixth row of the rectangular pattern are turned on 30th, 78th, 88th, 72nd, 40th, 64th, 96th, 102nd, 89th, 57th, 49th, 81st, 97th, 75th, 27th, 19th, 35th, 67th, 45th, 13th, 1st, 9th, 41st, 55th, 23rd, 7th, 31st, 79th, 85th, 69th, 37th, 61st, 93rd, 103rd, 92nd, 60th, 52nd, 84th, 100th, 74th, 26th, 18th, 34th, 66th, 48th, 16th, 4th, 12th, 44th, 54th, 22nd, and 6th, respectively;

(37) the pixels of the first to fifty-second columns which form the thirty-seventh row of the rectangular pattern are turned on 62nd, 94th, 104th, 91st, 59th, 51st, 83rd, 99th, 73rd, 25th, 17th, 33rd, 65th, 47th, 15th, 3rd, 11th, 43rd, 53rd, 21st, 5th, 29th, 77th, 87th, 71st, 39th, 63rd, 95th, 101st, 90th, 58th, 50th, 82nd, 98th, 76th, 28th, 20th, 36th, 68th, 46th, 14th, 2nd, 10th, 42nd, 56th, 24th, 8th, 32nd, 80th, 86th, 70th, and 38th, respectively;

(38) the pixels of the first to fifty-second columns which form the thirty-eighth row of the rectangular pattern are turned on 49th, 81st, 97th, 75th, 27th, 19th, 35th, 67th, 45th, 13th, 1st, 9th, 41st, 55th, 23rd, 7th, 31st, 79th, 85th, 69th, 37th, 61st, 93rd, 103rd, 92nd, 60th, 52nd, 84th, 100th, 74th, 26th, 18th, 34th, 66th, 48th, 16th, 4th, 12th, 44th, 54th, 22nd, 6th, 30th, 78th, 88th, 72nd, 40th, 64th, 96th, 102nd, 89th, and 57th, respectively;

(39) the pixels of the first to fifty-second columns which form the thirty-ninth row of the rectangular pattern are turned on 17th, 33rd, 65th, 47th, 15th, 3rd, 11th, 43rd, 53rd, 21st, 5th, 29th, 77th, 87th, 71st, 39th, 63rd, 95th, 101st, 90th, 58th, 50th, 82nd, 98th, 76th, 28th, 20th, 36th, 68th, 46th, 14th, 2nd, 10th, 42nd, 56th, 24th, 8th, 32nd, 80th, 86th, 70th, 38th, 62nd, 94th, 104th, 91st, 59th, 51st, 83rd, 99th, 73rd, and 25th, respectively;

(40) the pixels of the first to fifty-second columns which form the fortieth row of the rectangular pattern are turned on 1st, 9th, 41st, 55th, 23rd, 7th, 31st, 79th, 85th, 69th, 37th, 61st, 93rd, 103rd, 92nd, 60th, 52nd, 84th, 100th, 74th, 26th, 18th, 34th, 66th, 48th, 16th, 4th, 12th, 44th, 54th, 22nd, 6th, 30th, 78th, 88th, 72nd, 40th, 64th, 96th, 102nd, 89th, 57th, 49th, 81st, 97th, 75th, 27th, 19th, 35th, 67th, 45th, and 13th, respectively;

(41) the pixels of the first to fifty-second columns which form the forty-first row of the rectangular pattern are turned on 5th, 29th, 77th, 87th, 71st, 39th, 63rd, 95th, 101st, 90th, 58th, 50th, 82nd, 98th, 76th, 28th, 20th, 36th, 68th, 46th, 14th, 2nd, 10th, 42nd, 56th, 24th, 8th, 32nd, 80th, 86th, 70th, 38th, 62nd, 94th, 104th, 91st, 59th, 51st, 83rd, 99th, 73rd, 25th, 17th, 33rd, 65th, 47th, 15th, 3rd, 11th, 43rd, 53rd, and 21st, respectively;

(42) the pixels of the first to fifty-second columns which form the forty-second row of the rectangular pattern are turned on 37th, 61st, 93rd, 103rd, 92nd, 60th, 52nd, 84th, 100th, 74th, 26th, 18th, 34th, 66th, 48th, 16th, 4th, 12th, 44th, 54th, 22nd, 6th, 30th, 78th, 88th, 72nd, 40th, 64th, 96th, 102nd, 89th, 57th, 49th, 81st, 97th, 75th, 27th, 19th, 35th, 67th, 45th, 13th, 1st, 9th, 41st, 55th, 23rd, 7th, 31st, 79th, 85th, and 69th, respectively;

(43) the pixels of the first to fifty-second columns which form the forty-third row of the rectangular pattern are turned on 58th, 50th, 82nd, 98th, 76th, 28th, 20th, 36th, 68th, 46th, 14th, 2nd, 10th, 42nd, 56th, 24th, 8th, 32nd, 80th, 86th, 70th, 38th, 62nd, 94th, 104th, 91st, 59th, 51st, 83rd, 99th, 73rd, 25th, 17th, 33rd, 65th, 47th, 15th, 3rd, 11th, 43rd, 53rd, 21st, 5th, 29th, 77th, 87th, 71st, 39th, 63rd, 95th, 101st, and 90th, respectively;

(44) the pixels of the first to fifty-second columns which form the forty-fourth row of the rectangular pattern are turned on 26th, 18th, 34th, 66th, 48th, 16th, 4th, 12th, 44th, 54th, 22nd, 6th, 30th, 78th, 88th, 72nd, 40th, 64th, 96th, 102nd, 89th, 57th, 49th, 81st, 97th, 75th, 27th, 19th, 35th, 67th, 45th, 13th, 1st, 9th, 41st, 55th, 23rd, 7th, 31st, 79th, 85th, 69th, 37th, 61st, 93rd, 103rd, 92nd, 60th, 52nd, 84th, 100th, and 74th, respectively;

(45) the pixels of the first to fifty-second columns which form the forty-fifth row of the rectangular pattern are turned on 14th, 2nd, 10th, 42nd, 56th, 24th, 8th, 32nd, 80th, 86th, 70th, 38th, 62nd, 94th, 104th, 91st, 59th, 51st, 83rd, 99th, 73rd, 25th, 17th, 33rd, 65th, 47th, 15th, 3rd, 11th, 43rd, 53rd, 21st, 5th, 29th, 77th, 87th, 71st, 39th, 63rd, 95th, 101st, 90th, 58th, 50th, 82nd, 98th, 76th, 28th, 20th, 36th, 68th, and 46th, respectively;

(46) the pixels of the first to fifty-second columns which form the forty-sixth row of the rectangular pattern are turned on 22nd, 6th, 30th, 78th, 88th, 72nd, 40th, 64th, 96th, 102nd, 89th, 57th, 49th, 81st, 97th, 75th, 27th, 19th, 35th, 67th, 45th, 13th, 1st, 9th, 41st, 55th, 23rd, 7th, 31st, 79th, 85th, 69th, 37th, 61st, 93rd, 103rd, 92nd, 60th, 52nd, 84th, 100th, 74th, 26th, 18th, 34th, 66th, 48th, 16th, 4th, 12th, 44th, and 54th, respectively;

(47) the pixels of the first to fifty-second columns which form the forty-seventh row of the rectangular pattern are turned on 70th, 38th, 62nd, 94th, 104th, 91st, 59th, 51st, 83rd, 99th, 73rd, 25th, 17th, 33rd, 65th, 47th, 15th, 3rd, 11th, 43rd, 53rd, 21st, 5th, 29th, 77th, 87th, 71st, 39th, 63rd, 95th, 101st, 90th, 58th, 50th, 82nd, 98th, 76th, 28th, 20th, 36th, 68th, 46th, 14th, 2nd, 10th, 42nd, 56th, 24th, 8th, 32nd, 80th, and 86th, respectively;

(48) the pixels of the first to fifty-second columns which form the forty-eighth row of the rectangular pattern are turned on 89th, 57th, 49th, 81st, 97th, 75th, 27th, 19th, 35th, 67th, 45th, 13th, 1st, 9th, 41st, 55th, 23rd, 7th, 31st, 79th, 85th, 69th, 37th, 61st, 93rd, 103rd, 92nd, 60th, 52nd, 84th, 100th, 74th, 26th, 18th, 34th, 66th, 48th, 16th, 4th, 12th, 44th, 54th, 22nd, 6th, 30th, 78th, 88th, 72nd, 40th, 64th, 96th, and 102nd, respectively;

(49) the pixels of the first to fifty-second columns which form the forty-ninth row of the rectangular pattern are turned on 73rd, 25th, 17th, 33rd, 65th, 47th, 15th, 3rd, 11th, 43rd, 53rd, 21st, 5th, 29th, 77th, 87th, 71st, 39th, 63rd, 95th, 101st, 90th, 58th, 50th, 82nd, 98th, 76th, 28th, 20th, 36th, 68th, 46th, 14th, 2nd, 10th, 42nd, 56th, 24th, 8th, 32nd, 80th, 86th, 70th, 38th, 62nd, 94th, 104th, 91st, 59th, 51st, 83rd, and 99th, respectively;

(50) the pixels of the first to fifty-second columns which form the fiftieth row of the rectangular pattern are turned on 45th, 13th, 1st, 9th, 41st, 55th, 23rd, 7th, 31st, 79th, 85th, 69th, 37th, 61st, 93rd, 103rd, 92nd, 60th, 52nd, 84th, 100th, 74th, 26th, 18th, 34th, 66th, 48th, 16th, 4th, 12th, 44th, 54th, 22nd, 6th, 30th, 78th, 88th, 72nd, 40th, 64th, 96th, 102nd, 89th, 57th, 49th, 81st, 97th, 75th, 27th, 19th, 35th, and 67th, respectively;

(51) the pixels of the first to fifty-second columns which form the fifty-first row of the rectangular pattern are turned on 53rd, 21st, 5th, 29th, 77th, 87th, 71st, 39th, 63rd, 95th, 101st, 90th, 58th, 50th, 82nd, 98th, 76th, 28th, 20th, 36th, 68th, 46th, 14th, 2nd, 10th, 42nd, 56th, 24th, 8th, 32nd, 80th, 86th, 70th, 38th, 62nd, 94th, 104th, 91st, 59th, 51st, 83rd, 99th, 73rd, 25th, 17th, 33rd, 65th, 47th, 15th, 3rd, 11th, and 43rd, respectively; and

(52) the pixels of the first to fifty-second columns which form the fifty-second row of the rectangular pattern are turned on 85th, 69th, 37th, 61st, 93rd, 103rd, 92nd, 60th, 52nd, 84th, 100th, 74th, 26th, 18th, 34th, 66th, 48th, 16th, 4th, 12th, 44th, 54th, 22nd, 6th, 30th, 78th, 88th, 72nd, 40th, 64th, 96th, 102nd, 89th, 57th, 49th, 81st, 97th, 75th, 27th, 19th, 35th, 67th, 45th, 13th, 1st, 9th, 41st, 55th, 23rd, 7th, 31st, and 79th, respectively.

Further, the turn-on order is set so that dots having shapes same as each other individually grow in order from a plurality of points.

Similarly to the binarization pattern 12e, also the binarization pattern 12f is a binarization pattern having a dither angle (screen angle, half tone angle) of 11.3 degrees and an output line number of 117.7 lpi.

It is to be noted that, by using the binarization pattern 12f, the pixel value (for example, within a range from 0 to 255) of each of pixels which form a multi-value image (original image) to be printed can be represented in one hundred five stages (gradations).

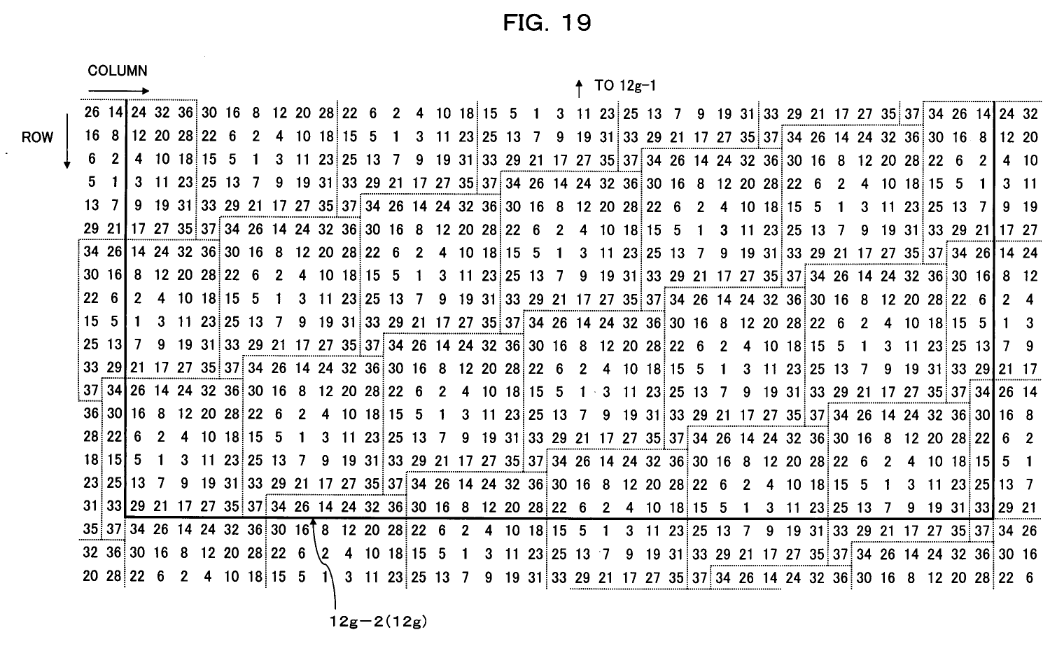

Also the binarization pattern 12g shown in FIGS. 18 and 19 is a rectangular pattern wherein a plurality of pixels to be successively turned on are arranged in a matrix, and is formed from one thousand three hundred sixty-nine pixels arranged in a matrix of thirty-seven rows and thirty-seven columns (rectangular pattern). Further, a turn-on order number is individually set to each of the pixels.

In the drawings, for the convenience of illustration, the binarization pattern 12g is shown divisionally in two figures, that is, FIGS. 18 and 19. In particular, if the binarization pattern 12g-1 shown in FIG. 18 and binarization pattern 12g-2 shown in FIG. 19 are combined, then the single binarization pattern 12g is indicated.

Further, in the binarization pattern 12g, as shown in FIGS. 18 and 19, a turn-on order is set so that dots having shapes same as each other individually grow in order from a plurality of points (in the binarization pattern 12g, pixels to which the number 1 is applied).

The binarization pattern 12g is formed by repetitively arranging the basic pattern 124 shown in FIG. 17 in a vertical direction and a transverse direction. As shown in FIG. 17, the basic pattern 124 is a partly lacking matrix formed by cutting away part of a rectangular matrix formed from forty-two pixels of seven rows and six columns. In the present modification, the basic pattern 124 is formed by cutting away five pixels at lower right positions (in particular, pixels of the second to sixth columns of the seventh row) of the rectangular matrix.

Further, in the basic pattern 124, where a picture element already turned on and positioned nearest to a specific point (in the present modification, the center of the figure of the basic pattern 124) in the basic pattern 124 exists as shown in FIG. 17, an unturned on picture element adjacent the turned on picture element is turned on and then a picture element at a point-symmetric position with respect to the specific point of the basic pattern 124 is turned on. Consequently, the turn-on order is set so that a dot grows in a substantially circular form.

In particular, in the basic pattern 124 shown in FIG. 17, a color material is placed on the pixels in order from a pixel having a low order number to another pixel having a higher order number. Therefore, a dot grows in a substantially circular form in order from the proximity of the center of the figure (specific point) of the basic pattern 124, and the binarization pattern 12g functions as a binarization pattern (binarization dither matrix pattern; dither pattern) of the dot concentration type.

In particular, the basic pattern 124 is formed such that, in a partly lacking matrix of seven rows and six columns, the pixels of the first to sixth columns which form the first row of the partly lacking matrix are turned on 34th, 26th, 14th, 24th, 32nd, and 36th, respectively; the pixels of the first to sixth columns which form the second row of the partly lacking matrix are turned on 30th, 16th, 8th, 12th, 20th, and 28th, respectively; the pixels of the first to sixth columns which form the third row of the partly lacking matrix are turned on 22nd, 6th, 2nd, 4th, 10th, and 18th, respectively; the pixels of the first to sixth columns which form the fourth row of the partly lacking matrix are turned on 15th, 5th, 1st, 3rd, 11th, and 23rd, respectively; the pixels of the first to sixth columns which form the fifth row of the partly lacking matrix are turned on 25th, 13th, 7th, 9th, 19th, and 31st, respectively; the pixels of the first to sixth columns which form the sixth row of the partly lacking matrix are turned on 33rd, 29th, 21st, 17th, 27th, and 35th, respectively; and the picture element of the first column which forms the seventh row of the partly lacking matrix is turned on 37th.

As shown in FIGS. 18 and 19, the binarization pattern 12g is formed by arranging such basic patterns (partly lacking matrixes) 124 such that the lacking portion (in FIG. 17, a lower right portion) of each basic pattern 124 is fitted with a portion (in FIG. 17, an upper left portion) of another basic pattern 124 at a point-symmetric position with respect to the center of the figure in the basic pattern 124 and a turn-on order appears repetitively and successively in a vertical direction (row arrangement direction) and a transverse direction (column arrangement direction) of the binarization pattern 12g without a clearance left therebetween and then cutting out an arbitrary rectangular portion (refer to thick lines of FIGS. 18 and 19) having thirty-seven rows and thirty-seven columns from the arranged basic patterns 124.

Further, in the binarization pattern 12g, the turn-on order is set so that dots having shapes same as each other individually grow in order from the basic patterns 124 provided in the binarization pattern 12g.

In particular, in the binarization pattern 12g, the turn-on order of one thousand three hundred sixty-nine pixels is set such that:

(1) the pixels of the first to thirty-seventh columns which form the first row of the rectangular pattern are turned on 34th, 26th, 14th, 24th, 32nd, 36th, 30th, 16th, 8th, 12th, 20th, 28th, 22nd, 6th, 2nd, 4th, 10th, 18th, 15th, 5th, 1st, 3rd, 11th, 23rd, 25th, 13th, 7th, 9th, 19th, 31st, 33rd, 29th, 21st, 17th, 27th, 35th, and 37th, respectively;

(2) the pixels of the first to thirty-seventh columns which form the second row of the rectangular pattern are turned on 30th, 16th, 8th, 12th, 20th, 28th, 22nd, 6th, 2nd, 4th, 10th, 18th, 15th, 5th, 1st, 3rd, 11th, 23rd, 25th, 13th, 7th, 9th, 19th, 31st, 33rd, 29th, 21st, 17th, 27th, 35th, 37th, 34th, 26th, 14th, 24th, 32nd, and 36th, respectively;

(3) the pixels of the first to thirty-seventh columns which form the third row of the rectangular pattern are turned on 22nd, 6th, 2nd, 4th, 10th, 18th, 15th, 5th, 1st, 3rd, 11th, 23rd, 25th, 13th, 7th, 9th, 19th, 31st, 33rd, 29th, 21st, 17th, 27th, 35th, 37th, 34th, 26th, 14th, 24th, 32nd, 36th, 30th, 16th, 8th, 12th, 20th, and 28th, respectively;

(4) the pixels of the first to thirty-seventh columns which form the fourth row of the rectangular pattern are turned on 15th, 5th, 1st, 3rd, 11th, 23rd, 25th, 13th, 7th, 9th, 19th, 31st, 33rd, 29th, 21st, 17th, 27th, 35th, 37th, 34th, 26th, 14th, 24th, 32nd, 36th, 30th, 16th, 8th, 12th, 20th, 28th, 22nd, 6th, 2nd, 4th, 10th, and 18th, respectively;

(5) the pixels of the first to thirty-seventh columns which form the fifth row of the rectangular pattern are turned on 25th, 13th, 7th, 9th, 19th, 31st, 33rd, 29th, 21st, 17th, 27th, 35th, 37th, 34th, 26th, 14th, 24th, 32nd, 36th, 30th, 16th, 8th, 12th, 20th, 28th, 22nd, 6th, 2nd, 4th, 10th, 18th, 15th, 5th, 1st, 3rd, 11th, and 23rd, respectively;

(6) the pixels of the first to thirty-seventh columns which form the sixth row of the rectangular pattern are turned on 33rd, 29th, 21st, 17th, 27th, 35th, 37th, 34th, 26th, 14th, 24th, 32nd, 36th, 30th, 16th, 8th, 12th, 20th, 28th, 22nd, 6th, 2nd, 4th, 10th, 18th, 15th, 5th, 1st, 3rd, 11th, 23rd, 25th, 13th, 7th, 9th, 19th, and 31st, respectively;

(7) the pixels of the first to thirty-seventh columns which form the seventh row of the rectangular pattern are turned on 37th, 34th, 26th, 14th, 24th, 32nd, 36th, 30th, 16th, 8th, 12th, 20th, 28th, 22nd, 6th, 2nd, 4th, 10th, 18th, 15th, 5th, 1st, 3rd, 11th, 23rd, 25th, 13th, 7th, 9th, 19th, 31st, 33rd, 29th, 21st, 17th, 27th, and 35th, respectively;

(8) the pixels of the first to thirty-seventh columns which form the eighth row of the rectangular pattern are turned on 36th, 30th, 16th, 8th, 12th, 20th, 28th, 22nd, 6th, 2nd, 4th, 10th, 18th, 15th, 5th, 1st, 3rd, 11th, 23rd, 25th, 13th, 7th, 9th, 19th, 31st, 33rd, 29th, 21st, 17th, 27th, 35th, 37th, 34th, 26th, 14th, 24th, and 32nd, respectively;

(9) the pixels of the first to thirty-seventh columns which form the ninth row of the rectangular pattern are turned on 28th, 22nd, 6th, 2nd, 4th, 10th, 18th, 15th, 5th, 1st, 3rd, 11th, 23rd, 25th, 13th, 7th, 9th, 19th, 31st, 33rd, 29th, 21st, 17th, 27th, 35th, 37th, 34th, 26th, 14th, 24th, 32nd, 36th, 30th, 16th, 8th, 12th, and 20th, respectively;

(10) the pixels of the first to thirty-seventh columns which form the tenth row of the rectangular pattern are turned on 18th, 15th, 5th, 1st, 3rd, 11th, 23rd, 25th, 13th, 7th, 9th, 19th, 31st, 33rd, 29th, 21st, 17th, 27th, 35th, 37th, 34th, 26th, 14th, 24th, 32nd, 36th, 30th, 16th, 8th, 12th, 20th, 28th, 22nd, 6th, 2nd, 4th, and 10th, respectively;

(11) the pixels of the first to thirty-seventh columns which form the eleventh row of the rectangular pattern are turned on 23rd, 25th, 13th, 7th, 9th, 19th, 31st, 33rd, 29th, 21st, 17th, 27th, 35th, 37th, 34th, 26th, 14th, 24th, 32nd, 36th, 30th, 16th, 8th, 12th, 20th, 28th, 22nd, 6th, 2nd, 4th, 10th, 18th, 15th, 5th, 1st, 3rd, and 11th, respectively;

(12) the pixels of the first to thirty-seventh columns which form the twelfth row of the rectangular pattern are turned on 31st, 33rd, 29th, 21st, 17th, 27th, 35th, 37th, 34th, 26th, 14th, 24th, 32nd, 36th, 30th, 16th, 8th, 12th, 20th, 28th, 22nd, 6th, 2nd, 4th, 10th, 18th, 15th, 5th, 1st, 3rd, 11th, 23rd, 25th, 13th, 7th, 9th, and 19th, respectively;

(13) the pixels of the first to thirty-seventh columns which form the thirteenth row of the rectangular pattern are turned on 35th, 37th, 34th, 26th, 14th, 24th, 32nd, 36th, 30th, 16th, 8th, 12th, 20th, 28th, 22nd, 6th, 2nd, 4th, 10th, 18th, 15th, 5th, 1st, 3rd, 11th, 23rd, 25th, 13th, 7th, 9th, 19th, 31st, 33rd, 29th, 21st, 17th, and 27th, respectively;

(14) the pixels of the first to thirty-seventh columns which form the fourteenth row of the rectangular pattern are turned on 32nd, 36th, 30th, 16th, 8th, 12th, 20th, 28th, 22nd, 6th, 2nd, 4th, 10th, 18th, 15th, 5th, 1st, 3rd, 11th, 23rd, 25th, 13th, 7th, 9th, 19th, 31st, 33rd, 29th, 21st, 17th, 27th, 35th, 37th, 34th, 26th, 14th, and 24th, respectively;

(15) the pixels of the first to thirty-seventh columns which form the fifteenth row of the rectangular pattern are turned on 20th, 28th, 22nd, 6th, 2nd, 4th, 10th, 18th, 15th, 5th, 1st, 3rd, 11th, 23rd, 25th, 13th, 7th, 9th, 19th, 31st, 33rd, 29th, 21st, 17th, 27th, 35th, 37th, 34th, 26th, 14th, 24th, 32nd, 36th, 30th, 16th, 8th, and 12th, respectively;

(16) the pixels of the first to thirty-seventh columns which form the sixteenth row of the rectangular pattern are turned on 10th, 18th, 15th, 5th, 1st, 3rd, 11th, 23rd, 25th, 13th, 7th, 9th, 19th, 31st, 33rd, 29th, 21st, 17th, 27th, 35th, 37th, 34th, 26th, 14th, 24th, 32nd, 36th, 30th, 16th, 8th, 12th, 20th, 28th, 22nd, 6th, 2nd, and 4th, respectively;

(17) the pixels of the first to thirty-seventh columns which form the seventeenth row of the rectangular pattern are turned on 11th, 23rd, 25th, 13th, 7th, 9th, 19th, 31st, 33rd, 29th, 21st, 17th, 27th, 35th, 37th, 34th, 26th, 14th, 24th, 32nd, 36th, 30th, 16th, 8th, 12th, 20th, 28th, 22nd, 6th, 2nd, 4th, 10th, 18th, 15th, 5th, 1st, and 3rd, respectively;

(18) the pixels of the first to thirty-seventh columns which form the eighteenth row of the rectangular pattern are turned on 19th, 31st, 33rd, 29th, 21st, 17th, 27th, 35th, 37th, 34th, 26th, 14th, 24th, 32nd, 36th, 30th, 16th, 8th, 12th, 20th, 28th, 22nd, 6th, 2nd, 4th, 10th, 18th, 15th, 5th, 1st, 3rd, 11th, 23rd, 25th, 13th, 7th, and 9th, respectively;

(19) the pixels of the first to thirty-seventh columns which form the nineteenth row of the rectangular pattern are turned on 27th, 35th, 37th, 34th, 26th, 14th, 24th, 32nd, 36th, 30th, 16th, 8th, 12th, 20th, 28th, 22nd, 6th, 2nd, 4th, 10th, 18th, 15th, 5th, 1st, 3rd, 11th, 23rd, 25th, 13th, 7th, 9th, 19th, 31st, 33rd, 29th, 21st, and 17th, respectively;

(20) the pixels of the first to thirty-seventh columns which form the twentieth row of the rectangular pattern are turned on 24th, 32nd, 36th, 30th, 16th, 8th, 12th, 20th, 28th, 22nd, 6th, 2nd, 4th, 10th, 18th, 15th, 5th, 1st, 3rd, 11th, 23rd, 25th, 13th, 7th, 9th, 19th, 31st, 33rd, 29th, 21st, 17th, 27th, 35th, 37th, 34th, 26th, and 14th, respectively;

(21) the pixels of the first to thirty-seventh columns which form the twenty-first row of the rectangular pattern are turned on 12th, 20th, 28th, 22nd, 6th, 2nd, 4th, 10th, 18th, 15th, 5th, 1st, 3rd, 11th, 23rd, 25th, 13th, 7th, 9th, 19th, 31st, 33rd, 29th, 21st, 17th, 27th, 35th, 37th, 34th, 26th, 14th, 24th, 32nd, 36th, 30th, 16th, and 8th, respectively;

(22) the pixels of the first to thirty-seventh columns which form the twenty-second row of the rectangular pattern are turned on 4th, 10th, 18th, 15th, 5th, 1st, 3rd, 11th, 23rd, 25th, 13th, 7th, 9th, 19th, 31st, 33rd, 29th, 21st, 17th, 27th, 35th, 37th, 34th, 26th, 14th, 24th, 32nd, 36th, 30th, 16th, 8th, 12th, 20th, 28th, 22nd, 6th, and 2nd, respectively;

(23) the pixels of the first to thirty-seventh columns which form the twenty-third row of the rectangular pattern are turned on 3rd, 11th, 23rd, 25th, 13th, 7th, 9th, 19th, 31st, 33rd, 29th, 21st, 17th, 27th, 35th, 37th, 34th, 26th, 14th, 24th, 32nd, 36th, 30th, 16th, 8th, 12th, 20th, 28th, 22nd, 6th, 2nd, 4th, 10th, 18th, 15th, 5th, and 1st, respectively;

(24) the pixels of the first to thirty-seventh columns which form the twenty-fourth row of the rectangular pattern are turned on 9th, 19th, 31st, 33rd, 29th, 21st, 17th, 27th, 35th, 37th, 34th, 26th, 14th, 24th, 32nd, 36th, 30th, 16th, 8th, 12th, 20th, 28th, 22nd, 6th, 2nd, 4th, 10th, 18th, 15th, 5th, 1st, 3rd, 11th, 23rd, 25th, 13th, and 7th, respectively;

(25) the pixels of the first to thirty-seventh columns which form the twenty-fifth row of the rectangular pattern are turned on 17th, 27th, 35th, 37th, 34th, 26th, 14th, 24th, 32nd, 36th, 30th, 16th, 8th, 12th, 20th, 28th, 22nd, 6th, 2nd, 4th, 10th, 18th, 15th, 5th, 1st, 3rd, 11th, 23rd, 25th, 13th, 7th, 9th, 19th, 31st, 33rd, 29th, and 21st, respectively;

(26) the pixels of the first to thirty-seventh columns which form the twenty-sixth row of the rectangular pattern are turned on 14th, 24th, 32nd, 36th, 30th, 16th, 8th, 12th, 20th, 28th, 22nd, 6th, 2nd, 4th, 10th, 18th, 15th, 5th, 1st, 3rd, 11th, 23rd, 25th, 13th, 7th, 9th, 19th, 31st, 33rd, 29th, 21st, 17th, 27th, 35th, 37th, 34th, and 26th, respectively;

(27) the pixels of the first to thirty-seventh columns which form the twenty-seventh row of the rectangular pattern are turned on 8th, 12th, 20th, 28th, 22nd, 6th, 2nd, 4th, 10th, 18th, 15th, 5th, 1st, 3rd, 11th, 23rd, 25th, 13th, 7th, 9th, 19th, 31st, 33rd, 29th, 21st, 17th, 27th, 35th, 37th, 34th, 26th, 14th, 24th, 32nd, 36th, 30th, and 16th, respectively;

(28) the pixels of the first to thirty-seventh columns which form the twenty-eighth row of the rectangular pattern are turned on 2nd, 4th, 10th, 18th, 15th, 5th, 1st, 3rd, 11th, 23rd, 25th, 13th, 7th, 9th, 19th, 31st, 33rd, 29th, 21st, 17th, 27th, 35th, 37th, 34th, 26th, 14th, 24th, 32nd, 36th, 30th, 16th, 8th, 12th, 20th, 28th, 22nd, and 6th, respectively;

(29) the pixels of the first to thirty-seventh columns which form the twenty-ninth row of the rectangular pattern are turned on 1st, 3rd, 11th, 23rd, 25th, 13th, 7th, 9th, 19th, 31st, 33rd, 29th, 21st, 17th, 27th, 35th, 37th, 34th, 26th, 14th, 24th, 32nd, 36th, 30th, 16th, 8th, 12th, 20th, 28th, 22nd, 6th, 2nd, 4th, 10th, 18th, 15th, and 5th, respectively;

(30) the pixels of the first to thirty-seventh columns which form the thirtieth row of the rectangular pattern are turned on 7th, 9th, 19th, 31st, 33rd, 29th, 21st, 17th, 27th, 35th, 37th, 34th, 26th, 14th, 24th, 32nd, 36th, 30th, 16th, 8th, 12th, 20th, 28th, 22nd, 6th, 2nd, 4th, 10th, 18th, 15th, 5th, 1st, 3rd, 11th, 23rd, 25th, and 13th, respectively;

(31) the pixels of the first to thirty-seventh columns which form the thirty-first row of the rectangular pattern are turned on 21st, 17th, 27th, 35th, 37th, 34th, 26th, 14th, 24th, 32nd, 36th, 30th, 16th, 8th, 12th, 20th, 28th, 22nd, 6th, 2nd, 4th, 10th, 18th, 15th, 5th, 1st, 3rd, 11th, 23rd, 25th, 13th, 7th, 9th, 19th, 31st, 33rd, and 29th, respectively;

(32) the pixels of the first to thirty-seventh columns which form the thirty-second row of the rectangular pattern are turned on 26th, 14th, 24th, 32nd, 36th, 30th, 16th, 8th, 12th, 20th, 28th, 22nd, 6th, 2nd, 4th, 10th, 18th, 15th, 5th, 1st, 3rd, 11th, 23rd, 25th, 13th, 7th, 9th, 19th, 31st, 33rd, 29th, 21st, 17th, 27th, 35th, 37th, and 34th, respectively;

(33) the pixels of the first to thirty-seventh columns which form the thirty-third row of the rectangular pattern are turned on 16th, 8th, 12th, 20th, 28th, 22nd, 6th, 2nd, 4th, 10th, 18th, 15th, 5th, 1st, 3rd, 11th, 23rd, 25th, 13th, 7th, 9th, 19th, 31st, 33rd, 29th, 21st, 17th, 27th, 35th, 37th, 34th, 26th, 14th, 24th, 32nd, 36th, and 30th, respectively;

(34) the pixels of the first to thirty-seventh columns which form the thirty-fourth row of the rectangular pattern are turned on 6th, 2nd, 4th, 10th, 18th, 15th, 5th, 1st, 3rd, 11th, 23rd, 25th, 13th, 7th, 9th, 19th, 31st, 33rd, 29th, 21st, 17th, 27th, 35th, 37th, 34th, 26th, 14th, 24th, 32nd, 36th, 30th, 16th, 8th, 12th, 20th, 28th, and 22nd, respectively;

(35) the pixels of the first to thirty-seventh columns which form the thirty-fifth row of the rectangular pattern are turned on 5th, 1st, 3rd, 11th, 23rd, 25th, 13th, 7th, 9th, 19th, 31st, 33rd, 29th, 21st, 17th, 27th, 35th, 37th, 34th, 26th, 14th, 24th, 32nd, 36th, 30th, 16th, 8th, 12th, 20th, 28th, 22nd, 6th, 2nd, 4th, 10th, 18th, and 15th, respectively;

(36) the pixels of the first to thirty-seventh columns which form the thirty-sixth row of the rectangular pattern are turned on 13th, 7th, 9th, 19th, 31st, 33rd, 29th, 21st, 17th, 27th, 35th, 37th, 34th, 26th, 14th, 24th, 32nd, 36th, 30th, 16th, 8th, 12th, 20th, 28th, 22nd, 6th, 2nd, 4th, 10th, 18th, 15th, 5th, 1st, 3rd, 11th, 23rd, and 25th, respectively; and

(37) the pixels of the first to thirty-seventh columns which form the thirty-seventh row of the rectangular pattern are turned on 29th, 21st, 17th, 27th, 35th, 37th, 34th, 26th, 14th, 24th, 32nd, 36th, 30th, 16th, 8th, 12th, 20th, 28th, 22nd, 6th, 2nd, 4th, 10th, 18th, 15th, 5th, 1st, 3rd, 11th, 23rd, 25th, 13th, 7th, 9th, 19th, 31st, and 33rd, respectively.

Further, in the binarization pattern 12g, the dither angle (screen angle, halftone dot angle) is 9.5 degrees.

In particular, the binarization pattern 12g shown in FIGS. 18 and 19 is a binarization pattern having a dither angle of 9.5 degrees and an output line number of 98.6 lpi.

It is to be noted that, by using the binarization pattern 12g, the picture element value (for example, within a range from 0 to 255) of each of pixels which form a multi-value image (original image) to be printed can be represented in thirty-eight stages (gradation).

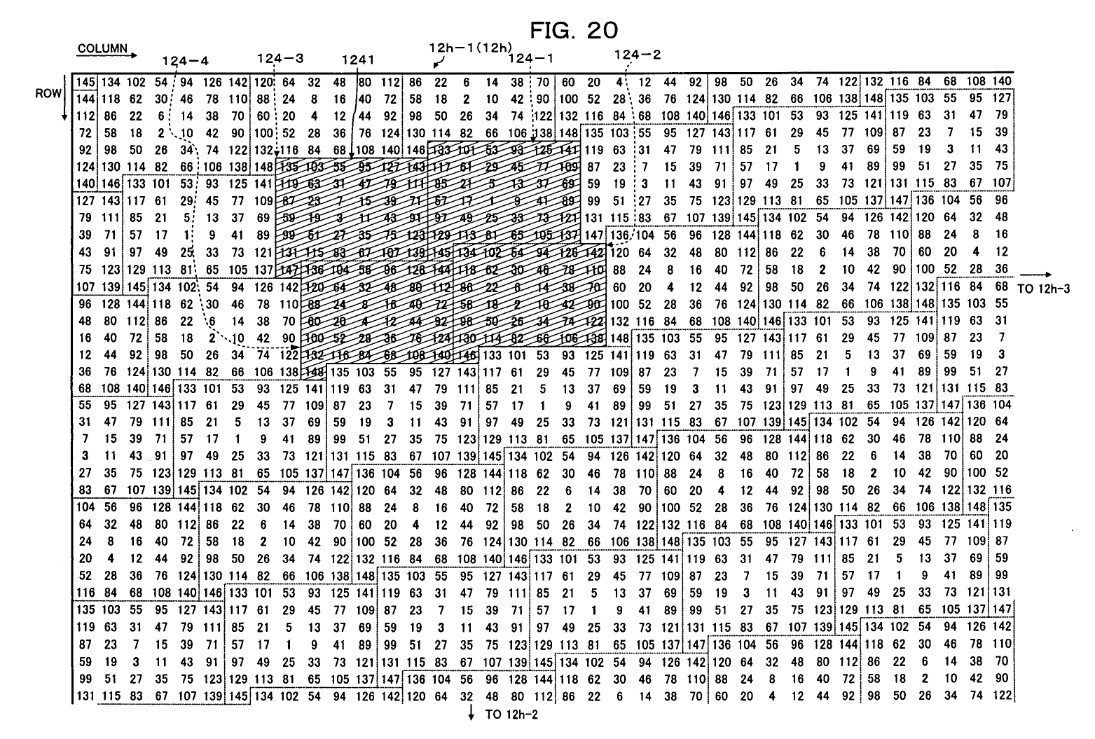

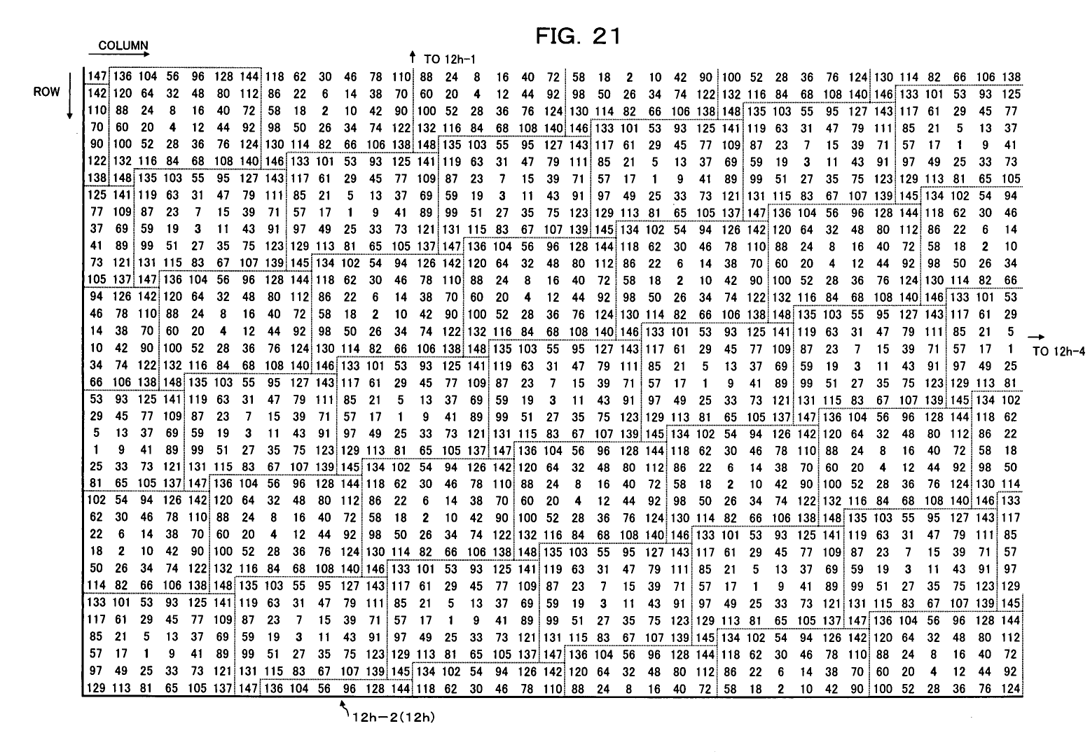

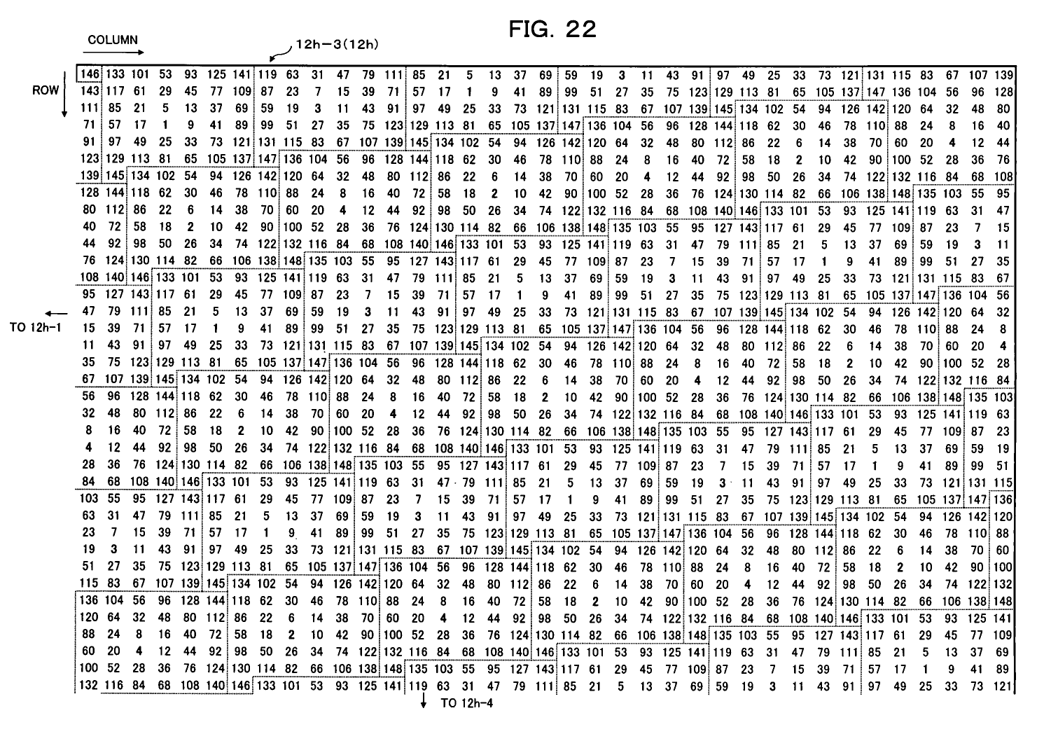

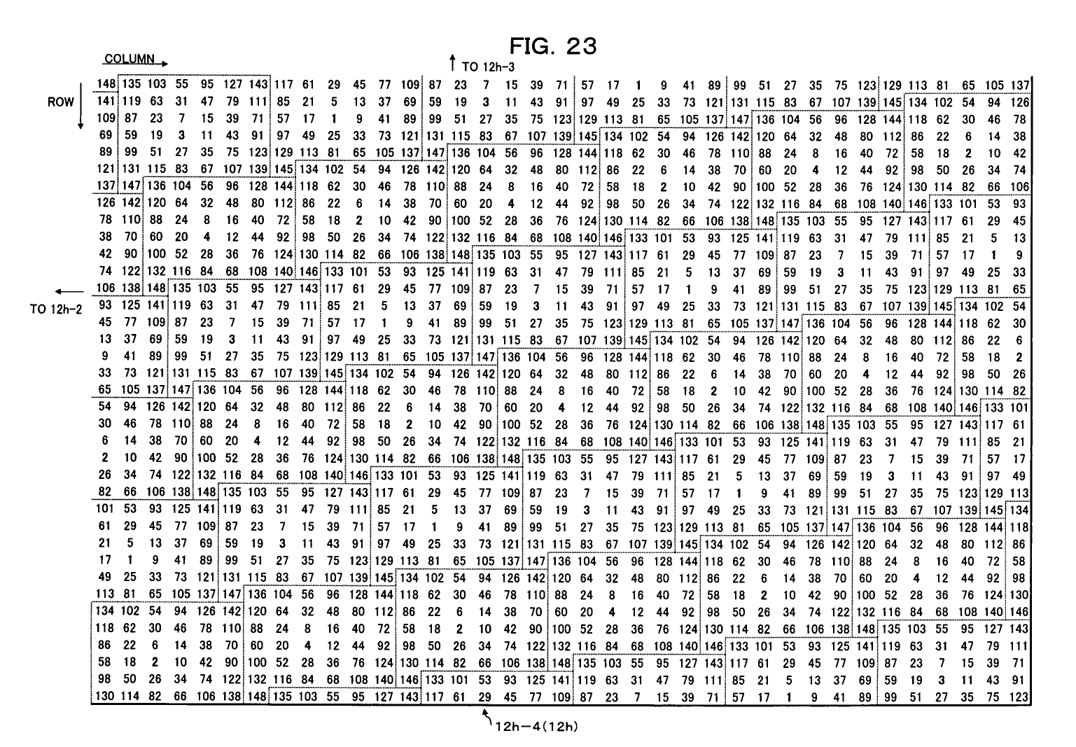

In the drawings, for the convenience of illustration, the binarization pattern 12h is shown divisionally in four figures, that is, FIGS. 20 to 23. In particular, if the binarization pattern 12h-1 shown in FIG. 20, binarization pattern 12h-2 shown in FIG. 21, binarization pattern 12h-3 shown in FIG. 22 and binarization pattern 12h-4 shown in FIG. 23 are combined, then the single binarization pattern 12h is indicated.

The binarization pattern 12h (12h-1, 12h-2, 12h-3, and 12h-4) shown in FIGS. 20 to 23 is formed from five thousand four hundred seventy-six pixels arranged in a matrix of seventy-four rows and seventy-four columns, and is formed as a rectangular pattern wherein a plurality of pixels to be successively turned on are arranged in a matrix. Further, the binarization pattern 12h includes a plurality of sub patterns 1241 formed by arranging two basic patterns 124 shown in FIG. 17 in a vertical direction and a transverse direction (in the present modification, two basic patterns in a vertical direction and two basic patterns in a transverse direction, and hence totaling four basic patterns) such that the lacking portion of each basic pattern 124 is fitted with a portion of another basic pattern 124 at a point-symmetric position with respect to the center of the figure in the basic pattern 124 and a turn-on order appears repetitively and successively in a vertical direction (row arrangement direction) and a transverse direction (column arrangement direction) of the binarization pattern 12f without a clearance left therebetween. It is to be noted that, in FIG. 20, slanting lines are applied to several sub patterns 1241 for the convenience of illustration.

It is to be noted that, as a reference character which indicates a basic pattern, reference characters 124-1 to 124-n (n is a natural number) are used where one basic pattern must be specified from among a plurality of basic patterns, but reference numeral 124 is used when an arbitrary basic pattern is to be pointed to. Further, the number of basic patterns 124 which form a single sub pattern 1241 is represented by m. In particular, in the present modification, a relationship of 1≦n ≦m (n and m are natural numbers) is satisfied.

In the binarization pattern 12h shown in FIGS. 20 to 23, the sub pattern 1241 includes four basic patterns 124, that is, 124-1 to 124-4. Therefore, n is an arbitrary natural number from among 1, 2, 3 and 4, and m is equal to 4.

In particular, the sub pattern 1241 is formed by arranging m (m=4) basic patterns 124 (124-1 to 124-n; where 1≦n≦m) formed such that, in a partly lacking matrix having seven rows and six columns, the pixels of the first to sixth columns which form the first row of the partly lacking matrix are turned on n+33×mth, n+25×mth, n+13×mth, n+23×mth, n+31×mth, and n+35×mth, respectively; the pixels of the first to sixth columns which form the second row of the partly lacking matrix are turned on n+29×mth, n+15×mth, n+7×mth, n+11×mth, n+19×mth, and n+27×mth, respectively; the pixels of the first to sixth columns which form the third row of the partly lacking matrix are turned on n+21×mth, n+5×mth, n+mth, n+3×mth, n+9×mth, and n+17×mth, respectively; the pixels of the first to sixth columns which form the fourth row of the partly lacking matrix are turned on n+14×mth, n+4×mth, nth, n+2×mth, n+10×mth, and n+22×mth, respectively; the pixels of the first to sixth columns which form the fifth row of the partly lacking matrix are turned on n+24×mth, n+12×mth, n+6×mth, n+8×mth, n+18×mth, and n+30×mth, respectively; the pixels of the first to sixth columns which form the sixth row of the partly lacking matrix are turned on n+32×mth, n+28×mth, n+20×mth, n+16×mth, n+26×mth, and n+34×mth, respectively; and the picture element of the first column which forms the seventh row of the partly lacking matrix is turned on n+36×mth.

Further, in the sub pattern 1241 to which slanting lines are applied in FIG. 20, the basic pattern 124-2 is arranged on the lower side of the basic pattern 124-1; the basic pattern 124-3 is arranged on the left side of the basic pattern 124-1; and the basic pattern 124-4 is arranged on the lower side of the basic pattern 124-3. It is to be noted that the arrangement of the basic patterns 124-1 to 124-4 in the sub pattern 1241 is not limited to this, and variations and modifications can be made without departing from the scope of the present invention.

The binarization pattern 12h is formed by arranging a plurality of such sub patterns 1241 in a vertical direction and a transverse direction such that the basic patterns 124-1 and 124-3 of each sub pattern 1241 are fitted with the lacking portions of the basic patterns 124-2 and 124-4 in another sub pattern 1241 adjacent in a vertical direction and a turn-on order appears repetitively and successively in a vertical direction (row arrangement direction) and a transverse direction (column arrangement direction) of the binarization pattern 12f without a clearance left therebetween and then cutting out an arbitrary rectangular portion having seventy-four rows and seventy-four columns from the arranged basic patterns 124.

Further, the binarization pattern 12h includes a plurality of sub patterns 1241, and the turn-on order is set so that dots having shapes same as each other individually grow in order from the plural sub patterns 1241.

In particular, in the binarization pattern 12h, as shown in FIGS. 20 to 23, the turn-on order of the five thousand four hundred seventy-six pixels is set such that:

(1) the pixels of the first to seventy-fourth columns which form the first row of the rectangular pattern are turned on 145th, 134th, 102nd, 54th, 94th, 126th, 142nd, 120th, 64th, 32nd, 48th, 80th, 112th, 86th, 22nd, 6th, 14th, 38th, 70th, 60th, 20th, 4th, 12th, 44th, 92nd, 98th, 50th, 26th, 34th, 74th, 122nd, 132nd, 116th, 84th, 68th, 108th, 140th, 146th, 133rd, 101st, 53rd, 93rd, 125th, 141st, 119th, 63rd, 31st, 47th, 79th, 111th, 85th, 21st, 5th, 13th, 37th, 69th, 59th, 19th, 3rd, 11th, 43rd, 91st, 97th, 49th, 25th, 33rd, 73rd, 121st, 131st, 115th, 83rd, 67th, 107th, and 139th, respectively;

(2) the pixels of the first to seventy-fourth columns which form the second row of the rectangular pattern are turned on 144th, 118th, 62nd, 30th, 46th, 78th, 110th, 88th, 24th, 8th, 16th, 40th, 72nd, 58th, 18th, 2nd, 10th, 42nd, 90th, 100th, 52nd, 28th, 36th, 76th, 124th, 130th, 114th, 82nd, 66th, 106th, 138th, 148th, 135th, 103rd, 55th, 95th, 127th, 143rd, 117th, 61st, 29th, 45th, 77th, 109th, 87th, 23rd, 7th, 15th, 39th, 71st, 57th, 17th, 1st, 9th, 41st, 89th, 99th, 51st, 27th, 35th, 75th, 123rd, 129th, 113th, 81st, 65th, 105th, 137th, 147th, 136th, 104th, 56th, 96th, and 128th, respectively;

(3) the pixels of the first to seventy-fourth columns which form the third row of the rectangular pattern are turned on 112th, 86th, 22nd, 6th, 14th, 38th, 70th, 60th, 20th, 4th, 12th, 44th, 92nd, 98th, 50th, 26th, 34th, 74th, 122nd, 132nd, 116th, 84th, 68th, 108th, 140th, 146th, 133rd, 101st, 53rd, 93rd, 125th, 141st, 119th, 63rd, 31st, 47th, 79th, 111th, 85th, 21st, 5th, 13th, 37th, 69th, 59th, 19th, 3rd, 11th, 43rd, 91st, 97th, 49th, 25th, 33rd, 73rd, 121st, 131st, 115th, 83rd, 67th, 107th, 139th, 145th, 134th, 102nd, 54th, 94th, 126th, 142nd, 120th, 64th, 32nd, 48th, and 80th, respectively;

(4) the pixels of the first to seventy-fourth columns which form the fourth row of the rectangular pattern are turned on 72nd, 58th, 18th, 2nd, 10th, 42nd, 90th, 100th, 52nd, 28th, 36th, 76th, 124th, 130th, 114th, 82nd, 66th, 106th, 138th, 148th, 135th, 103rd, 55th, 95th, 127th, 143rd, 117th, 61st, 29th, 45th, 77th, 109th, 87th, 23rd, 7th, 15th, 39th, 71st, 57th, 17th, 1st, 9th, 41st, 89th, 99th, 51st, 27th, 35th, 75th, 123rd, 129th, 113th, 81st, 65th, 105th, 137th, 147th, 136th, 104th, 56th, 96th, 128th, 144th, 118th, 62nd, 30th, 46th, 78th, 110th, 88th, 24th, 8th, 16th, and 40th, respectively;

(5) the pixels of the first to seventy-fourth columns which form the fifth row of the rectangular pattern are turned on 92nd, 98th, 50th, 26th, 34th, 74th, 122nd, 132nd, 116th, 84th, 68th, 108th, 140th, 146th, 133rd, 101st, 53rd, 93rd, 125th, 141st, 119th, 63rd, 31st, 47th, 79th, 111th, 85th, 21st, 5th, 13th, 37th, 69th, 59th, 19th, 3rd, 11th, 43rd, 91st, 97th, 49th, 25th, 33rd, 73rd, 121st, 131st, 115th, 83rd, 67th, 107th, 139th, 145th, 134th, 102nd, 54th, 94th, 126th, 142nd, 120th, 64th, 32nd, 48th, 80th, 112th, 86th, 22nd, 6th, 14th, 38th, 70th, 60th, 20th, 4th, 12th, and 44th, respectively;

(6) the pixels of the first to seventy-fourth columns which form the sixth row of the rectangular pattern are turned on 124th, 130th, 114th, 82nd, 66th, 106th, 138th, 148th, 135th, 103rd, 55th, 95th, 127th, 143rd, 117th, 61st, 29th, 45th, 77th, 109th, 87th, 23rd, 7th, 15th, 39th, 71st, 57th, 17th, 1st, 9th, 41st, 89th, 99th, 51st, 27th, 35th, 75th, 123rd, 129th, 113th, 81st, 65th, 105th, 137th, 147th, 136th, 104th, 56th, 96th, 128th, 144th, 118th, 62nd, 30th, 46th, 78th, 110th, 88th, 24th, 8th, 16th, 40th, 72nd, 58th, 18th, 2nd, 10th, 42nd, 90th, 100th, 52nd, 28th, 36th, and 76th, respectively;

(7) the pixels of the first to seventy-fourth columns which form the seventh row of the rectangular pattern are turned on 140th, 146th, 133rd, 101st, 53rd, 93rd, 125th, 141st, 119th, 63rd, 31st, 47th, 79th, 111th, 85th, 21st, 5th, 13th, 37th, 69th, 59th, 19th, 3rd, 11th, 43rd, 91st, 97th, 49th, 25th, 33rd, 73rd, 121st, 131st, 115th, 83rd, 67th, 107th, 139th, 145th, 134th, 102nd, 54th, 94th, 126th, 142nd, 120th, 64th, 32nd, 48th, 80th, 112th, 86th, 22nd, 6th, 14th, 38th, 70th, 60th, 20th, 4th, 12th, 44th, 92nd, 98th, 50th, 26th, 34th, 74th, 122nd, 132nd, 116th, 84th, 68th, and 108th, respectively;

(8) the pixels of the first to seventy-fourth columns which form the eighth row of the rectangular pattern are turned on 127th, 143rd, 117th, 61st, 29th, 45th, 77th, 109th, 87th, 23rd, 7th, 15th, 39th, 71st, 57th, 17th, 1st, 9th, 41st, 89th, 99th, 51st, 27th, 35th, 75th, 123rd, 129th, 113th, 81st, 65th, 105th, 137th, 147th, 136th, 104th, 56th, 96th, 128th, 144th, 118th, 62nd, 30th, 46th, 78th, 110th, 88th, 24th, 8th, 16th, 40th, 72nd, 58th, 18th, 2nd, 10th, 42nd, 90th, 100th, 52nd, 28th, 36th, 76th, 124th, 130th, 114th, 82nd, 66th, 106th, 138th, 148th, 135th, 103rd, 55th, and 95th, respectively;

(9) the pixels of the first to seventy-fourth columns which form the ninth row of the rectangular pattern are turned on 79th, 111th, 85th, 21st, 5th, 13th, 37th, 69th, 59th, 19th, 3rd, 11th, 43rd, 91st, 97th, 49th, 25th, 33rd, 73rd, 121st, 131st, 115th, 83rd, 67th, 107th, 139th, 145th, 134th, 102nd, 54th, 94th, 126th, 142nd, 120th, 64th, 32nd, 48th, 80th, 112th, 86th, 22nd, 6th, 14th, 38th, 70th, 60th, 20th, 4th, 12th, 44th, 92nd, 98th, 50th, 26th, 34th, 74th, 122nd, 132nd, 116th, 84th, 68th, 108th, 140th, 146th, 133rd, 101st, 53rd, 93rd, 125th, 141st, 119th, 63rd, 31st, and 47th, respectively;

(10) the pixels of the first to seventy-fourth columns which form the tenth row of the rectangular pattern are turned on 39th, 71st, 57th, 17th, 1st, 9th, 41st, 89th, 99th, 51st, 27th, 35th, 75th, 123rd, 129th, 113th, 81st, 65th, 105th, 137th, 147th, 136th, 104th, 56th, 96th, 128th, 144th, 118th, 62nd, 30th, 46th, 78th, 110th, 88th, 24th, 8th, 16th, 40th, 72nd, 58th, 18th, 2nd, 10th, 42nd, 90th, 100th, 52nd, 28th, 36th, 76th, 124th, 130th, 114th, 82nd, 66th, 106th, 138th, 148th, 135th, 103rd, 55th, 95th, 127th, 143rd, 117th, 61st, 29th, 45th, 77th, 109th, 87th, 23rd, 7th, and 15th, respectively;

(11) the pixels of the first to seventy-fourth columns which form the eleventh row of the rectangular pattern are turned on 43rd, 91st, 97th, 49th, 25th, 33rd, 73rd, 121st, 131st, 115th, 83rd, 67th, 107th, 139th, 145th, 134th, 102nd, 54th, 94th, 126th, 142nd, 120th, 64th, 32nd, 48th, 80th, 112th, 86th, 22nd, 6th, 14th, 38th, 70th, 60th, 20th, 4th, 12th, 44th, 92nd, 98th, 50th, 26th, 34th, 74th, 122nd, 132nd, 116th, 84th, 68th, 108th, 140th, 146th, 133rd, 101st, 53rd, 93rd, 125th, 141st, 119th, 63rd, 31st, 47th, 79th, 111th, 85th, 21st, 5th, 13th, 37th, 69th, 59th, 19th, 3rd, and 11th, respectively;

(12) the pixels of the first to seventy-fourth columns which form the twelfth row of the rectangular pattern are turned on 75th, 123rd, 129th, 113th, 81st, 65th, 105th, 137th, 147th, 136th, 104th, 56th, 96th,128th, 144th, 118th, 62nd, 30th, 46th, 78th, 110th, 88th, 24th, 8th, 16th, 40th, 72nd, 58th, 18th, 2nd, 10th, 42nd, 90th, 100th, 52nd, 28th, 36th, 76th, 124th, 130th, 114th, 82nd, 66th, 106th, 138th, 148th, 135th, 103rd, 55th, 95th, 127th, 143rd, 117th, 61st, 29th, 45th, 77th, 109th, 87th, 23rd, 7th, 15th, 39th, 71st, 57th, 17th, 1st, 9th, 41st, 89th, 99th, 51st, 27th, and 35th, respectively;

(13) the pixels of the first to seventy-fourth columns which form the thirteenth row of the rectangular pattern are turned on 107th, 139th, 145th, 134th, 102nd, 54th, 94th, 126th, 142nd, 120th, 64th, 32nd, 48th, 80th, 112th, 86th, 22nd, 6th, 14th, 38th, 70th, 60th, 20th, 4th, 12th, 44th, 92nd, 98th, 50th, 26th, 34th, 74th, 122nd, 132nd, 116th, 84th, 68th, 108th, 140th, 146th, 133rd, 101st, 53rd, 93rd, 125th, 141st, 119th, 63rd, 31st, 47th, 79th, 111th, 85th, 21st, 5th, 13th, 37th, 69th, 59th, 19th, 3rd, 11th, 43rd, 91st, 97th, 49th, 25th, 33rd, 73rd, 121st, 131st, 115th, 83rd, and 67th, respectively;

(14) the pixels of the first to seventy-fourth columns which form the fourteenth row of the rectangular pattern are turned on 96th, 128th, 144th, 118th, 62nd, 30th, 46th, 78th, 110th, 88th, 24th, 8th, 16th, 40th, 72nd, 58th, 18th, 2nd, 10th, 42nd, 90th, 100th, 52nd, 28th, 36th, 76th, 124th, 130th, 114th, 82nd, 66th, 106th, 138th, 148th, 135th, 103rd, 55th, 95th, 127th, 143rd, 117th, 61st, 29th, 45th, 77th, 109th, 87th, 23rd, 7th, 15th, 39th, 71st, 57th, 17th, 1st, 9th, 41st, 89th, 99th, 51st, 27th, 35th, 75th, 123rd, 129th, 113th, 81st, 65th, 105th, 137th, 147th, 136th, 104th, and 56th, respectively;

(15) the pixels of the first to seventy-fourth columns which form the fifteenth row of the rectangular pattern are turned on 48th, 80th, 112th, 86th, 22nd, 6th, 14th, 38th, 70th, 60th, 20th, 4th, 12th, 44th, 92nd, 98th, 50th, 26th, 34th, 74th, 122nd, 132nd, 116th, 84th, 68th, 108th, 140th, 146th, 133rd, 101st, 53rd, 93rd, 125th, 141st, 119th, 63rd, 31st, 47th, 79th, 111th, 85th, 21st, 5th, 13th, 37th, 69th, 59th, 19th, 3rd, 11th, 43rd, 91st, 97th, 49th, 25th, 33rd, 73rd, 121st, 131st, 115th, 83rd, 67th, 107th, 139th, 145th, 134th, 102nd, 54th, 94th, 126th, 142nd, 120th, 64th, and 32nd, respectively;

(16) the pixels of the first to seventy-fourth columns which form the sixteenth row of the rectangular pattern are turned on 16th, 40th, 72nd, 58th, 18th, 2nd, 10th, 42nd, 90th, 100th, 52nd, 28th, 36th, 76th, 124th, 130th, 114th, 82nd, 66th, 106th, 138th, 148th, 135th, 103rd, 55th, 95th, 127th, 143rd, 117th, 61st, 29th, 45th, 77th, 109th, 87th, 23rd, 7th, 15th, 39th, 71st, 57th, 17th, 1st, 9th, 41st, 89th, 99th, 51st, 27th, 35th, 75th, 123rd, 129th, 113th, 81st, 65th, 105th, 137th, 147th, 136th, 104th, 56th, 96th, 128th, 144th, 118th, 62nd, 30th, 46th, 78th, 110th, 88th, 24th, and 8th, respectively;

(17) the pixels of the first to seventy-fourth columns which form the seventeenth row of the rectangular pattern are turned on 12th, 44th, 92nd, 98th, 50th, 26th, 34th, 74th, 122nd, 132nd, 116th, 84th, 68th, 108th, 140th, 146th, 133rd, 101st, 53rd, 93rd, 125th, 141st, 119th, 63rd, 31st, 47th, 79th, 111th, 85th, 21st, 5th, 13th, 37th, 69th, 59th, 19th, 3rd, 11th, 43rd, 91st, 97th, 49th, 25th, 33rd, 73rd, 121st, 131st, 115th, 83rd, 67th, 107th, 139th, 145th, 134th, 102nd, 54th, 94th, 126th, 142nd, 120th, 64th, 32nd, 48th, 80th, 112th, 86th, 22nd, 6th, 14th, 38th, 70th, 60th, 20th, and 4th, respectively;

(18) the pixels of the first to seventy-fourth columns which form the eighteenth row of the rectangular pattern are turned on 36th, 76th, 124th, 130th, 114th, 82nd, 66th, 106th, 138th, 148th, 135th, 103rd, 55th, 95th, 127th, 143rd, 117th, 61st, 29th, 45th, 77th, 109th, 87th, 23rd, 7th, 15th, 39th, 71st, 57th, 17th, 1st, 9th, 41st, 89th, 99th, 51st, 27th, 35th, 75th, 123rd, 129th, 113th, 81st, 65th, 105th, 137th, 147th, 136th, 104th, 56th, 96th, 128th, 144th, 118th, 62nd, 30th, 46th, 78th, 110th, 88th, 24th, 8th, 16th, 40th, 72nd, 58th, 18th, 2nd, 10th, 42nd, 90th, 100th, 52nd, and 28th, respectively;

(19) the pixels of the first to seventy-fourth columns which form the nineteenth row of the rectangular pattern are turned on 68th, 108th, 140th, 146th, 133rd, 101st, 53rd, 93rd, 125th, 141st, 119th, 63rd, 31st, 47th, 79th, 111th, 85th, 21st, 5th, 13th, 37th, 69th, 59th, 19th, 3rd, 11th, 43rd, 91st, 97th, 49th, 25th, 33rd, 73rd, 121st, 131st, 115th, 83rd, 67th, 107th, 139th, 145th, 134th, 102nd, 54th, 94th, 126th, 142nd, 120th, 64th, 32nd, 48th, 80th, 112th, 86th, 22nd, 6th, 14th, 38th, 70th, 60th, 20th, 4th, 12th, 44th, 92nd, 98th, 50th, 26th, 34th, 74th, 122nd, 132nd, 116th, and 84th, respectively;

(20) the pixels of the first to seventy-fourth columns which form the twentieth row of the rectangular pattern are turned on 55th, 95th, 127th, 143rd, 117th, 61st, 29th, 45th, 77th, 109th, 87th, 23rd, 7th, 15th, 39th, 71st, 57th, 17th, 1st, 9th, 41st, 89th, 99th, 51st, 27th, 35th, 75th, 123rd, 129th, 113th, 81st, 65th, 105th, 137th, 147th, 136th, 104th, 56th, 96th, 128th, 144th, 118th, 62nd, 30th, 46th, 78th, 110th, 88th, 24th, 8th, 16th, 40th, 72nd, 58th, 18th, 2nd, 10th, 42nd, 90th, 100th, 52nd, 28th, 36th, 76th, 124th, 130th, 114th, 82nd, 66th, 106th, 138th, 148th, 135th, and 103rd, respectively;

(21) the pixels of the first to seventy-fourth columns which form the twenty-first row of the rectangular pattern are turned on 31st, 47th, 79th, 111th, 85th, 21st, 5th, 13th, 37th, 69th, 59th, 19th, 3rd, 11th, 43rd, 91st, 97th, 49th, 25th, 33rd, 73rd, 121st, 131st, 115th, 83rd, 67th, 107th, 139th, 145th, 134th, 102nd, 54th, 94th, 126th, 142nd, 120th, 64th, 32nd, 48th, 80th, 112th, 86th, 22nd, 6th, 14th, 38th, 70th, 60th, 20th, 4th, 12th, 44th, 92nd, 98th, 50th, 26th, 34th, 74th, 122nd, 132nd, 116th, 84th, 68th, 108th, 140th, 146th, 133rd, 101st, 53rd, 93rd, 125th, 141st, 119th, and 63rd, respectively;

(22) the pixels of the first to seventy-fourth columns which form the twenty-second row of the rectangular pattern are turned on 7th, 15th, 39th, 71st, 57th, 17th, 1st, 9th, 41st, 89th, 99th, 51st, 27th, 35th, 75th, 123rd, 129th, 113th, 81st, 65th, 105th, 137th, 147th, 136th, 104th, 56th, 96th, 128th, 144th, 118th, 62nd, 30th, 46th, 78th, 110th, 88th, 24th, 8th, 16th, 40th, 72nd, 58th, 18th, 2nd, 10th, 42nd, 90th, 100th, 52nd, 28th, 36th, 76th, 124th, 130th, 114th, 82nd, 66th, 106th, 138th, 148th, 135th, 103rd, 55th, 95th, 127th, 143rd, 117th, 61st, 29th, 45th, 77th, 109th, 87th, and 23rd, respectively;

(23) the pixels of the first to seventy-fourth columns which form the twenty-third row of the rectangular pattern are turned on 3rd, 11th, 43rd, 91st, 97th, 49th, 25th, 33rd, 73rd, 121st, 131st, 115th, 83rd, 67th, 107th, 139th, 145th, 134th, 102nd, 54th, 94th, 126th, 142nd, 120th, 64th, 32nd, 48th, 80th, 112th, 86th, 22nd, 6th, 14th, 38th, 70th, 60th, 20th, 4th, 12th, 44th, 92nd, 98th, 50th, 26th, 34th, 74th, 122nd, 132nd, 116th, 84th, 68th, 108th, 140th, 146th, 133rd, 101st, 53rd, 93rd, 125th, 141st, 119th, 63rd, 31st, 47th, 79th, 111th, 85th, 21st, 5th, 13th, 37th, 69th, 59th, and 19th, respectively;

(24) the pixels of the first to seventy-fourth columns which form the twenty-fourth row of the rectangular pattern are turned on 27th, 35th, 75th, 123rd, 129th, 113th, 81st, 65th, 105th, 137th, 147th, 136th, 104th, 56th, 96th, 128th, 144th, 118th, 62nd, 30th, 46th, 78th, 110th, 88th, 24th, 8th, 16th, 40th, 72nd, 58th, 18th, 2nd, 10th, 42nd, 90th, 100th, 52nd, 28th, 36th, 76th, 124th, 130th, 114th, 82nd, 66th, 106th, 138th, 148th, 135th, 103rd, 55th, 95th, 127th, 143rd, 117th, 61st, 29th, 45th, 77th, 109th, 87th, 23rd, 7th, 15th, 39th, 71st, 57th, 17th, 1st, 9th, 41st, 89th, 99th, and 51st, respectively;

(25) the pixels of the first to seventy-fourth columns which form the twenty-fifth row of the rectangular pattern are turned on 83rd, 67th, 107th, 139th, 145th, 134th, 102nd, 54th, 94th, 126th, 142nd, 120th, 64th, 32nd, 48th, 80th, 112th, 86th, 22nd, 6th, 14th, 38th, 70th, 60th, 20th, 4th, 12th, 44th, 92nd, 98th, 50th, 26th, 34th, 74th, 122nd, 132nd, 116th, 84th, 68th, 108th, 140th, 146th, 133rd, 101st, 53rd, 93rd, 125th, 141st, 119th, 63rd, 31st, 47th, 79th, 111th, 85th, 21st, 5th, 13th, 37th, 69th, 59th, 19th, 3rd, 11th, 43rd, 91st, 97th, 49th, 25th, 33rd, 73rd, 121st, 131st, and 115th, respectively;

(26) the pixels of the first to seventy-fourth columns which form the twenty-sixth row of the rectangular pattern are turned on 104th, 56th, 96th, 128th, 144th, 118th, 62nd, 30th, 46th, 78th, 110th, 88th, 24th, 8th, 16th, 40th, 72nd, 58th, 18th, 2nd, 10th, 42nd, 90th, 100th, 52nd, 28th, 36th, 76th, 124th, 130th, 114th, 82nd, 66th, 106th, 138th, 148th, 135th, 103rd, 55th, 95th, 127th, 143rd, 117th, 61st, 29th, 45th, 77th, 109th, 87th, 23rd, 7th, 15th, 39th, 71st, 57th, 17th, 1st, 9th, 41st, 89th, 99th, 51st, 27th, 35th, 75th, 123rd, 129th, 113th, 81st, 65th, 105th, 137th, 147th, and 136th, respectively;

(27) the pixels of the first to seventy-fourth columns which form the twenty-seventh row of the rectangular pattern are turned on 64th, 32nd, 48th, 80th, 112th, 86th, 22nd, 6th, 14th, 38th, 70th, 60th, 20th, 4th, 12th, 44th, 92nd, 98th, 50th, 26th, 34th, 74th, 122nd, 132nd, 116th, 84th, 68th, 108th, 140th, 146th, 133rd, 101st, 53rd, 93rd, 125th, 141st, 119th, 63rd, 31st, 47th, 79th, 111th, 85th, 21st, 5th, 13th, 37th, 69th, 59th, 19th, 3rd, 11th, 43rd, 91st, 97th, 49th, 25th, 33rd, 73rd, 121st, 131st, 115th, 83rd, 67th, 107th, 139th, 145th, 134th, 102nd, 54th, 94th, 126th, 142nd, and 120th, respectively;

(28) the pixels of the first to seventy-fourth columns which form the twenty-eighth row of the rectangular pattern are turned on 24th, 8th, 16th, 40th, 72nd, 58th, 18th, 2nd, 10th, 42nd, 90th, 100th, 52nd, 28th, 36th, 76th, 124th, 130th, 114th, 82nd, 66th, 106th, 138th, 148th, 135th, 103rd, 55th, 95th, 127th, 143rd, 117th, 61st, 29th, 45th, 77th, 109th, 87th, 23rd, 7th, 15th, 39th, 71st, 57th, 17th, 1st, 9th, 41st, 89th, 99th, 51st, 27th, 35th, 75th, 123rd, 129th, 113th, 81st, 65th, 105th, 137th, 147th, 136th, 104th, 56th, 96th, 128th, 144th, 118th, 62nd, 30th, 46th, 78th, 110th, and 88th, respectively;

(29) the pixels of the first to seventy-fourth columns which form the twenty-ninth row of the rectangular pattern are turned on 20th, 4th, 12th, 44th, 92nd, 98th, 50th, 26th, 34th, 74th, 122nd, 132nd, 116th, 84th, 68th, 108th, 140th, 146th, 133rd, 101st, 53rd, 93rd, 125th, 141st, 119th, 63rd, 31st, 47th, 79th, 111th, 85th, 21st, 5th, 13th, 37th, 69th, 59th, 19th, 3rd, 11th, 43rd, 91st, 97th, 49th, 25th, 33rd, 73rd, 121st, 131st, 115th, 83rd, 67th, 107th, 139th, 145th, 134th, 102nd, 54th, 94th, 126th, 142nd, 120th, 64th, 32nd, 48th, 80th, 112th, 86th, 22nd, 6th, 14th, 38th, 70th, and 60th, respectively;

(30) the pixels of the first to seventy-fourth columns which form the thirtieth row of the rectangular pattern are turned on 52nd, 28th, 36th, 76th, 124th, 130th, 114th, 82nd, 66th, 106th, 138th, 148th, 135th, 103rd, 55th, 95th, 127th, 143rd, 117th, 61st, 29th, 45th, 77th, 109th, 87th, 23rd, 7th, 15th, 39th, 71st, 57th, 17th, 1st, 9th, 41st, 89th, 99th, 51st, 27th, 35th, 75th, 123rd, 129th, 113th, 81st, 65th, 105th, 137th, 147th, 136th, 104th, 56th, 96th, 128th, 144th, 118th, 62nd, 30th, 46th, 78th, 110th, 88th, 24th, 8th, 16th, 40th, 72nd, 58th, 18th, 2nd, 10th, 42nd, 90th, and 100th, respectively;

(31) the pixels of the first to seventy-fourth columns which form the thirty-first row of the rectangular pattern are turned on 116th, 84th, 68th, 108th, 140th, 146th, 133rd, 101st, 53rd, 93rd, 125th, 141st, 119th, 63rd, 31st, 47th, 79th, 111th, 85th, 21st, 5th, 13th, 37th, 69th, 59th, 19th, 3rd, 11th, 43rd, 91st, 97th, 49th, 25th, 33rd, 73rd, 121st, 131st, 115th, 83rd, 67th, 107th, 139th, 145th, 134th, 102nd, 54th, 94th, 126th, 142nd, 120th, 64th, 32nd, 48th, 80th, 112th, 86th, 22nd, 6th, 14th, 38th, 70th, 60th, 20th, 4th, 12th, 44th, 92nd, 98th, 50th, 26th, 34th, 74th, 122nd, and 132nd, respectively;

(32) the pixels of the first to seventy-fourth columns which form the thirty-second row of the rectangular pattern are turned on 135th, 103rd, 55th, 95th, 127th, 143rd, 117th, 61st, 29th, 45th, 77th, 109th, 87th, 23rd, 7th, 15th, 39th, 71st, 57th, 17th, 1st, 9th, 41st, 89th, 99th, 51st, 27th, 35th, 75th, 123rd, 129th, 113th, 81st, 65th, 105th, 137th, 147th, 136th, 104th, 56th, 96th, 128th, 144th, 118th, 62nd, 30th, 46th, 78th, 110th, 88th, 24th, 8th, 16th, 40th, 72nd, 58th, 18th, 2nd, 10th, 42nd, 90th, 100th, 52nd, 28th, 36th, 76th, 124th, 130th, 114th, 82nd, 66th, 106th, 138th, and 148th, respectively;

(33) the pixels of the first to seventy-fourth columns which form the thirty-third of the rectangular pattern are turned on 119th, 63rd, 31st, 47th, 79th, 111th, 85th, 21st, 5th, 13th, 37th, 69th, 59th, 19th, 3rd, 11th, 43rd, 91st, 97th, 49th, 25th, 33rd, 73rd, 121st, 131st, 115th, 83rd, 67th, 107th, 139th, 145th, 134th, 102nd, 54th, 94th, 126th, 142nd, 120th, 64th, 32nd, 48th, 80th, 112th, 86th, 22nd, 6th, 14th, 38th, 70th, 60th, 20th, 4th, 12th, 44th, 92nd, 98th, 50th, 26th, 34th, 74th, 122nd, 132nd, 116th, 84th, 68th, 108th, 140th, 146th, 133rd, 101st, 53rd, 93rd, 125th, and 141st, respectively;

(34) the pixels of the first to seventy-fourth columns which form the thirty-fourth row of the rectangular pattern are turned on 87th, 23rd, 7th, 15th, 39th, 71st, 57th, 17th, 1st, 9th, 41st, 89th, 99th, 51st, 27th, 35th, 75th, 123rd, 129th, 113th, 81st, 65th, 105th, 137th, 147th, 136th, 104th, 56th, 96th, 128th, 144th, 118th, 62nd, 30th, 46th, 78th, 110th, 88th, 24th, 8th, 16th, 40th, 72nd, 58th, 18th, 2nd, 10th, 42nd, 90th, 100th, 52nd, 28th, 36th, 76th, 124th, 130th, 114th, 82nd, 66th, 106th, 138th, 148th, 135th, 103rd, 55th, 95th, 127th, 143rd, 117th, 61st, 29th, 45th, 77th, and 109th, respectively;

(35) the pixels of the first to seventy-fourth columns which form the thirty-fifth of the rectangular pattern are turned on 59th, 19th, 3rd, 11th, 43rd, 91st, 97th, 49th, 25th, 33rd, 73rd, 121st, 131st, 115th, 83rd, 67th, 107th, 139th, 145th, 134th, 102nd, 54th, 94th, 126th, 142nd, 120th, 64th, 32nd, 48th, 80th, 112th, 86th, 22nd, 6th, 14th, 38th, 70th, 60th, 20th, 4th, 12th, 44th, 92nd, 98th, 50th, 26th, 34th, 74th, 122nd, 132nd, 116th, 84th, 68th, 108th, 140th, 146th, 133rd, 101st, 53rd, 93rd, 125th, 141st, 119th, 63rd, 31st, 47th, 79th, 111th, 85th, 21st, 5th, 13th, 37th, and 69th, respectively;

(36) the pixels of the first to seventy-fourth columns which form the thirty-sixth row of the rectangular pattern are turned on 99th, 51st, 27th, 35th, 75th, 123rd, 129th, 113th, 81st, 65th, 105th, 137th, 147th, 136th, 104th, 56th, 96th, 128th, 144th, 118th, 62nd, 30th, 46th, 78th, 110th, 88th, 24th, 8th, 16th, 40th, 72nd, 58th, 18th, 2nd, 10th, 42nd, 90th, 100th, 52nd, 28th, 36th, 76th, 124th, 130th, 114th, 82nd, 66th, 106th, 138th, 148th, 135th, 103rd, 55th, 95th, 127th, 143rd, 117th, 61st, 29th, 45th, 77th, 109th, 87th, 23rd, 7th, 15th, 39th, 71st, 57th, 17th, 1st, 9th, 41st, and 89th, respectively;

(37) the pixels of the first to seventy-fourth columns which form the thirty-seventh of the rectangular pattern are turned on 131st, 115th, 83rd, 67th, 107th, 139th, 145th, 134th, 102nd, 54th, 94th, 126th, 142nd, 120th, 64th, 32nd, 48th, 80th, 112th, 86th, 22nd, 6th, 14th, 38th, 70th, 60th, 20th, 4th, 12th, 44th, 92nd, 98th, 50th, 26th, 34th, 74th, 122nd, 132nd, 116th, 84th, 68th, 108th, 140th, 146th, 133rd, 101st, 53rd, 93rd, 125th, 141st, 119th, 63rd, 31st, 47th, 79th, 111th, 85th, 21st, 5th, 13th, 37th, 69th, 59th, 19th, 3rd, 11th, 43rd, 91st, 97th, 49th, 25th, 33rd, 73rd, and 121st, respectively;

(38) the pixels of the first to seventy-fourth columns which form the thirty-eighth row of the rectangular pattern are turned on 147th, 136th, 104th, 56th, 96th, 128th, 144th, 118th, 62nd, 30th, 46th, 78th, 110th, 88th, 24th, 8th, 16th, 40th, 72nd, 58th, 18th, 2nd, 10th, 42nd, 90th, 100th, 52nd, 28th, 36th, 76th, 124th, 130th, 114th, 82nd, 66th, 106th, 138th, 148th, 135th, 103rd, 55th, 95th, 127th, 143rd, 117th, 61st, 29th, 45th, 77th, 109th, 87th, 23rd, 7th, 15th, 39th, 71st, 57th, 17th, 1st, 9th, 41st, 89th, 99th, 51st, 27th, 35th, 75th, 123rd, 129th, 113th, 81st, 65th, 105th, and 137th, respectively;

(39) the pixels of the first to seventy-fourth columns which form the thirty-ninth of the rectangular pattern are turned on 142nd, 120th, 64th, 32nd, 48th, 80th, 112th, 86th, 22nd, 6th, 14th, 38th, 70th, 60th, 20th, 4th, 12th, 44th, 92nd, 98th, 50th, 26th, 34th, 74th, 122nd, 132nd, 116th, 84th, 68th, 108th, 140th, 146th, 133rd, 101st, 53rd, 93rd, 125th, 141st, 119th, 63rd, 31st, 47th, 79th, 111th, 85th, 21st, 5th, 13th, 37th, 69th, 59th, 19th, 3rd, 11th, 43rd, 91st, 97th, 49th, 25th, 33rd, 73rd, 121st, 131st, 115th, 83rd, 67th, 107th, 139th, 145th, 134th, 102nd, 54th, 94th, and 126th, respectively;

(40) the pixels of the first to seventy-fourth columns which form the fortieth row of the rectangular pattern are turned on 110th, 88th, 24th, 8th, 16th, 40th, 72nd, 58th, 18th, 2nd, 10th, 42nd, 90th, 100th, 52nd, 28th, 36th, 76th, 124th, 130th, 114th, 82nd, 66th, 106th, 138th, 148th, 135th, 103rd, 55th, 95th, 127th, 143rd, 117th, 61st, 29th, 45th, 77th, 109th, 87th, 23rd, 7th, 15th, 39th, 71st, 57th, 17th, 1st, 9th, 41st, 89th, 99th, 51st, 27th, 35th, 75th, 123rd, 129th, 113th, 81st, 65th, 105th, 137th, 147th, 136th, 104th, 56th, 96th, 128th, 144th, 118th, 62nd, 30th, 46th, and 78th, respectively;

(41) the pixels of the first to seventy-fourth columns which form the forty-first of the rectangular pattern are turned on 70th, 60th, 20th, 4th, 12th, 44th, 92nd, 98th, 50th, 26th, 34th, 74th, 122nd, 132nd, 116th, 84th, 68th, 108th, 140th, 146th, 133rd, 101st, 53rd, 93rd, 125th, 141st, 119th, 63rd, 31st, 47th, 79th, 111th, 85th, 21st, 5th, 13th, 37th, 69th, 59th, 19th, 3rd, 11th, 43rd, 91st, 97th, 49th, 25th, 33rd, 73rd, 121st, 131st, 115th, 83rd, 67th, 107th, 139th, 145th, 134th, 102nd, 54th, 94th, 126th, 142nd, 120th, 64th, 32nd, 48th, 80th, 112th, 86th, 22nd, 6th, 14th, and 38th, respectively;

(42) the pixels of the first to seventy-fourth columns which form the forty-second row of the rectangular pattern are turned on 90th, 100th, 52nd, 28th, 36th, 76th, 124th, 130th, 114th, 82nd, 66th, 106th, 138th, 148th, 135th, 103rd, 55th, 95th, 127th, 143rd, 117th, 61st, 29th, 45th, 77th, 109th, 87th, 23rd, 7th, 15th, 39th, 71st, 57th, 17th, 1st, 9th, 41st, 89th, 99th, 51st, 27th, 35th, 75th, 123rd, 129th, 113th, 81st, 65th, 105th, 137th, 147th, 136th, 104th, 56th, 96th, 128th, 144th, 118th, 62nd, 30th, 46th, 78th, 110th, 88th, 24th, 8th, 16th, 40th, 72nd, 58th, 18th, 2nd, 10th, and 42nd, respectively;

(43) the pixels of the first to seventy-fourth columns which form the forty-third of the rectangular pattern are turned on 122nd, 132nd, 116th, 84th, 68th, 108th, 140th, 146th, 133rd, 101st, 53rd, 93rd, 125th, 141st, 119th, 63rd, 31st, 47th, 79th, 111th, 85th, 21st, 5th, 13th, 37th, 69th, 59th, 19th, 3rd, 11th, 43rd, 91st, 97th, 49th, 25th, 33rd, 73rd, 121st, 131st, 115th, 83rd, 67th, 107th, 139th, 145th, 134th, 102nd, 54th, 94th, 126th, 142nd, 120th, 64th, 32nd, 48th, 80th, 112th, 86th, 22nd, 6th, 14th, 38th, 70th, 60th, 20th, 4th, 12th, 44th, 92nd, 98th, 50th, 26th, 34th, and 74th, respectively;

(44) the pixels of the first to seventy-fourth columns which form the forty-fourth row of the rectangular pattern are turned on 138th, 148th, 135th, 103rd, 55th, 95th, 127th, 143rd, 117th, 61st, 29th, 45th, 77th, 109th, 87th, 23rd, 7th, 15th, 39th, 71st, 57th, 17th, 1st, 9th, 41st, 89th, 99th, 51st, 27th, 35th, 75th, 123rd, 129th, 113th, 81st, 65th, 105th, 137th, 147th, 136th, 104th, 56th, 96th, 128th, 144th, 118th, 62nd, 30th, 46th, 78th, 110th, 88th, 24th, 8th, 16th, 40th, 72nd, 58th, 18th, 2nd, 10th, 42nd, 90th, 100th, 52nd, 28th, 36th, 76th, 124th, 130th, 114th, 82nd, 66th, and 106th, respectively;

(45) the pixels of the first to seventy-fourth columns which form the forty-fifth of the rectangular pattern are turned on 125th, 141st, 119th, 63rd, 31st, 47th, 79th, 111th, 85th, 21st, 5th, 13th, 37th, 69th, 59th, 19th, 3rd, 11th, 43rd, 91st, 97th, 49th, 25th, 33rd, 73rd, 121st, 131st, 115th, 83rd, 67th, 107th, 139th, 145th, 134th, 102nd, 54th, 94th, 126th, 142nd, 120th, 64th, 32nd, 48th, 80th, 112th, 86th, 22nd, 6th, 14th, 38th, 70th, 60th, 20th, 4th, 12th, 44th, 92nd, 98th, 50th, 26th, 34th, 74th, 122nd, 132nd, 116th, 84th, 68th, 108th, 140th, 146th, 133rd, 101st, 53rd, and 93rd, respectively;

(46) the pixels of the first to seventy-fourth columns which form the forty-sixth row of the rectangular pattern are turned on 77th, 109th, 87th, 23rd, 7th, 15th, 39th, 71st, 57th, 17th, 1st, 9th, 41st, 89th, 99th, 51st, 27th, 35th, 75th, 123rd, 129th, 113th, 81st, 65th, 105th, 137th, 147th, 136th, 104th, 56th, 96th, 128th, 144th, 118th, 62nd, 30th, 46th, 78th, 110th, 88th, 24th, 8th, 16th, 40th, 72nd, 58th, 18th, 2nd, 10th, 42nd, 90th, 100th, 52nd, 28th, 36th, 76th, 124th, 130th, 114th, 82nd, 66th, 106th, 138th, 148th, 135th, 103rd, 55th, 95th, 127th, 143rd, 117th, 61st, 29th, and 45th, respectively;

(47) the pixels of the first to seventy-fourth columns which form the forty-seventh of the rectangular pattern are turned on 37th, 69th, 59th, 19th, 3rd, 11th, 43rd, 91st, 97th, 49th, 25th, 33rd, 73rd, 121st, 131st, 115th, 83rd, 67th, 107th, 139th, 145th, 134th, 102nd, 54th, 94th, 126th, 142nd, 120th, 64th, 32nd, 48th, 80th, 112th, 86th, 22nd, 6th, 14th, 38th, 70th, 60th, 20th, 4th, 12th, 44th, 92nd, 98th, 50th, 26th, 34th, 74th, 122nd, 132nd, 116th, 84th, 68th, 108th, 140th, 146th, 133rd, 101st, 53rd, 93rd, 125th, 141st, 119th, 63rd, 31st, 47th, 79th, 111th, 85th, 21st, 5th, and 13th, respectively;

(48) the pixels of the first to seventy-fourth columns which form the forty-eighth row of the rectangular pattern are turned on 41st, 89th, 99th, 51st, 27th, 35th, 75th, 123rd, 129th, 113th, 81st, 65th, 105th, 137th, 147th, 136th, 104th, 56th, 96th, 128th, 144th, 118th, 62nd, 30th, 46th, 78th, 110th, 88th, 24th, 8th, 16th, 40th, 72nd, 58th, 18th, 2nd, 10th, 42nd, 90th, 100th, 52nd, 28th, 36th, 76th, 124th, 130th, 114th, 82nd, 66th, 106th, 138th, 148th, 135th, 103rd, 55th, 95th, 127th, 143rd, 117th, 61st, 29th, 45th, 77th, 109th, 87th, 23rd, 7th, 15th, 39th, 71st, 57th, 17th, 1st, and 9th, respectively;

(49) the pixels of the first to seventy-fourth columns which form the forty-ninth of the rectangular pattern are turned on 73rd, 121st, 131st, 115th, 83rd, 67th, 107th, 139th, 145th, 134th, 102nd, 54th, 94th, 126th, 142nd, 120th, 64th, 32nd, 48th, 80th, 112th, 86th, 22nd, 6th, 14th, 38th, 70th, 60th, 20th, 4th, 12th, 44th, 92nd, 98th, 50th, 26th, 34th, 74th, 122nd, 132nd, 116th, 84th, 68th, 108th, 140th, 146th, 133rd, 101st, 53rd, 93rd, 125th, 141st, 119th, 63rd, 31st, 47th, 79th, 111th, 85th, 21st, 5th, 13th, 37th, 69th, 59th, 19th, 3rd, 11th, 43rd, 91st, 97th, 49th, 25th, and 33rd, respectively;

(50) the pixels of the first to seventy-fourth columns which form the fiftieth row of the rectangular pattern are turned on 105th, 137th, 147th, 136th, 104th, 56th, 96th, 128th, 144th, 118th, 62nd, 30th, 46th, 78th, 110th, 88th, 24th, 8th, 16th, 40th, 72nd, 58th, 18th, 2nd, 10th, 42nd, 90th, 100th, 52nd, 28th, 36th, 76th, 124th, 130th, 114th, 82nd, 66th, 106th, 138th, 148th, 135th, 103rd, 55th, 95th, 127th, 143rd, 117th, 61st, 29th, 45th, 77th, 109th, 87th, 23rd, 7th, 15th, 39th, 71st, 57th, 17th, 1st, 9th, 41st, 89th, 99th, 51st, 27th, 35th, 75th, 123rd, 129th, 113th, 81st, and 65th, respectively;

(51) the pixels of the first to seventy-fourth columns which form the fifty-first of the rectangular pattern are turned on 94th, 126th, 142nd, 120th, 64th, 32nd, 48th, 80th, 112th, 86th, 22nd, 6th, 14th, 38th, 70th, 60th, 20th, 4th, 12th, 44th, 92nd, 98th, 50th, 26th, 34th, 74th, 122nd, 132nd, 116th, 84th, 68th, 108th, 140th, 146th, 133rd, 101st, 53rd, 93rd, 125th, 141st, 119th, 63rd, 31st, 47th, 79th, 111th, 85th, 21st, 5th, 13th, 37th, 69th, 59th, 19th, 3rd, 11th, 43rd, 91st, 97th, 49th, 25th, 33rd, 73rd, 121st, 131st, 115th, 83rd, 67th, 107th, 139th, 145th, 134th, 102nd, and 54th, respectively;

(52) the pixels of the first to seventy-fourth columns which form the fifty-second row of the rectangular pattern are turned on 46th, 78th, 110th, 88th, 24th, 8th, 16th, 40th, 72nd, 58th, 18th, 2nd, 10th, 42nd, 90th, 100th, 52nd, 28th, 36th, 76th, 124th, 130th, 114th, 82nd, 66th, 106th, 138th, 148th, 135th, 103rd, 55th, 95th, 127th, 143rd, 117th, 61st, 29th, 45th, 77th, 109th, 87th, 23rd, 7th, 15th, 39th, 71st, 57th, 17th, 1st, 9th, 41st, 89th, 99th, 51st, 27th, 35th, 75th, 123rd, 129th, 113th, 81st, 65th, 105th, 137th, 147th, 136th, 104th, 56th, 96th, 128th, 144th, 118th, 62nd, and 30th, respectively;

(53) the pixels of the first to seventy-fourth columns which form the fifty-third of the rectangular pattern are turned on 14th, 38th, 70th, 60th, 20th, 4th, 12th, 44th, 92nd, 98th, 50th, 26th, 34th, 74th, 122nd, 132nd, 116th, 84th, 68th, 108th, 140th, 146th, 133rd, 101st, 53rd, 93rd, 125th, 141st, 119th, 63rd, 31st, 47th, 79th, 111th, 85th, 21st, 5th, 13th, 37th, 69th, 59th, 19th, 3rd, 11th, 43rd, 91st, 97th, 49th, 25th, 33rd, 73rd, 121st, 131st, 115th, 83rd, 67th, 107th, 139th, 145th, 134th, 102nd, 54th, 94th, 126th, 142nd, 120th, 64th, 32nd, 48th, 80th, 112th, 86th, 22nd, and 6th, respectively;

(54) the pixels of the first to seventy-fourth columns which form the fifty-fourth row of the rectangular pattern are turned on 10th, 42nd, 90th, 100th, 52nd, 28th, 36th, 76th, 124th, 130th, 114th, 82nd, 66th, 106th, 138th, 148th, 135th, 103rd, 55th, 95th, 127th, 143rd, 117th, 61st, 29th, 45th, 77th, 109th, 87th, 23rd, 7th, 15th, 39th, 71st, 57th, 17th, 1st, 9th, 41st, 89th, 99th, 51st, 27th, 35th, 75th, 123rd, 129th, 113th, 81st, 65th, 105th, 137th, 147th, 136th, 104th, 56th, 96th, 128th, 144th, 118th, 62nd, 30th, 46th, 78th, 110th, 88th, 24th, 8th, 16th, 40th, 72nd, 58th, 18th, and 2nd, respectively;

(55) the pixels of the first to seventy-fourth columns which form the fifty-fifth of the rectangular pattern are turned on 34th, 74th, 122nd, 132nd, 116th, 84th, 68th, 108th, 140th, 146th, 133rd, 101st, 53rd, 93rd, 125th, 141st, 119th, 63rd, 31st, 47th, 79th, 111th, 85th, 21st, 5th, 13th, 37th, 69th, 59th, 19th, 3rd, 11th, 43rd, 91st, 97th, 49th, 25th, 33rd, 73rd, 121st, 131st, 115th, 83rd, 67th, 107th, 139th, 145th, 134th, 102nd, 54th, 94th, 126th, 142nd, 120th, 64th, 32nd, 48th, 80th, 112th, 86th, 22nd, 6th, 14th, 38th, 70th, 60th, 20th, 4th, 12th, 44th, 92nd, 98th, 50th, and 26th, respectively;

(56) the pixels of the first to seventy-fourth columns which form the fifty-sixth row of the rectangular pattern are turned on 66th, 106th, 138th, 148th, 135th, 103rd, 55th, 95th, 127th, 143rd, 117th, 61st, 29th, 45th, 77th, 109th, 87th, 23rd, 7th, 15th, 39th, 71st, 57th, 17th, 1st, 9th, 41st, 89th, 99th, 51st, 27th, 35th, 75th, 123rd, 129th, 113th, 81st, 65th, 105th, 137th, 147th, 136th, 104th, 56th, 96th, 128th, 144th, 118th, 62nd, 30th, 46th, 78th, 110th, 88th, 24th, 8th, 16th, 40th, 72nd, 58th, 18th, 2nd, 10th, 42nd, 90th, 100th, 52nd, 28th, 36th, 76th, 124th, 130th, 114th, and 82nd, respectively;

(57) the pixels of the first to seventy-fourth columns which form the fifty-seventh of the rectangular pattern are turned on 53rd, 93rd, 125th, 141st, 119th, 63rd, 31st, 47th, 79th, 111th, 85th, 21st, 5th, 13th, 37th, 69th, 59th, 19th, 3rd, 11th, 43rd, 91st, 97th, 49th, 25th, 33rd, 73rd, 121st, 131st, 115th, 83rd, 67th, 107th, 139th, 145th, 134th, 102nd, 54th, 94th, 126th, 142nd, 120th, 64th, 32nd, 48th, 80th, 112th, 86th, 22nd, 6th, 14th, 38th, 70th, 60th, 20th, 4th, 12th, 44th, 92nd, 98th, 50th, 26th, 34th, 74th, 122nd, 132nd, 116th, 84th, 68th, 108th, 140th, 146th, 133rd, and 101st, respectively;

(58) the pixels of the first to seventy-fourth columns which form the fifty-eighth row of the rectangular pattern are turned on 29th, 45th, 77th, 109th, 87th, 23rd, 7th, 15th, 39th, 71st, 57th, 17th, 1st, 9th, 41st, 89th, 99th, 51st, 27th, 35th, 75th, 123rd, 129th, 113th, 81st, 65th, 105th, 137th, 147th, 136th, 104th, 56th, 96th, 128th, 144th, 118th, 62nd, 30th, 46th, 78th, 110th, 88th, 24th, 8th, 16th, 40th, 72nd, 58th, 18th, 2nd, 10th, 42nd, 90th, 100th, 52nd, 28th, 36th, 76th, 124th, 130th, 114th, 82nd, 66th, 106th, 138th, 148th, 135th, 103rd, 55th, 95th, 127th, 143rd, 117th, and 61st, respectively;

(59) the pixels of the first to seventy-fourth columns which form the fifty-ninth of the rectangular pattern are turned on 5th, 13th, 37th, 69th, 59th, 19th, 3rd, 11th, 43rd, 91st, 97th, 49th, 25th, 33rd, 73rd, 121st, 131st, 115th, 83rd, 67th, 107th, 139th, 145th, 134th, 102nd, 54th, 94th, 126th, 142nd, 120th, 64th, 32nd, 48th, 80th, 112th, 86th, 22nd, 6th, 14th, 38th, 70th, 60th, 20th, 4th, 12th, 44th, 92nd, 98th, 50th, 26th, 34th, 74th, 122nd, 132nd, 116th, 84th, 68th, 108th, 140th, 146th, 133rd, 101st, 53rd, 93rd, 125th, 141st, 119th, 63rd, 31st, 47th, 79th, 111th, 85th, and 21st, respectively;

(60) the pixels of the first to seventy-fourth columns which form the sixtieth row of the rectangular pattern are turned on 1st, 9th, 41st, 89th, 99th, 51st, 27th, 35th, 75th, 123rd, 129th, 113th, 81st, 65th, 105th, 137th, 147th, 136th, 104th, 56th, 96th, 128th, 144th, 118th, 62nd, 30th, 46th, 78th, 110th, 88th, 24th, 8th, 16th, 40th, 72nd, 58th, 18th, 2nd, 10th, 42nd, 90th, 100th, 52nd, 28th, 36th, 76th, 124th, 130th, 114th, 82nd, 66th, 106th, 138th, 148th, 135th, 103rd, 55th, 95th, 127th, 143rd, 117th, 61st, 29th, 45th, 77th, 109th, 87th, 23rd, 7th, 15th, 39th, 71st, 57th, and 17th, respectively;

(61) the pixels of the first to seventy-fourth columns which form the sixty-first of the rectangular pattern are turned on 25th, 33rd, 73rd, 121st, 131st, 115th, 83rd, 67th, 107th, 139th, 145th, 134th, 102nd, 54th, 94th, 126th, 142nd, 120th, 64th, 32nd, 48th, 80th, 112th, 86th, 22nd, 6th, 14th, 38th, 70th, 60th, 20th, 4th, 12th, 44th, 92nd, 98th, 50th, 26th, 34th, 74th, 122nd, 132nd, 116th, 84th, 68th, 108th, 140th, 146th, 133rd, 101st, 53rd, 93rd, 125th, 141st, 119th, 63rd, 31st, 47th, 79th, 111th, 85th, 21st, 5th, 13th, 37th, 69th, 59th, 19th, 3rd, 11th, 43rd, 91st, 97th, and 49th, respectively;

(62) the pixels of the first to seventy-fourth columns which form the sixty-second row of the rectangular pattern are turned on 81st, 65th, 105th, 137th, 147th, 136th, 104th, 56th, 96th, 128th, 144th, 118th, 62nd, 30th, 46th, 78th, 110th, 88th, 24th, 8th, 16th, 40th, 72nd, 58th, 18th, 2nd, 10th, 42nd, 90th, 100th, 52nd, 28th, 36th, 76th, 124th, 130th, 114th, 82nd, 66th, 106th, 138th, 148th, 135th, 103rd, 55th, 95th, 127th, 143rd, 117th, 61st, 29th, 45th, 77th, 109th, 87th, 23rd, 7th, 15th, 39th, 71st, 57th, 17th, 1st, 9th, 41st, 89th, 99th, 51st, 27th, 35th, 75th, 123rd, 129th, and 113th, respectively;

(63) the pixels of the first to seventy-fourth columns which form the sixty-third of the rectangular pattern are turned on 102nd, 54th, 94th, 126th, 142nd, 120th, 64th, 32nd, 48th, 80th, 112th, 86th, 22nd, 6th, 14th, 38th, 70th, 60th, 20th, 4th, 12th, 44th, 92nd, 98th, 50th, 26th, 34th, 74th, 122nd, 132nd, 116th, 84th, 68th, 108th, 140th, 146th, 133rd, 101st, 53rd, 93rd, 125th, 141st, 119th, 63rd, 31st, 47th, 79th, 111th, 85th, 21st, 5th, 13th, 37th, 69th, 59th, 19th, 3rd, 11th, 43rd, 91st, 97th, 49th, 25th, 33rd, 73rd, 121st, 131st, 115th, 83rd, 67th, 107th, 139th, 145th, and 134th, respectively;

(64) the pixels of the first to seventy-fourth columns which form the sixty-fourth row of the rectangular pattern are turned on 62nd, 30th, 46th, 78th, 110th, 88th, 24th, 8th, 16th, 40th, 72nd, 58th, 18th, 2nd, 10th, 42nd, 90th, 100th, 52nd, 28th, 36th, 76th, 124th, 130th, 114th, 82nd, 66th, 106th, 138th, 148th, 135th, 103rd, 55th, 95th, 127th, 143rd, 117th, 61st, 29th, 45th, 77th, 109th, 87th, 23rd, 7th, 15th, 39th, 71st, 57th, 17th, 1st, 9th, 41st, 89th, 99th, 51st, 27th, 35th, 75th, 123rd, 129th, 113th, 81st, 65th, 105th, 137th, 147th, 136th, 104th, 56th, 96th, 128th, 144th, and 118th, respectively;

(65) the pixels of the first to seventy-fourth columns which form the sixty-fifth of the rectangular pattern are turned on 22nd, 6th, 14th, 38th, 70th, 60th, 20th, 4th, 12th, 44th, 92nd, 98th, 50th, 26th, 34th, 74th, 122nd, 132nd, 116th, 84th, 68th, 108th, 140th, 146th, 133rd, 101st, 53rd, 93rd, 125th, 141st, 119th, 63rd, 31st, 47th, 79th, 111th, 85th, 21st, 5th, 13th, 37th, 69th, 59th, 19th, 3rd, 11th, 43rd, 91st, 97th, 49th, 25th, 33rd, 73rd, 121st, 131st, 115th, 83rd, 67th, 107th, 139th, 145th, 134th, 102nd, 54th, 94th, 126th, 142nd, 120th, 64th, 32nd, 48th, 80th, 112th, and 86th, respectively;

(66) the pixels of the first to seventy-fourth columns which form the sixty-sixth row of the rectangular pattern are turned on 18th, 2nd, 10th, 42nd, 90th, 100th, 52nd, 28th, 36th, 76th, 124th, 130th, 114th, 82nd, 66th, 106th, 138th, 148th, 135th, 103rd, 55th, 95th, 127th, 143rd, 117th, 61st, 29th, 45th, 77th, 109th, 87th, 23rd, 7th, 15th, 39th, 71st, 57th, 17th, 1st, 9th, 41st, 89th, 99th, 51st, 27th, 35th, 75th, 123rd, 129th, 113th, 81st, 65th, 105th, 137th, 147th, 136th, 104th, 56th, 96th, 128th, 144th, 118th, 62nd, 30th, 46th, 78th, 110th, 88th, 24th, 8th, 16th, 40th, 72nd, and 58th, respectively;

(67) the pixels of the first to seventy-fourth columns which form the sixty-seventh of the rectangular pattern are turned on 50th, 26th, 34th, 74th, 122nd, 132nd, 116th, 84th, 68th, 108th, 140th, 146th, 133rd, 101st, 53rd, 93rd, 125th, 141st, 119th, 63rd, 31st, 47th, 79th, 111th, 85th, 21st, 5th, 13th, 37th, 69th, 59th, 19th, 3rd, 11th, 43rd, 91st, 97th, 49th, 25th, 33rd, 73rd, 121st, 131st, 115th, 83rd, 67th, 107th, 139th, 145th, 134th, 102nd, 54th, 94th, 126th, 142nd, 120th, 64th, 32nd, 48th, 80th, 112th, 86th, 22nd, 6th, 14th, 38th, 70th, 60th, 20th, 4th, 12th, 44th, 92nd, and 98th, respectively;

(68) the pixels of the first to seventy-fourth columns which form the sixty-eighth row of the rectangular pattern are turned on 114th, 82nd, 66th, 106th, 138th, 148th, 135th, 103rd, 55th, 95th, 127th, 143rd, 117th, 61st, 29th, 45th, 77th, 109th, 87th, 23rd, 7th, 15th, 39th, 71st, 57th, 17th, 1st, 9th, 41st, 89th, 99th, 51st, 27th, 35th, 75th, 123rd, 129th, 113th, 81st, 65th, 105th, 137th, 147th, 136th, 104th, 56th, 96th, 128th, 144th, 118th, 62nd, 30th, 46th, 78th, 110th, 88th, 24th, 8th, 16th, 40th, 72nd, 58th, 18th, 2nd, 10th, 42nd, 90th, 100th, 52nd, 28th, 36th, 76th, 124th, and 130th, respectively;

(69) the pixels of the first to seventy-fourth columns which form the sixty-ninth of the rectangular pattern are turned on 133rd, 101st, 53rd, 93rd, 125th, 141st, 119th, 63rd, 31st, 47th, 79th, 111th, 85th, 21st, 5th, 13th, 37th, 69th, 59th, 19th, 3rd, 11th, 43rd, 91st, 97th, 49th, 25th, 33rd, 73rd, 121st, 131st, 115th, 83rd, 67th, 107th, 139th, 145th, 134th, 102nd, 54th, 94th, 126th, 142nd, 120th, 64th, 32nd, 48th, 80th, 112th, 86th, 22nd, 6th, 14th, 38th, 70th, 60th, 20th, 4th, 12th, 44th, 92nd, 98th, 50th, 26th, 34th, 74th, 122nd, 132nd, 116th, 84th, 68th, 108th, 140th, and 146th, respectively;

(70) the pixels of the first to seventy-fourth columns which form the seventieth row of the rectangular pattern are turned on 117th, 61st, 29th, 45th, 77th, 109th, 87th, 23rd, 7th, 15th, 39th, 71st, 57th, 17th, 1st, 9th, 41st, 89th, 99th, 51st, 27th, 35th, 75th, 123rd, 129th, 113th, 81st, 65th, 105th, 137th, 147th, 136th, 104th, 56th, 96th, 128th, 144th, 118th, 62nd, 30th, 46th, 78th, 110th, 88th, 24th, 8th, 16th, 40th, 72nd, 58th, 18th, 2nd, 10th, 42nd, 90th, 100th, 52nd, 28th, 36th, 76th, 124th, 130th, 114th, 82nd, 66th, 106th, 138th, 148th, 135th, 103rd, 55th, 95th, 127th, and 143rd, respectively;

(71) the pixels of the first to seventy-fourth columns which form the seventy-first of the rectangular pattern are turned on 85th, 21st, 5th, 13th, 37th, 69th, 59th, 19th, 3rd, 11th, 43rd, 91st, 97th, 49th, 25th, 33rd, 73rd, 121st, 131st, 115th, 83rd, 67th, 107th, 139th, 145th, 134th, 102nd, 54th, 94th, 126th, 142nd, 120th, 64th, 32nd, 48th, 80th, 112th, 86th, 22nd, 6th, 14th, 38th, 70th, 60th, 20th, 4th, 12th, 44th, 92nd, 98th, 50th, 26th, 34th, 74th, 122nd, 132nd, 116th, 84th, 68th, 108th, 140th, 146th, 133rd, 101st, 53rd, 93rd, 125th, 141st, 119th, 63rd, 31st, 47th, 79th, and 111th, respectively;

(72) the pixels of the first to seventy-fourth columns which form the seventy-second row of the rectangular pattern are turned on 57th, 17th, 1st, 9th, 41st, 89th, 99th, 51st, 27th, 35th, 75th, 123rd, 129th, 113th, 81st, 65th, 105th, 137th, 147th, 136th, 104th, 56th, 96th, 128th, 144th, 118th, 62nd, 30th, 46th, 78th, 110th, 88th, 24th, 8th, 16th, 40th, 72nd, 58th, 18th, 2nd, 10th, 42nd, 90th, 100th, 52nd, 28th, 36th, 76th, 124th, 130th, 114th, 82nd, 66th, 106th, 138th, 148th, 135th, 103rd, 55th, 95th, 127th, 143rd, 117th, 61st, 29th, 45th, 77th, 109th, 87th, 23rd, 7th, 15th, 39th, and 71st, respectively;

(73) the pixels of the first to seventy-fourth columns which form the seventy-third of the rectangular pattern are turned on 97th, 49th, 25th, 33rd, 73rd, 121st, 131st, 115th, 83rd, 67th, 107th, 139th, 145th, 134th, 102nd, 54th, 94th, 126th, 142nd, 120th, 64th, 32nd, 48th, 80th, 112th, 86th, 22nd, 6th, 14th, 38th, 70th, 60th, 20th, 4th, 12th, 44th, 92nd, 98th, 50th, 26th, 34th, 74th, 122nd, 132nd, 116th, 84th, 68th, 108th, 140th, 146th, 133rd, 101st, 53rd, 93rd, 125th, 141st, 119th, 63rd, 31st, 47th, 79th, 111th, 85th, 21st, 5th, 13th, 37th, 69th, 59th, 19th, 3rd, 11th, 43rd, and 91st, respectively; and

(74) the pixels of the first to seventy-fourth columns which form the seventy-fourth row of the rectangular pattern are turned on 129th, 113th, 81st, 65th, 105th, 137th, 147th, 136th, 104th, 56th, 96th, 128th, 144th, 118th, 62nd, 30th, 46th, 78th, 110th, 88th, 24th, 8th, 16th, 40th, 72nd, 58th, 18th, 2nd, 10th, 42nd, 90th, 100th, 52nd, 28th, 36th, 76th, 124th, 130th, 114th, 82nd, 66th, 106th, 138th, 148th, 135th, 103rd, 55th, 95th, 127th, 143rd, 117th, 61st, 29th, 45th, 77th, 109th, 87th, 23rd, 7th, 15th, 39th, 71st, 57th, 17th, 1st, 9th, 41st, 89th, 99th, 51st, 27th, 35th, 75th, and 123rd, respectively.

Further, the turn-on order of the pixels is set so that dots having shapes same as each other individually grow in order from a plurality of points.

Similarly to the binarization pattern 12g, also the binarization pattern 12h is a binarization pattern having a dither angle (screen angle, half tone angle) of 9.5 degrees and an output line number of 98.6 lpi.

It is to be noted that, by using the binarization pattern 12h, the pixel value (for example, within a range from 0 to 255) of each of pixels which form a multi-value image (original image) to be printed can be represented in one hundred forty-nine stages (gradations).

Also the binarization pattern 12i shown in FIG. 25 is a rectangular pattern wherein a plurality of pixels to be successively turned on are arranged in a matrix, and is formed from four hundred pixels which are arranged in a matrix of twenty rows and twenty columns (rectangular pattern). Further, a turn-on order number is individually set to each of the pixels.

Further, in the binarization pattern 12i, as shown in FIG. 25, the turn-on order is set so that dots having shapes same as each other individually grow in order from a plurality of points (in the binarization pattern 12i, pixels to which the number 1 is applied).

The binarization pattern 12i is formed by repetitively arranging the basic pattern 125 shown in FIG. 24 in a vertical direction and a transverse direction. As shown in FIG. 24, the basic pattern 125 is a partly lacking matrix formed by partly cutting away a rectangular matrix formed from fifty-six pixels of eight rows and seven columns. In the present modification, the basic pattern 125 is formed by cutting away the pixels at the first to third and seventh columns of the first row, the seventh column of the second row, the seventh column of the thi rd, row, the first column of the sixth row, the first, sixth and seventh columns of the seventh row, and the first and third to seventh columns of the eighth row.

Further, in the basic pattern 125 shown in FIG. 24, the turn-on order is set such that the pixels are turned on preferentially beginning with a pixel nearest to a specific point (in the present modification, the center of the figure of the basic pattern 125) in the basic pattern 125 so that a dot grows in a substantially circular form.

In particular, in the basic pattern 125 shown in FIG. 24, a color material is placed on the pixels in order from a pixel having a low order number to another pixel having a higher order number. Therefore, a dot grows in a substantially circular form in order from the proximity of the center of the figure (specific point) of the basic pattern 125, and the binarization pattern 12i functions as a binarization pattern (binarization dither matrix pattern; dither pattern) of the dot concentration type.

In particular, the basic pattern 125 is formed such that, in a partly lacking matrix having eight rows and seven columns, the pixels of the fourth to sixth columns which form the first row of the partly lacking matrix are turned on 29th, 35th, and 39, respectively; the pixels of the first to sixth columns which form the second row of the partly lacking matrix are turned on 37th, 27th, 15th, 17th, 25th, and 31st, respectively; the pixels of the first to sixth columns which form the third row of the partly lacking matrix are turned on 33rd, 21st, 9th, 7th, 11th, and 19th, respectively; the pixels of the first to seventh column which form the fourth row of the partly lacking matrix are turned on 28th, 10th, 3rd, 1st, 5th, 13th, and 23rd, respectively; the pixels of the first to seventh columns which form the fifth row of the partly lacking matrix are turned on 22nd, 12th, 4th, 2nd, 6th, 18th, and 34th, respectively; the pixels of the second to seventh columns which form the sixth row of the partly lacking matrix are turned on 26th, 16th, 8th, 14th, 30th, and 38th, respectively; the pixels of the second to fifth columns which form the seventh row of the partly lacking matrix are turned on 36th, 32nd, 24th, and 20th, respectively; and the pixel of the second column which forms the eighth row of the partly lacking matrix is turned on 40th.

As shown in FIG. 25, the binarization pattern 12i is formed by arranging such basic patterns (partly lacking matrixes) 125 such that the lacking portions of each basic pattern 125 are fitted with basic patterns 125 adjacent thereto and a turn-on order appears repetitively and successively in a vertical direction (row arrangement direction) and a transverse direction (column arrangement direction) of the binarization pattern 12i without a clearance left therebetween and then cutting away an arbitrary rectangular portion (refer to a thick line of FIG. 25) having twenty rows and twenty columns from the arranged basic patterns 125.

Further, in the binarization pattern 12i, the turn-on order is set so that dots having shapes same as each other individually grow in order from each of the basic patterns 125 provided in the binarization pattern 12i.

In particular, in the binarization pattern 12i, the turn-on order of four hundred pixels is set such that:

(1) the pixels of the first to twentieth columns which form the first row of the rectangular pattern are turned on 37th, 27th, 15th, 17th, 25th, 31st, 28th, 10th, 3rd, 1st, 5th, 13th, 23rd, 26th, 16th, 8th, 14th, 30th, 38th, and 40th, respectively;

(2) the pixels of the first to twentieth columns which form the second row of the rectangular pattern are turned on 33rd, 21st, 9th, 7th, 11th, 19th, 22nd, 12th, 4th, 2nd, 6th, 18th, 34th, 36th, 32nd, 24th, 20th, 29th, 35th, and 39th, respectively;

(3) the pixels of the first to twentieth columns which form the third row of the rectangular pattern are turned on 28th, 10th, 3rd, 1st, 5th, 13th, 23rd, 26th, 16th, 8th, 14th, 30th, 38th, 40th, 37th, 27th, 15th, 17th, 25th, and 31st, respectively;

(4) the pixels of the first to twentieth columns which form the fourth row of the rectangular pattern are turned on 22nd, 12th, 4th, 2nd, 6th, 18th, 34th, 36th, 32nd, 24th, 20th, 29th, 35th, 39th, 33rd, 21st, 9th, 7th, 11th, and 19th, respectively;

(5) the pixels of the first to twentieth columns which form the fifth row of the rectangular pattern are turned on 23rd, 26th, 16th, 8th, 14th, 30th, 38th, 40th, 37th, 27th, 15th, 17th, 25th, 31st, 28th, 10th, 3rd, 1st, 5th, and 13th, respectively;

(6) the pixels of the first to twentieth columns which form the sixth row of the rectangular pattern are turned on 34th, 36th, 32nd, 24th, 20th, 29th, 35th, 39th, 33rd, 21st, 9th, 7th, 11th, 19th, 22nd, 12th, 4th, 2nd, 6th, and 18th, respectively;

(7) the pixels of the first to twentieth columns which form the seventh row of the rectangular pattern are turned on 38th, 40th, 37th, 27th, 15th, 17th, 25th, 31st, 28th, 10th, 3rd, 1st, 5th, 13th, 23rd, 26th, 16th, 8th, 14th, and 30th, respectively;

(8) the pixels of the first to twentieth columns which form the eighth row of the rectangular pattern are turned on 35th, 39th, 33rd, 21st, 9th, 7th, 11th, 19th, 22nd, 12th, 4th, 2nd, 6th, 18th, 34th, 36th, 32nd, 24th, 20th, and 29th, respectively;

(9) the pixels of the first to twentieth columns which form the ninth row of the rectangular pattern are turned on 25th, 31st, 28th, 10th, 3rd, 1st, 5th, 13th, 23rd, 26th, 16th, 8th, 14th, 30th, 38th, 40th, 37th, 27th, 15th, and 17th, respectively;

(10) the pixels of the first to twentieth columns which form the tenth row of the rectangular pattern are turned on 11th, 19th, 22nd, 12th, 4th, 2nd, 6th, 18th, 34th, 36th, 32nd, 24th, 20th, 29th, 35th, 39th, 33rd, 21st, 9th, and 7th, respectively;

(11) the pixels of the first to twentieth columns which form the eleventh row of the rectangular pattern are turned on 5th, 13th, 23rd, 26th, 16th, 8th, 14th, 30th, 38th, 40th, 37th, 27th, 15th, 17th, 25th, 31st, 28th, 10th, 3rd, and 1st, respectively;

(12) the pixels of the first to twentieth columns which form the twelfth row of the rectangular pattern are turned on 6th, 18th, 34th, 36th, 32nd, 24th, 20th, 29th, 35th, 39th, 33rd, 21st, 9th, 7th, 11th, 19th, 22nd, 12th, 4th, and 2nd, respectively;

(13) the pixels of the first to twentieth columns which form the thirteenth row of the rectangular pattern are turned on 14th, 30th, 38th, 40th, 37th, 27th, 15th, 17th, 25th, 31st, 28th, 10th, 3rd, 1st, 5th, 13th, 23rd, 26th, 16th, and 8th, respectively;

(14) the pixels of the first to twentieth columns which form the fourteenth row of the rectangular pattern are turned on 20th, 29th, 35th, 39th, 33rd, 21st, 9th, 7th, 11th, 19th, 22nd, 12th, 4th, 2nd, 6th, 18th, 34th, 36th, 32nd, and 24th, respectively;

(15) the pixels of the first to twentieth columns which form the fifteenth row of the rectangular pattern are turned on 15th, 17th, 25th, 31st, 28th, 10th, 3rd, 1st, 5th, 13th, 23rd, 26th, 16th, 8th, 14th, 30th, 38th, 40th, 37th, and 27th, respectively;

(16) the pixels of the first to twentieth columns which form the sixteenth row of the rectangular pattern are turned on 9th, 7th, 11th, 19th, 22nd, 12th, 4th, 2nd, 6th, 18th, 34th, 36th, 32nd, 24th, 20th, 29th, 35th, 39th, 33rd, and 21st, respectively;

(17) the pixels of the first to twentieth columns which form the seventeenth row of the rectangular pattern are turned on 3rd, 1st, 5th, 13th, 23rd, 26th, 16th, 8th, 14th, 30th, 38th, 40th, 37th, 27th, 15th, 17th, 25th, 31st, 28th, and 10th, respectively;

(18) the pixels of the first to twentieth columns which form the eighteenth row of the rectangular pattern are turned on 4th, 2nd, 6th, 18th, 34th, 36th, 32nd, 24th, 20th, 29th, 35th, 39th, 33rd, 21st, 9th, 7th, 11th, 19th, 22nd, and 12th, respectively;

(19) the pixels of the first to twentieth columns which form the nineteenth row of the rectangular pattern are turned on 16th, 8th, 14th, 30th, 38th, 40th, 37th, 27th, 15th, 17th, 25th, 31st, 28th, 10th, 3rd, 1st, 5th, 13th, 23rd, and 26th, respectively; and

(20) the pixels of the first to twentieth columns which form the twentieth row of the rectangular pattern are turned on 32nd, 24th, 20th, 29th, 35th, 39th, 33rd, 21st, 9th, 7th, 11th, 19th, 22nd, 12th, 4th, 2nd, 6th, 18th, 34th, and 36th, respectively.

Further, in the binarization pattern 12i, the dither angle (screen angle, halftone dot angle) is 18.4 degrees. In particular, the binarization pattern 12i shown in FIG. 25 is a binarization pattern having a dither angle of 18.4 degrees and an output line number of 94.9 lpi.

It is to be noted that, by using the binarization pattern 12i, the picture element value (for example, within a range from 0 to 255) of each of picture elements which form a multi-value image (original image) to be printed can be individually represented in forty-one stages (gradations).

The binarization pattern 12j shown in FIG. 26 is formed from one thousand six hundred picture elements arranged in a matrix of forty rows and forty columns, and is configured as a rectangular pattern wherein a plurality of picture elements to be successively turned on are arranged in a matrix. Further, the binarization pattern 12j includes a plurality of sub patterns 1251 formed by arranging two basic patterns 125 shown in FIG. 24 in a vertical direction and a transverse direction (in the present modification, two basic patterns in a vertical direction and two basic patterns in a transverse direction, and hence totaling four basic patterns) such that each of the lacking portions of each basic pattern 125 are fitted with a portion of another basic pattern 125 corresponding to a point-symmetric position with respect to the center of the figure in the basic pattern 125 and a turn-on order appears repetitively and successively in a vertical direction (row arrangement direction) and a transverse direction (column arrangement direction) of the binarization pattern 12j without a clearance left therebetween. It is to be noted that, in FIG. 26, slanting lines are applied to several sub patterns 1251 for the convenience of illustration.

It is to be noted that, as a reference character which indicates a basic pattern, reference characters 125-1 to 125-n (n is a natural number) are used where one basic pattern must be specified from among a plurality of basic patterns, but reference numeral 125 is used when an arbitrary basic pattern is to be pointed to. Further, the number of basic patterns 125 which form a single sub pattern 1251 is represented by m. In particular, in the present modification, a relationship of 1≦n≦m (n and m are natural numbers) is satisfied.

In the binarization pattern 12j shown in FIG. 26, the sub pattern 1251 includes four basic patterns 125, that is, 125-1 to 125-4. Therefore, n is an arbitrary natural number from among 1, 2, 3 and 4, and m is equal to 4.

In particular, the sub pattern 1251 is formed by arranging m (m=4) basic patterns 125 (125-1 to 125-n; where 1≦n≦m) formed such that, in a partly lacking matrix having eight rows and seven columns, the picture elements of the fourth to sixth columns which form the first row of the partly lacking matrix are turned on n+28×mth, n+34×mth, and n+38×mth, respectively; the picture elements of the first to sixth columns which form the second row of the partly lacking matrix are turned on n+36×mth, n+26×mth, n+14×mth, n+16×mth, n+24×mth, and n+30×mth, respectively; the picture elements of the first to sixth columns which form the third row of the partly lacking matrix are turned on n+32×mth, n+20×mth, n+8×mth, n+6×mth, n+10×mth, and n+18×mth, respectively; the picture elements of the first to seventh columns which form the fourth row of the partly lacking matrix are turned on n+27×mth, n+9×mth, n+2×mth, nth, n+4×mth, n+12×mth, and n+22×mth, respectively; the picture elements of the first to seventh columns which form the fifth row of the partly lacking matrix are turned on n+21×mth, n+11×mth, n+3×mth, n+mth, n+5×mth, n+17×mth, and n+33×mth, respectively; the picture elements of the second to seventh columns which form the sixth row of the partly lacking matrix are turned on n+25×mth, n+15×mth, n+7×mth, n+13×mth, n+29×mth, and n+37×mth, respectively; the picture elements of the second to fifth columns which form the seventh row of the partly lacking matrix are turned on n+35×mth, n+31×mth, n+23×mth, and n+19×mth, respectively; and the picture element of the second column which forms the eighth row of the partly lacking matrix is turned on n+39×mth.

Further, in the sub pattern 1251 to which slanting lines are applied in FIG. 26, the basic pattern 125-2 is arranged on the lower side of the basic pattern 125-1; the basic pattern 125-3 is arranged on the right side of the basic pattern 125-1; and the basic pattern 125-4 is arranged on the lower side of the basic pattern 125-3. It is to be noted that the arrangement of the basic patterns 125-1 to 125-4 in the sub pattern 1251 is not limited to this, and variations and modifications can be made without departing from the scope of the present invention.

The binarization pattern 12j is formed by arranging a plurality of such sub patterns 1251 in a vertical direction and a transverse direction such that the basic patterns 125-1 and 125-3 of each sub pattern 1251 are fitted with the lacking portions of the basic patterns 125-2 and 125-4 of another sub pattern 1251 adjacent in a vertical direction and a turn-on order appears repetitively and successively in a vertical direction (row arrangement direction) and a transverse direction (column arrangement direction) of the binarization pattern 12j without a clearance left therebetween and then cutting out an arbitrary rectangular portion having forty rows and forty columns from the arranged basic patterns 125.

Further, the binarization pattern 12j includes a plurality of such sub patterns 1251 as described above, and the turn-on order of the pixels is set so that dots having shapes same as each other individually grow in order from a plurality of the sub patterns 1251.

In particular, in the binarization pattern 12j, as shown in FIG. 26, the turn-on order of one thousand six hundred pixels is set such that:

(1) the pixels of the first to fortieth columns which form the first row of the rectangular pattern are turned on 157th, 146th, 106th, 58th, 66th, 98th, 122nd, 112th, 40th, 12th, 4th, 20th, 52nd, 92nd, 102nd, 62nd, 30th, 54th, 118th, 150th, 160th, 147th, 107th, 59th, 67th, 99th, 123rd, 109th, 37th, 9th, 1st, 17th, 49th, 89th, 103rd, 63rd, 31st, 55th, 119th, and 151st, respectively;

(2) the pixels of the first to fortieth columns which form the second row of the rectangular pattern are turned on 156th, 130th, 82nd, 34th, 26th, 42nd, 74th, 88th, 48th, 16th, 8th, 24th, 72nd, 136th, 142nd, 126th, 94th, 78th, 113th, 137th, 153rd, 131st, 83rd, 35th, 27th, 43rd, 75th, 85th, 45th, 13th, 5th, 21st, 69th, 133rd, 143rd, 127th, 95th, 79th, 116th, and 140th, respectively;

(3) the pixels of the first to fortieth columns which form the third row of the rectangular pattern are turned on 124th, 110th, 38th, 10th, 2nd, 18th, 50th, 90th, 104th, 64th, 32nd, 56th, 120th, 152nd, 158th, 145th, 105th, 57th, 65th, 97th, 121st, 111th, 39th, 11th, 3rd, 19th, 51st, 91st, 101st, 61st, 29th, 53rd, 117th, 149th, 159th, 148th, 108th, 60th, 68th, and 100th, respectively;

(4) the pixels of the first to fortieth columns which form the fourth row of the rectangular pattern are turned on 76th, 86th, 46th, 14th, 6th, 22nd, 70th, 134th, 144th, 128th, 96th, 80th, 115th, 139th, 155th, 129th, 81st, 33rd, 25th, 41st, 73rd, 87th, 47th, 15th, 7th, 23rd, 71st, 135th, 141st, 125th, 93rd, 77th, 114th, 138th, 154th, 132nd, 84th, 36th, 28th, and 44th, respectively;

(5) the pixels of the first to fortieth columns which form the fifth row of the rectangular pattern are turned on 52nd, 92nd, 102nd, 62nd, 30th, 54th, 118th, 150th, 160th, 147th, 107th, 59th, 67th, 99th, 123rd, 109th, 37th, 9th, 1st, 17th, 49th, 89th, 103rd, 63rd, 31st, 55th, 119th, 151st, 157th, 146th, 106th, 58th, 66th, 98th, 122nd, 112th, 40th, 12th, 4th, and 20th, respectively;

(6) the pixels of the first to fortieth columns which form the sixth row of the rectangular pattern are turned on 72nd, 136th, 142nd, 126th, 94th, 78th, 113th, 137th, 153rd, 131st, 83rd, 35th, 27th, 43rd, 75th, 85th, 45th, 13th, 5th, 21st, 69th, 133rd, 143rd, 127th, 95th, 79th, 116th, 140, 156th, 130th, 82nd, 34th, 26th, 42nd, 74th, 88th, 48th, 16th, 8th, and 24th, respectively;

(7) the pixels of the first to fortieth columns which form the seventh row of the rectangular pattern are turned on 120th, 152nd, 158th, 145th, 105th, 57th, 65th, 97th, 121st, 111th, 39th, 11th, 3rd, 19th, 51st, 91st, 101st, 61st, 29th, 53rd, 117th, 149th, 159th, 148th, 108th, 60th, 68th, 100th, 124th, 110th, 38th, 10th, 2nd, 18th, 50th, 90th, 104th, 64th, 32nd, and 56th, respectively;

(8) the pixels of the first to fortieth columns which form the eighth row of the rectangular pattern are turned on 115th, 139th, 155th, 129th, 81st, 33rd, 25th, 41st, 73rd, 87th, 47th, 15th, 7th, 23rd, 71st, 135th, 141st, 125th, 93rd, 77th, 114th, 138th, 154th, 132nd, 84th, 36th, 28th, 44th, 76th, 86th, 46th, 14th, 6th, 22nd, 70th, 134th, 144th, 128th, 96th, and 80th, respectively;

(9) the pixels of the first to fortieth columns which form the ninth row of the rectangular pattern are turned on 67th, 99th, 123rd, 109th, 37th, 9th, 1st, 17th, 49th, 89th, 103rd, 63rd, 31st, 55th, 119th, 151st, 157th, 146th, 106th, 58th, 66th, 98th, 122nd, 112th, 40th, 12th, 4th, 20th, 52nd, 92nd, 102nd, 62nd, 30th, 54th, 118th, 150th, 160th, 147th, 107th, and 59th, respectively;

(10) the pixels of the first to fortieth columns which form the tenth row of the rectangular pattern are turned on 27th, 43rd, 75th, 85th, 45th, 13th, 5th, 21st, 69th, 133rd, 143rd, 127th, 95th, 79th, 116th, 140th, 156th, 130th, 82nd, 34th, 26th, 42nd, 74th, 88th, 48th, 16th, 8th, 24th, 72nd, 136th, 142nd, 126th, 94th, 78th, 113th, 137th, 153rd, 131st, 83rd, and 35th, respectively;

(11) the pixels of the first to fortieth columns which form the eleventh row of the rectangular pattern are turned on 3rd, 19th, 51st, 91st, 101st, 61st, 29th, 53rd, 117th, 149th, 159th, 148th, 108th, 60th, 68th, 100th, 124th, 110th, 38th, 10th, 2nd, 18th, 50th, 90th, 104th, 64th, 32nd, 56th, 120th, 152nd, 158th, 145th, 105th, 57th, 65th, 97th, 121st, 111th, 39th, and 11th, respectively;

(12) the pixels of the first to fortieth columns which form the twelfth row of the rectangular pattern are turned on 7th, 23rd, 71st, 135th, 141st, 125th, 93rd, 77th, 114th, 138th, 154th, 132nd, 84th, 36th, 28th, 44th, 76th, 86th, 46th, 14th, 6th, 22nd, 70th, 134th, 144th, 128th, 96th, 80th, 115th, 139th, 155th, 129th, 81st, 33rd, 25th, 41st, 73rd, 87th, 47th, and 15th, respectively;

(13) the pixels of the first to fortieth columns which form the thirteenth row of the rectangular pattern are turned on 31st, 55th, 119th, 151st, 157th, 146th, 106th, 58th, 66th, 98th, 122nd, 112th, 40th, 12th, 4th, 20th, 52nd, 92nd, 102nd, 62nd, 30th, 54th, 118th, 150th, 160th, 147th, 107th, 59th, 67th, 99th, 123rd, 109th, 37th, 9th, 1st, 17th, 49th, 89th, 103rd, and 63rd, respectively;

(14) the pixels of the first to fortieth columns which form the fourteenth row of the rectangular pattern are turned on 95th, 79th, 116th, 140th, 156th, 130th, 82nd, 34th, 26th, 42nd, 74th, 88th, 48th, 16th, 8th, 24th, 72nd, 136th, 142nd, 126th, 94th, 78th, 113th, 137th, 153rd, 131st, 83rd, 35th, 27th, 43rd, 75th, 85th, 45th, 13th, 5th, 21st, 69th, 133rd, 143rd, and 127th, respectively;

(15) the pixels of the first to fortieth columns which form the fifteenth row of the rectangular pattern are turned on 108th, 60th, 68th, 100th, 124th, 110th, 38th, 10th, 2nd, 18th, 50th, 90th, 104th, 64th, 32nd, 56th, 120th, 152nd, 158th, 145th, 105th, 57th, 65th, 97th, 121st, 111th, 39th, 11th, 3rd, 19th, 51st, 91st, 101st, 61st, 29th, 53rd, 117th, 149th, 159th, and 148th, respectively;

(16) the pixels of the first to fortieth columns which form the sixteenth row of the rectangular pattern are turned on 84th, 36th, 28th, 44th, 76th, 86th, 46th, 14th, 6th, 22nd, 70th, 134th, 144th, 128th, 96th, 80th, 115th, 139th, 155th, 129th, 81st, 33rd, 25th, 41st, 73rd, 87th, 47th, 15th, 7th, 23rd, 71st, 135th, 141st, 125th, 93rd, 77th, 114th, 138th, 154th, and 132nd, respectively;

(17) the pixels of the first to fortieth columns which form the seventeenth row of the rectangular pattern are turned on 40th, 12th, 4th, 20th, 52nd, 92nd, 102nd, 62nd, 30th, 54th, 118th, 150th, 160th, 147th, 107th, 59th, 67th, 99th, 123rd, 109th, 37th, 9th, 1st, 17th, 49th, 89th, 103rd, 63rd, 31st, 55th, 119th, 151st, 157th, 146th, 106th, 58th, 66th, 98th, 122nd, and 112th, respectively;

(18) the pixels of the first to fortieth columns which form the eighteenth row of the rectangular pattern are turned on 48th, 16th, 8th, 24th, 72nd, 136th, 142nd, 126th, 94th, 78th, 113th, 137th, 153rd, 131st, 83rd, 35th, 27th, 43rd, 75th, 85th, 45th, 13th, 5th, 21st, 69th, 133rd, 143rd, 127th, 95th, 79th, 116th, 140th, 156th, 130th, 82nd, 34th, 26th, 42nd, 74th, and 88th, respectively;

(19) the pixels of the first to fortieth columns which form the nineteenth row of the rectangular pattern are turned on 104th, 64th, 32nd, 56th, 120th, 152nd, 158th, 145th, 105th, 57th, 65th, 97th, 121st, 111th, 39th, 11th, 3rd, 19th, 51st, 91st, 101st, 61st, 29th, 53rd, 117th, 149th, 159th, 148th, 108th, 60th, 68th, 100th, 124th, 110th, 38th, 10th, 2nd, 18th, 50th, and 90th, respectively;

(20) the pixels of the first to fortieth columns which form the twentieth row of the rectangular pattern are turned on 144th, 128th, 96th, 80th, 115th, 139th, 155th, 129th, 81st, 33rd, 25th, 41st, 73rd, 87th, 47th, 15th, 7th, 23rd, 71st, 135th, 141st, 125th, 93rd, 77th, 114th, 138th, 154th, 132nd, 84th, 36th, 28th, 44th, 76th, 86th, 46th, 14th, 6th, 22nd, 70th, and 134th, respectively;

(21) the pixels of the first to fortieth columns which form the twenty-first row of the rectangular pattern are turned on 160th, 147th, 107th, 59th, 67th, 99th, 123rd, 109th, 37th, 9th, 1st, 17th, 49th, 89th, 103rd, 63rd, 31st, 55th, 119th, 151st, 157th, 146th, 106th, 58th, 66th, 98th, 122nd, 112th, 40th, 12th, 4th, 20th, 52nd, 92nd, 102nd, 62nd, 30th, 54th, 118th, and 150th, respectively;

(22) the pixels of the first to fortieth columns which form the twenty-second row of the rectangular pattern are turned on 153rd, 131st, 83rd, 35th, 27th, 43rd, 75th, 85th, 45th, 13th, 5th, 21st, 69th, 133rd, 143rd, 127th, 95th, 79th, 116th, 140th, 156th, 130th, 82nd, 34th, 26th, 42nd, 74th, 88th, 48th, 16th, 8th, 24th, 72nd, 136th, 142nd, 126th, 94th, 78th, 113th, and 137th, respectively;

(23) the pixels of the first to fortieth columns which form the twenty-third row of the rectangular pattern are turned on 121st, 111th, 39th, 11th, 3rd, 19th, 51st, 91st, 101st, 61st, 29th, 53rd, 117th, 149th, 159th, 148th, 108th, 60th, 68th, 100th, 124th, 110th, 38th, 10th, 2nd, 18th, 50th, 90th, 104th, 64th, 32nd, 56th, 120th, 152nd, 158th, 145th, 105th, 57th, 65th, and 97th, respectively;

(24) the pixels of the first to fortieth columns which form the twenty-fourth row of the rectangular pattern are turned on 73rd, 87th, 47th, 15th, 7th, 23rd, 71st, 135th, 141st, 125th, 93rd, 77th, 114th, 138th, 154th, 132nd, 84th, 36th, 28th, 44th, 76th, 86th, 46th, 14th, 6th, 22nd, 70th, 134th, 144th, 128th, 96th, 80th, 115th, 139th, 155th, 129th, 81st, 33rd, 25th, and 41st, respectively;

(25) the pixels of the first to fortieth columns which form the twenty-fifth row of the rectangular pattern are turned on 49th, 89th, 103rd, 63rd, 31st, 55th, 119th, 151st, 157th, 146th, 106th, 58th, 66th, 98th, 122nd, 112th, 40th, 12th, 4th, 20th, 52nd, 92nd, 102nd, 62nd, 30th, 54th, 118th, 150th, 160th, 147th, 107th, 59th, 67th, 99th, 123rd, 109th, 37th, 9th, 1st, and 17th, respectively;

(26) the pixels of the first to fortieth columns which form the twenty-sixth row of the rectangular pattern are turned on 69th, 133rd, 143rd, 127th, 95th, 79th, 116th, 140th, 156th, 130th, 82nd, 34th, 26th, 42nd, 74th, 88th, 48th, 16th, 8th, 24th, 72nd, 136th, 142nd, 126th, 94th, 78th, 113th, 137th, 153rd, 131st, 83rd, 35th, 27th, 43rd, 75th, 85th, 45th, 13th, 5th, and 21st, respectively;

(27) the pixels of the first to fortieth columns which form the twenty-seventh row of the rectangular pattern are turned on 117th, 149th, 159th, 148th, 108th, 60th, 68th, 100th, 124th, 110th, 38th, 10th, 2nd, 18th, 50th, 90th, 104th, 64th, 32nd, 56th, 120th, 152nd, 158th, 145th, 105th, 57th, 65th, 97th, 121st, 111th, 39th, 11th, 3rd, 19th, 51st, 91st, 101st, 61st, 29th, and 53rd, respectively;

(28) the pixels of the first to fortieth columns which form the twenty-eighth row of the rectangular pattern are turned on 114th, 138th, 154th, 132nd, 84th, 36th, 28th, 44th,76th, 86th, 46th, 14th, 6th, 22nd, 70th, 134th, 144th, 128th, 96th, 80th, 115th, 139th, 155th, 129th, 81st, 33rd, 25th, 41st, 73rd, 87th, 47th, 15th, 7th, 23rd, 71st, 135th, 141st, 125th, 93rd, and 77th, respectively;

(29) the pixels of the first to fortieth columns which form the twenty-ninth row of the rectangular pattern are turned on 66th, 98th, 122nd, 112th, 40th, 12th, 4th, 20th, 52nd, 92nd, 102nd, 62nd, 30th, 54th, 118th, 150th, 160th, 147th, 107th, 59th, 67th, 99th, 123rd, 109th, 37th, 9th, 1st, 17th, 49th, 89th, 103rd, 63rd, 31st, 55th, 119th, 151st, 157th, 146th, 106th, and 58th, respectively;

(30) the pixels of the first to fortieth columns which form the thirtieth row of the rectangular pattern are turned on 26th, 42nd, 74th, 88th, 48th, 16th, 8th, 24th, 72nd, 136th, 142nd, 126th, 94th, 78th, 113th, 137th, 153rd, 131st, 83rd, 35th, 27th, 43rd, 75th, 85th, 45th, 13th, 5th, 21st, 69th, 133rd, 143rd, 127th, 95th, 79th, 116th, 140th, 156th, 130th, 82nd, and 34th, respectively;

(31) the pixels of the first to fortieth columns which form the thirty-first row of the rectangular pattern are turned on 2nd, 18th, 50th, 90th, 104th, 64th, 32nd, 56th, 120th, 152nd, 158th, 145th, 105th, 57th, 65th, 97th, 121st, 111th, 39th, 11th, 3rd, 19th, 51st, 91st, 101st, 61st, 29th, 53rd, 117th, 149th, 159th, 148th, 108th, 60th, 68th, 100th, 124th, 110th, 38th, and 10th, respectively;

(32) the pixels of the first to fortieth columns which form the thirty-second row of the rectangular pattern are turned on 6th, 22nd, 70th, 134th, 144th, 128th, 96th, 80th, 115th, 139th, 155th, 129th, 81st, 33rd, 25th, 41st, 73rd, 87th, 47th, 15th, 7th, 23rd, 71st, 135th, 141st, 125th, 93rd, 77th, 114th, 138th, 154th, 132nd, 84th, 36th, 28th, 44th, 76th, 86th, 46th, and 14th, respectively;

(33) the pixels of the first to fortieth columns which form the thirty-third row of the rectangular pattern are turned on 30th, 54th, 118th, 150th, 160th, 147th, 107th, 59th, 67th, 99th, 123rd, 109th, 37th, 9th, 1st, 17th, 49th, 89th, 103rd, 63rd, 31st, 55th, 119th, 151st, 157th, 146th, 106th, 58th, 66th, 98th, 122nd, 112th, 40th, 12th, 4th, 20th, 52nd, 92nd, 102nd, and 62nd, respectively;

(34) the pixels of the first to fortieth columns which form the thirty-fourth row of the rectangular pattern are turned on 94th, 78th, 113th, 137th, 153rd, 131st, 83rd, 35th, 27th, 43rd, 75th, 85th, 45th, 13th, 5th, 21st, 69th, 133rd, 143rd, 127th, 95th, 79th, 116th, 140th, 156th, 130th, 82nd, 34th, 26th, 42nd, 74th, 88th, 48th, 16th, 8th, 24th, 72nd, 136th, 142nd, and 126th, respectively;

(35) the pixels of the first to fortieth columns which form the thirty-fifth row of the rectangular pattern are turned on 105th, 57th, 65th, 97th, 121st, 111th, 39th, 11th, 3rd, 19th, 51st, 91st, 101st, 61st, 29th, 53rd, 117th, 149th, 159th, 148th, 108th, 60th, 68th, 100th, 124th, 110th, 38th, 10th, 2nd, 18th, 50th, 90th, 104th, 64th, 32nd, 56th, 120th, 152nd, 158th, and 145th, respectively;

(36) the pixels of the first to fortieth columns which form the thirty-sixth row of the rectangular pattern are turned on 81st, 33rd, 25th, 41st, 73rd, 87th, 47th, 15th, 7th, 23rd, 71st, 135th, 141st, 125th, 93rd, 77th, 114th, 138th, 154th, 132nd, 84th, 36th, 28th, 44th, 76th, 86th, 46th, 14th, 6th, 22nd, 70th, 134th, 144th, 128th, 96th, 80th, 115th, 139th, 155th, and 129th, respectively;

(37) the pixels of the first to fortieth columns which form the thirty-seventh row of the rectangular pattern are turned on 37th, 9th, 1st, 17th, 49th, 89th, 103rd, 63rd, 31st, 55th, 119th, 151st, 157th, 146th, 106th, 58th, 66th, 98th, 122nd, 112th, 40th, 12th, 4th, 20th, 52nd, 92nd, 102nd, 62nd, 30th, 54th, 118th, 150th, 160th, 147th, 107th, 59th, 67th, 99th, 123rd, and 109th, respectively;

(38) the pixels of the first to fortieth columns which form the thirty-eighth row of the rectangular pattern are turned on 45th, 13th, 5th, 21st, 69th, 133rd, 143rd, 127th, 95th, 79th, 116th, 140th, 156th, 130th, 82nd, 34th, 26th, 42nd, 74th, 88th, 48th, 16th, 8th, 24th, 72nd, 136th, 142nd, 126th, 94th, 78th, 113th, 137th, 153rd, 131st, 83rd, 35th, 27th, 43rd, 75th, and 85th, respectively;

(39) the pixels of the first to fortieth columns which form the thirty-ninth row of the rectangular pattern are turned on 101st, 61st, 29th, 53rd, 117th, 149th, 159th, 148th, 108th, 60th, 68th, 100th, 124th, 110th, 38th, 10th, 2nd, 18th, 50th, 90th, 104th, 64th, 32nd, 56th, 120th, 152nd, 158th, 145th, 105th, 57th, 65th, 97th, 121st, 111th, 39th, 11th, 3rd, 19th, 51st, and 91st, respectively; and

(40) the pixels of the first to fortieth columns which form the fortieth row of the rectangular pattern are turned on 141st, 125th, 93rd, 77th, 114th, 138th, 154th, 132nd, 84th, 36th, 28th, 44th, 76th, 86th, 46th, 14th, 6th, 22nd, 70th, 134th, 144th, 128th, 96th, 80th, 115th, 139th, 155th, 129th, 81st, 33rd, 25th, 41st, 73rd, 87th, 47th, 15th, 7th, 23rd, 71st, and 135th, respectively.

Further, the turn-on order of the pixels is set so that dots having shapes same as each other individually grow in order from a plurality of points.

Further, similarly to the binarization pattern 12i, also the binarization pattern 12j is a binarization pattern having a dither angle (screen angle, half tone angle) of 18.4 degrees and an output line number of 94.9 lpi.

It is to be noted that, by using the binarization pattern 12j, the pixel value (for example, within a range from 0 to 255) of each of pixels which form a multi-value image (original image) to be printed can be represented in one hundred sixty-one stages (gradations).

Also where any of such binarization patterns 12b to 12j as described above is used, processes similar to those of the technique performed using the binarization pattern 12a described hereinabove are performed. In particular, the dot data production section 14 selects those pixels ranging from a starting pixel of a turn-on order to another pixel to which a predetermined turn-on order number is set in any of the binarization patterns 12b to 12j in accordance with the turn-on order to decide picture elements on which a color material is to be formed, and then produces dot data. Thereafter, the image forming section 15 forms (prints) an image in accordance with the produced dot data (an image forming step).

In other words, whichever one of the binarization patterns 12a, 12b, 12c, 12d, 12e, 12f, 12g, 12h, 12i and 12j is used as the binarization dither matrix pattern, the printing method (printing apparatus, printing program, binarization program, and computer-readable recording medium on which the printing program and/or binarization program are recorded) of the present invention can be implemented.

Even where any of the binarization patterns 12a, 12b, 12c, 12d, 12e, 12f, 12g, 12h, 12i and 12j is used, similar action and effects to those where the binarization pattern 12a described hereinabove is used can be anticipated. It is to be noted that, also in the binarization patterns 12a, 12b, 12c, 12d, 12e, 12f, 12g, 12h, 12i and 12j, an angle near to 15 degrees, that is, one of 14.0 degrees, 18.4 degrees, 11.3 degrees and 9.5 degrees, is exhibited as the dither angle. Therefore, from a mechanical characteristic (such as, for example, expansion and contraction of an elastic member used for a printing engine) of the printing apparatus 3, stripe patterns, moirés and so forth which appear on a printed matter and do not exist on an original image can be made less conspicuous.

Further, while, in the binarization patterns 12a to 12j described above, a color material is fixed to pixels in order from a pixel having a low turn-on order number to another pixel having a higher turn-on order number, the turn-on order is not limited to this, and alternatively, the turn-on order may be set reversely to that for any of the binarization patterns 12a to 12j such that a color material is fixed to pixels in order from a pixel having a high turn-on order number to another pixel having a lower turn-on order number.

Furthermore, the color calculation section 10, image signal memory 11, gradation characteristic changing section 13, pattern memory 12 and dot data production section 14 described hereinabove may be provided outside the printing apparatus 3 in the present printing system 1 (such as, for example, another apparatus (not shown) connected to the PC 2 or the printing apparatus 3). A CPU or a like element (computer) of the PC 2 or the printing apparatus 3 may execute a program (including a program for producing the binarization patterns 12a to 12j) so that a function of at least one of the color calculation section 10, image signal memory 11, gradation characteristic changing section 13, pattern memory 12 and dot data production section 14 may be implemented.

Further, the values of m and n in the binarization patterns 12b, 12d, 12f, 12h and 12j described above are not limited to those of the modifications described hereinabove, and various values may be used without departing from the scope of the present invention. Preferably, a square number is used particularly for m.

It is to be noted that, where the embodiment of the present invention and the modifications to the embodiment are disclosed, those skilled in the art could produce the apparatus of the present invention and could carry out the method of the present invention.

The present invention is not limited to the embodiment specifically described above, and variations and modifications can be made without departing from the scope of the present invention.

What is claimed is:

1. A printing method, comprising:
an expanding step of expanding a multi-value image in a storage area; and
an image forming step of binarizing the multi-value image expanded in said storage area based on a binarization dither matrix pattern and forming an image based on a result of the binarization; and wherein
the binarization dither matrix pattern is configured as a rectangular pattern wherein a plurality of pixels to be turned on successively are arranged in a matrix, and the rectangular pattern includes a plurality of basic patterns formed such that, in a partly lacking matrix having four rows and three columns, the pixels of the first to third columns which form the first row of the partly lacking matrix are turned on seventh, fifth, and ninth, respectively; the pixels of the first to third columns which form the second row of the partly lacking matrix are turned on fourth, first, and third, respectively; the pixels of the first to third columns which form the thi rd, row of the partly lacking matrix are turned on sixth, second and eighth, respectively; and the pixel of the first column which forms the fourth row of the partly lacking matrix is turned on tenth, and the turn-on order of the pixels is set so that dots having shapes same as each other individually grow in order from a plurality of points.

2. A printing method, comprising:
an expanding step of expanding a multi-value image in a storage area; and
an image forming step of binarizing the multi-value image expanded in said storage area based on a binarization dither matrix pattern and forming an image based on a result of the binarization; and wherein
the binarization dither matrix pattern is configured as a rectangular pattern wherein a plurality of pixels to be turned on successively are arranged in a matrix, and the rectangular pattern includes a plurality of sub patterns formed by arranging m basic patterns formed such that, in a partly lacking matrix having four rows and three columns, the pixels of the first to third columns which form the first row of the partly lacking matrix are turned on n+6×mth, n+4×mth, and n+8×mth, respectively; the pixels of the first to third columns which form the second row of the partly lacking matrix turned on n+3×mth, nth, and n+2×mth, respectively; the pixels of the first to thi rd, columns which form the third row of the partly lacking matrix are turned on n+5×mth, n+mth, and n+7×mth, respectively; and the pixel of the first column which forms the fourth row of the partly lacking matrix is turned on n+9×mth, m and n being arbitrary natural numbers, and the turn-on order of the pixels is set so that dots having shapes same as each other individually grow in order based on said plurality of sub patterns.

3. A printing method, comprising:
an expanding step of expanding a multi-value image in a storage area; and
an image forming step of binarizing the multi-value image expanded in said storage area based on a binarization dither matrix pattern and forming an image based on a result of the binarization; and wherein
the binarization dither matrix pattern is configured as a rectangular pattern wherein a plurality of pixels to be turned on successively are arranged in a matrix, and the rectangular pattern includes a plurality of basic patterns formed such that, in a partly lacking matrix having five rows and four columns, the pixels of the first to fourth columns which form the first row of the partly lacking matrix are turned on 14th, 6th, 12th, and 16th, respectively; the pixels of the first to fourth columns which form the second row of the partly lacking matrix are turned on 10th, 2nd, 4th, and 8th, respectively; the pixels of the first to fourth columns which form the thi rd, row of the partly lacking matrix are turned on 5th, 1st, 3rd, and 11th, respectively; the pixels of the first to fourth columns which form the fourth row of the partly lacking matrix are turned on 13th, 9th, 7th, and 15th, respectively; and the pixel of the first column which forms the fifth row of the partly lacking matrix is turned on 17th, and the turn-on order of the pixels is set so that dots having shapes same as each other individually grow in order from a plurality of points.

4. A printing method, comprising:
an expanding step of expanding a multi-value image in a storage area; and
an image forming step of binarizing the multi-value image expanded in said storage area based on a binarization dither matrix pattern and forming an image based on a result of the binarization; and wherein
the binarization dither matrix pattern is configured as a rectangular pattern wherein a plurality of pixels to be turned on successively are arranged in a matrix, and the rectangular pattern includes a plurality of sub patterns formed by arranging m basic patterns formed such that, in a partly lacking matrix having five rows and four columns, the pixels of the first to fourth column which form the first row of the partly lacking matrix are turned on n+13×mth, n+5×mth, n+11×mth, and n+15×mth, respectively; the pixels of the first to fourth columns which form the second row of the partly lacking matrix are turned on n+9×mth, n+mth, n+3×mth, and n+7×mth, respectively; the pixels of the first to fourth columns which form the third row of the partly lacking matrix are turned on n+4×mth, nth, n+2×mth, and n+10×mth, respectively; the pixels of the first to fourth columns which form the fourth row of the partly lacking matrix are turned on n+12×mth, n+8×mth, n+6×mth, and n+14×mth, respectively; and the pixel of the first column which forms the fifth row of the partly lacking matrix is turned on n+16×mth, m and n being arbitrary natural numbers, and the turn-on order of the pixels is set so that dots having shapes same as each other individually grow in order based on said plurality of sub patterns.

5. A printing method, comprising:
an expanding step of expanding a multi-value image in a storage area; and
an image forming step of binarizing the multi-value image expanded in said storage area based on a binarization dither matrix pattern and forming an image based on a result of the binarization; and wherein
the binarization dither matrix pattern is configured as a rectangular pattern wherein a plurality of pixels to be turned on successively are arranged in a matrix, and the rectangular pattern includes a plurality of basic patterns formed such that, in a partly lacking matrix having six rows and five columns, the pixels of the first to fifth columns which form the first row of the partly lacking matrix are turned on 23rd, 15th, 13th, 21st, and 25th, respectively; the pixels of the first to fifth columns which form the second row of the partly lacking matrix are turned on 19th, 7th, 5th, 9th, and 17th, respectively; the pixels of the first to fifth columns which form the third row of the partly lacking matrix are turned on 12th, 4th, 1st, 3rd, and 11th, respectively; the pixels of the first to fifth columns which form the fourth row of the partly lacking matrix are turned on 14th, 6th, 2nd, 8th, and 20th, respectively; the pixels of the first to fifth columns which form the fifth row of the partly lacking matrix are turned on 22nd, 18th, 10th, 16th, and 24th, respectively; and the pixel of the first column which forms the sixth row of the partly lacking matrix is turned on 26th, and the turn-on order of the pixels is set so that dots having shapes same as each other individually grow in order from a plurality of points.

6. A printing method, comprising:
an expanding step of expanding a multi-value image in a storage area; and
an image forming step of binarizing the multi-value image expanded in said storage area based on a binarization dither matrix pattern and forming an image based on a result of the binarization; and wherein
the binarization dither matrix pattern is configured as a rectangular pattern wherein a plurality of pixels to be turned on successively are arranged in a matrix, and the rectangular pattern includes a plurality of sub patterns formed by arranging m basic patterns formed such that, in a partly lacking matrix having six rows and five columns, the pixels of the first to fifth columns which form the first row of the partly lacking matrix are turned on n+22×mth, n+14×mth, n+12×mth, n+20×mth, and n+24×mth, respectively; the pixels of the first to fifth columns which form the second row of the partly lacking matrix are turned on n+18×mth, n+6×mth, n+4×mth, n+8×mth, and n+16×mth, respectively; the pixels of the first to fifth columns which form the third row of the partly lacking matrix are turned on n+11×mth, n+3×mth, nth, n+2×mth, and n+10×mth, respectively; the pixels of the first to fifth columns which form the fourth row of the partly lacking matrix are turned on n+13×mth, n+5×mth, n+mth, n+7×mth, and n+19×mth, respectively; the pixels of the first to fifth columns which form the fifth row of the partly lacking matrix are turned on n+21×mth, n+17×mth, n+9×mth, n+15×mth, and n+23×mth, respectively; and the pixel of the first column which forms the sixth row of the partly lacking matrix is turned on n+25×mth, m and n being arbitrary natural numbers, and the turn-on order of the pixels is set so that dots having shapes same as each other individually grow in order based on said plurality of sub patterns.

7. A printing method, comprising:
an expanding step of expanding a multi-value image in a storage area; and
an image forming step of binarizing the multi-value image expanded in said storage area based on a binarization dither matrix pattern and forming an image based on a result of the binarization; and wherein
the binarization dither matrix pattern is configured as a rectangular pattern wherein a plurality of pixels to be turned on successively are arranged in a matrix, and the rectangular pattern includes a plurality of basic patterns formed such that, in a partly lacking matrix having seven rows and six columns, the pixels of the first to sixth columns which form the first row of the partly lacking matrix are turned on 34th, 26th, 14th, 24th, 32nd, and 36th, respectively; the pixels of the first to sixth columns which form the second row of the partly lacking matrix are turned on 30th, 16th, 8th, 12th, 20th, and 28th, respectively; the pixels of the first to sixth columns which form the third row of the partly lacking matrix are turned on 22nd, 6th, 2nd, 4th, 10th, and 18th, respectively; the pixels of the first to sixth columns which form the fourth row of the partly lacking matrix are turned on 15th, 5th, 1st, 3rd, 11th, and 23rd, respectively; the pixels of the first to sixth columns which form the fifth row of the partly lacking matrix are turned on 25th, 13th, 7th, 9th, 19th, and 31st, respectively; the pixels of the first to sixth columns which form the sixth row of the partly lacking matrix are turned on 33rd, 29th, 21st, 17th, 27th, and 35th, respectively; and the pixel of the first column which forms the seventh row is turned on 37th, and the turn-on order of the pixels is set so that dots having shapes same as each other individually grow in order from a plurality of points.

8. A printing method, comprising:
an expanding step of expanding a multi-value image in a storage area; and
an image forming step of binarizing the multi-value image expanded in said storage area based on a binarization dither matrix pattern and forming an image based on a result of the binarization; and wherein
the binarization dither matrix pattern is configured as a rectangular pattern wherein a plurality of pixels to be turned on successively are arranged in a matrix, and the rectangular pattern includes a plurality of sub patterns formed by arranging m basic patterns formed such that, in a partly lacking matrix having seven rows and six columns, the pixels of the first to sixth columns which form the first row of the partly lacking matrix are turned on n+33×mth, n+25×mth, n+13×mth, n+23×mth, n+31×mth, and n+35×mth, respectively; the pixels of the first to sixth columns which form the second row of the partly lacking matrix are turned on n+29×mth, n+15×mth, n+7×mth, n+11×mth, n+19×mth, and n+27×mth, respectively; the pixels of the first to sixth columns which form the third row of the partly lacking matrix are turned on n+21×mth, n+5×mth, n+mth, n+3×mth, n+9×mth, and n+17×mth, respectively; the pixels of the first to sixth columns which form the fourth row of the partly lacking matrix are turned on n+14×mth, n+4×mth, nth, n+2×mth, n+10×mth, and n+22×mth, respectively; the pixels of the first to sixth columns which form the fifth row of the partly lacking matrix are turned on n+24×mth, n+12×mth, n+6×mth, n+8×mth, n+18×mth, and n+30×mth, respectively; the pixels of the first to sixth columns which form the sixth row of the partly lacking matrix are turned on n+32×mth, n+28×mth, n+20×mth, n+16×mth, n+26×mth, and n+34×mth, respectively; and the pixel of the first column which forms the seventh row of the partly lacking matrix is turned on n+36×mth, m and n being arbitrary natural numbers, and the turn-on order of the pixels is set so that dots having shapes same as each other individually grow in order based on said plurality of sub patterns.

9. A printing method, comprising:
an expanding step of expanding a multi-value image in a storage area; and
an image forming step of binarizing the multi-value image expanded in said storage area based on a binarization dither matrix pattern and forming an image based on a result of the binarization; and wherein
the binarization dither matrix pattern is configured as a rectangular pattern wherein a plurality of pixels to be turned on successively are arranged in a matrix, and the rectangular pattern includes a plurality of basic patterns formed such that, in a partly lacking matrix having eight rows and seven columns, the pixels of the fourth to sixth columns which form the first row of the partly lacking matrix are turned on 29th, 35th, and 39th, respectively; the pixels of the first to sixth columns which form the second row of the partly lacking matrix are turned on 37th, 27th, 15th, 17th, 25th, and 31st, respectively; the pixels of the first to sixth columns which form the third row of the partly lacking matrix are turned on 33rd, 21st, 9th, 7th, 11th, and 19th, respectively; the pixels of the first to seventh columns which form the fourth row of the partly lacking matrix are turned on 28th, 10th, 3rd, 1st, 5th, 13th, and 23rd, respectively; the pixels of the first to seventh columns which form the fifth row of the partly lacking matrix are turned on 22nd, 12th, 4th, 2nd, 6th, 18th, and 34th, respectively; the pixels of the second to seventh columns which form the sixth row of the partly lacking matrix are turned on 26th, 16th, 8th, 14th, 30th, and 38th, respectively; the pixels of the second to fifth columns which form the seventh row of the partly lacking matrix are turned on 36th, 32nd, 24th, and 20th, respectively; and the pixel of the second column which forms the eighth row of the partly lacking matrix is turned on 40th, and the turn-on order of the pixels is set so that dots having shapes same as each other individually grow in order from a plurality of points.

10. A printing method, comprising:
an expanding step of expanding a multi-value image in a storage area; and
an image forming step of binarizing the multi-value image expanded in said storage area based on a binarization dither matrix pattern and forming an image based on a result of the binarization; and wherein
the binarization dither matrix pattern is configured as a rectangular pattern wherein a plurality of pixels to be turned on successively are arranged in a matrix, and the rectangular pattern includes a plurality of sub patterns formed by arranging m basic patterns formed such that, in a partly lacking matrix having eight rows and seven columns, the pixels of the fourth to sixth columns which form the first row of the partly lacking matrix are turned on n+28×mth, n+34×mth, and n+38×mth, respectively; the pixels of the first to sixth columns which form the second row of the partly lacking matrix are turned on n+36×mth, n+26×mth, n+14×mth, n+16×mth, n+24×mth, and n+30×mth, respectively; the pixels of the first to sixth columns which form the third row of the partly lacking matrix are turned on n+32×mth, n+20×mth, n+8×mth, n+6×mth, n+10×mth, and n+18×mth, respectively; the pixels of the first to seventh columns which form the fourth row of the partly lacking matrix are turned on n+27×mth, n+9×mth, n+2×mth, nth, n+4×mth, n+12×mth, and n+22×mth, respectively; the pixels of the first to seventh columns which form the fifth row of the partly lacking matrix are turned on n+21×mth, n+11×mth, n+3×mth, n+mth, n+5×mth, n+17×mth, and n+33×mth, respectively; the pixels of the second to seventh columns which form the sixth row of the partly lacking matrix are turned on n+25×mth, n+15×mth, n+7×mth, n+13×mth, n+29×mth, and n+37×mth, respectively; the pixels of the second to fifth columns which form the seventh row of the partly lacking matrix are turned on n+35×mth, n+31×mth, n+23×mth, and n+19×mth, respectively; and the pixel of the second column which forms the eighth row of the partly lacking matrix is turned on n+39×mth, m and n being arbitrary natural numbers, and the turn-on order of the pixels is set so that dots having shapes same as each other individually grow in order based on said plurality of sub patterns.

11. A printing method, comprising:
a step of preparing a binarization dither matrix pattern which is formed as a rectangular pattern wherein a plurality of pixels to be turned on successively are arranged in a matrix, the rectangular pattern including a plurality of basic patterns formed such that, in a partly lacking matrix having four rows and three columns, the pixels of the first to third columns which form the first row of the partly lacking matrix are turned on 7th, 5th, and 9th, respectively; the pixels of the first to thi rd, columns which form the second row of the partly lacking matrix are turned on 4th, 1st, and 3rd, respectively; the pixels of the first to third columns which form the thi rd, row of the partly lacking matrix are turned on 6th, 2nd, and 8th, respectively; and the pixel of the first column which forms the fourth row of the partly lacking matrix is turned on 10th, the turn-on order of the pixels being set so that dots having shapes same as each other individually grow from a plurality of points; and
an image forming step of selecting the pixels from the starting pixel in the turn-on order to the pixel to which a predetermined turn-on order number is set in the binarization dither matrix pattern in accordance with the turn-on order based on a pixel value of an inputted multi-value image to determine the pixels on which a color material is to be formed and forming the color material on the determined pixels to form an image.

12. A printing method, comprising:
a step of preparing a binarization dither matrix pattern which is formed as a rectangular pattern wherein a plurality of pixels to be turned on successively are arranged in a matrix, the rectangular pattern including a plurality of sub patterns formed by arranging m basic patterns formed such that, in a partly lacking matrix having four rows and three columns, the pixels of the first to third columns which form the first row of the partly lacking matrix are turned on n+6×mth, n+4×mth, and n+8×mth, respectively; the pixels of the first to third columns which form the second row of the partly lacking matrix are turned on n+3×mth, nth, and n+2×mth, respectively; the pixels of the first to third columns which form the third row of the partly lacking matrix are turned on n+5×mth, n+mth, and n+7×mth, respectively; and the pixel of the first column which forms the four throw of the partly lacking matrix is turned on n+9×mth, m and n being arbitrary natural numbers, the turn-on order of the pixels being set so that dots having shapes same as each other individually grow from a plurality of points; and
an image forming step of selecting the pixels from the starting pixel in the turn-on order to the pixel to which a predetermined turn-on order number is set in the binarization dither matrix pattern in accordance with the turn-on order based on a pixel value of an inputted multi-value image to determine the pixels on which a color material is to be formed and forming the color material on the determined pixels to form an image.

13. A printing method, comprising:
a step of preparing a binarization dither matrix pattern which is formed as a rectangular pattern wherein a plurality of pixels to be turned on successively are arranged in a matrix, the rectangular pattern including a plurality of basic patterns formed such that, in a partly lacking matrix having five rows and four columns, the pixels of the first to fourth columns which form the first row of the partly lacking matrix are turned on 14th, 6th, 12th, and 16th, respectively; the pixels of the first to fourth columns which form the second row of the partly lacking matrix are turned on 10th, 2nd, 4th, and 8th, respectively; the pixels of the first to fourth columns which form the third row of the partly lacking matrix are turned on 5th, 1st, 3rd, and 11th, respectively; the pixels of the first to fourth columns which form the fourth row of the partly lacking matrix are turned on 13th, 9th, 7th, and 15th, respectively; and the pixel of the first column which forms the fifth row of the partly lacking matrix is turned on 17th, the turn-on order of the pixels being set so that dots having shapes same as each other individually grow from a plurality of points; and
an image forming step of selecting the pixels from the starting pixel in the turn-on order to the pixel to which a predetermined turn-on order number is set in the binarization dither matrix pattern in accordance with the turn-on order based on a pixel value of an inputted multi-value image to determine the pixels on which a color material is to be formed and forming the color material on the determined pixels to form an image.

14. A printing method, comprising:
a step of preparing a binarization dither matrix pattern which is formed as a rectangular pattern wherein a plurality of pixels to be turned on successively are arranged in a matrix, the rectangular pattern including a plurality of sub patterns formed by arranging m basic patterns formed such that, in a partly lacking matrix having five rows and four columns, the pixels of the first to fourth columns which form the first row of the partly lacking matrix are turned on n+13×mth, n+5×mth, n+11×mth, and n+15×mth, respectively; the pixels of the first to fourth columns which form the second row of the partly lacking matrix are turned on n+9×mth, n+mth, n+3×mth, and n+7×mth, respectively; the pixels of the first to fourth columns which form the third row of the partly lacking matrix are turned on n+4×mth, nth, n+2×mth, and n+10×mth, respectively; the pixels of the first to fourth columns which form the fourth row of the partly lacking matrix are turned on n+12×mth, n+8×mth, n+6×mth, and n+14×mth, respectively; and the pixel of the first column which forms the fifth row of the partly lacking matrix is turned on n+16×mth, m and n being arbitrary natural numbers, the turn-on order of the pixels being set so that dots having shapes same as each other individually grow from a plurality of points; and
an image forming step of selecting the pixels from the starting pixel in the turn-on order to the pixel to which a predetermined turn-on order number is set in the binarization dither matrix pattern in accordance with the turn-on order based on a pixel value of an inputted multi-value image to determine the pixels on which a color material is to be formed and forming the color material on the determined pixels to form an image.

15. A printing method, comprising:
a step of preparing a binarization dither matrix pattern which is formed as a rectangular pattern wherein a plurality of pixels to be turned on successively are arranged in a matrix, the rectangular pattern including a plurality of basic patterns formed such that, in a partly lacking matrix having six rows and five columns, the pixels of the first to fifth columns which form the first row of the partly lacking matrix are turned on 23rd, 15th, 13th, 21st, and 25th, respectively; the pixels of the first to fifth columns which form the second row of the partly lacking matrix are turned on 19th, 7th, 5th, 9th, and 17th, respectively; the pixels of the first to fifth columns which form the third row of the partly lacking matrix are turned on 12th, 4th, 1st, 3rd, and 11th, respectively; the pixels of the first to fifth columns which form the fourth row of the partly lacking matrix are turned on 14th, 6th, 2nd, 8th, and 20th, respectively; the pixels of the first to fifth columns which form the fifth row of the partly lacking matrix are turned on 22nd, 18th, 10th, 16th, and 24th, respectively; and the pixel of the first column which forms the sixth row of the partly lacking matrix is turned on 26th, the turn-on order of the pixels being set so that dots having shapes same as each other individually grow from a plurality of points; and
an image forming step of selecting the pixels from the starting pixel in the turn-on order to the pixel to which a predetermined turn-on order number is set in the binarization dither matrix pattern in accordance with the turn-on order based on a pixel value of an inputted multi-value image to determine the pixels on which a color material is to be formed and forming the color material on the determined pixels to form an image.

16. A printing method, comprising:
a step of preparing a binarization dither matrix pattern which is formed as a rectangular pattern wherein a plurality of pixels to be turned on successively are arranged in a matrix, the rectangular pattern including a plurality of sub patterns formed by arranging m basic patterns formed such that, in a partly lacking matrix having six rows and five columns, the pixels of the first to fifth columns which form the first row of the partly lacking matrix are turned on n+22×mth, n+14×mth, n+12×mth, n+20×mth, and n+24×mth, respectively; the pixels of the first to fifth columns which form the second row of the partly lacking matrix are turned on n+18×mth, n+6×mth, n+4×mth, n+8×mth, and n+16×mth, respectively; the pixels of the first to fifth columns which form the third row of the partly lacking matrix are turned on n+11×mth, n+3×mth, nth, n+2×mth, and n+10×mth, respectively; the pixels of the first to fifth columns which form the fourth row of the partly lacking matrix are turned on n+13×mth, n+5×mth, n+mth, n+7×mth, and n+19×mth, respectively; the pixels of the first to fifth columns which form the fifth row of the partly lacking matrix are turned on n+21×mth, n+17×mth, n+9×mth, n+15×mth, and n+23×mth, respectively; and the pixel of the first column which forms the sixth row of the partly lacking matrix is turned on n+25×mth, m and n being arbitrary natural numbers, the turn-on order of the pixels being set so that dots having shapes same as each other individually grow from a plurality of points; and
an image forming step of selecting the pixels from the starting pixel in the turn-on order to the pixel to which a predetermined turn-on order number is set in the binarization dither matrix pattern in accordance with the turn-on order based on a pixel value of an inputted multi-value image to determine the pixels on which a color material is to be formed and forming the color material on the determined pixels to form an image.

17. A printing method, comprising:
a step of preparing a binarization dither matrix pattern which is formed as a rectangular pattern wherein a plurality of pixels to be turned on successively are arranged in a matrix, the rectangular pattern including a plurality of basic patterns formed such that, in a partly lacking matrix having seven rows and six columns, the pixels of the first to sixth columns which form the first row of the partly lacking matrix are turned on 34th, 26th, 14th, 24th, 32nd, and 36th, respectively; the pixels of the first to sixth columns which form the second row of the partly lacking matrix are turned on 30th, 16th, 8th, 12th, 20th, and 28th, respectively; the pixels of the first to sixth columns which form the third row of the partly lacking matrix are turned on 22nd, 6th, 2nd, 4th, 10th, and 18th, respectively; the pixels of the first to sixth columns which form the fourth row of the partly lacking matrix are turned on 15th, 5th, 1st, 3rd, 11th, and 23rd, respectively; the pixels of the first to sixth columns which form the fifth row of the partly lacking matrix are turned on 25th, 13th, 7th, 9th, 19th, and 31st, respectively; the pixels of the first to sixth columns which form the sixth row of the partly lacking matrix are turned on 33rd, 29th, 21st, 17th, 27th, and 35th, respectively; and the pixel of the first column which forms the seventh row of the partly lacking matrix is turned on 37th, the turn-on order of the pixels being set so that dots having shapes same as each other individually grow from a plurality of points; and
an image forming step of selecting the pixels from the starting pixel in the turn-on order to the pixel to which a predetermined turn-on order number is set in the binarization dither matrix pattern in accordance with the turn-on order based on a pixel value of an inputted multi-value image to determine the pixels on which a color material is to be formed and forming the color material on the determined pixels to form an image.

18. A printing method, comprising:
a step of preparing a binarization dither matrix pattern which is formed as a rectangular pattern wherein a plurality of pixels to be turned on successively are arranged in a matrix, the rectangular pattern including a plurality of sub patterns formed by arranging m basic patterns formed such that, in a partly lacking matrix having seven rows and six columns, the pixels of the first to sixth columns which form the first row of the partly lacking matrix are turned on n+33×mth, n+25×mth, n+13×mth, n+23×mth, n+31×mth, and n+35×mth, respectively; the pixels of the first to sixth columns which form the second row of the partly lacking matrix are turned on n+29×mth, n+15×mth, n+7×mth, n+11×mth, n+19×mth, and n+27×mth, respectively; the pixels of the first to sixth columns which form the third row of the partly lacking matrix are turned on n+21×mth, n+5×mth, n+mth, n+3×mth, n+9×mth, and n+17×mth, respectively; the pixels of the first to sixth columns which form the fourth row of the partly lacking matrix are turned on n+14×mth, n+4×mth, nth, n+2×mth, n+10×mth, and n+22×mth, respectively; the pixels of the first to sixth columns which form the fifth row of the partly lacking matrix are turned on n+24×mth, n+12×mth, n+6×mth, n+8×mth, n+18×mth, and n+30×mth, respectively; the pixels of the first to sixth columns which form the sixth row of the partly lacking matrix are turned on n+32×mth, n+28×mth, n+20×mth, n+16×mth, n+26×mth, and n+34×mth, respectively; and the pixel of the first column which forms the seventh row of the partly lacking matrix is turned on n+36×mth, m and n being arbitrary natural numbers, the turn-on order of the pixels being set so that dots having shapes same as each other individually grow from a plurality of points; and
an image forming step of selecting the pixels from the starting pixel in the turn-on order to the pixel to which a predetermined turn-on order number is set in the binarization dither matrix pattern in accordance with the turn-on order based on a pixel value of an inputted multi-value image to determine the pixels on which a color material is to be formed and forming the color material on the determined pixels to form an image.

19. A printing method, comprising:
a step of preparing a binarization dither matrix pattern which is formed as a rectangular pattern wherein a plurality of pixels to be turned on successively are arranged in a matrix, the rectangular pattern including a plurality of basic patterns formed such that, in a partly lacking matrix having eight rows and seven columns, the pixels of the fourth to sixth columns which form the first row of the partly lacking matrix are turned on 29th, 35th, and 39th, respectively; the pixels of the first to sixth columns which form the second row of the partly lacking matrix are turned on 37th, 27th, 15th, 17th, 25th, and 31st, respectively; the pixels of the first to sixth columns which form the third row of the partly lacking matrix are turned on 33rd, 21st, 9th, 7th, 11th, and 19th, respectively; the pixels of the first to seventh columns which form the fourth row of the partly lacking matrix are turned on 28th, 10th, 3rd, 1st, 5th, 13th, and 23rd, respectively; the pixels of the first to seventh columns which form the fifth row of the partly lacking matrix are turned on 22nd, 12th, 4th, 2nd, 6th, 18th, and 34th, respectively; the pixels of the second to seventh columns which form the sixth row of the partly lacking matrix are turned on 26th, 16th, 8th, 14th, 30th, and 38th, respectively; the pixels of the second to fifth columns which form the seventh row of the partly lacking matrix are turned on 36th, 32nd, 24th, and 20th, respectively; and the pixel of the second column which forms the eighth row of the partly lacking matrix is turned on 40th, the turn-on order of the pixels being set so that dots having shapes same as each other individually grow from a plurality of points; and
an image forming step of selecting the pixels from the starting pixel in the turn-on order to the pixel to which a predetermined turn-on order number is set in the binarization dither matrix pattern in accordance with the turn-on order based on a pixel value of an inputted multi-value image to determine the pixels on which a color material is to be formed and forming the color material on the determined pixels to form an image.

20. A printing method, comprising:
a step of preparing a binarization dither matrix pattern which is formed as a rectangular pattern wherein a plurality of pixels to be turned on successively are arranged in a matrix, the rectangular pattern including a plurality of sub patterns formed by arranging m basic patterns formed such that, in a partly lacking matrix having eight rows and seven columns, the pixels of the fourth to sixth columns which form the first row of the partly lacking matrix are turned on n+28×mth, n+34×mth, and n+38×mth, respectively; the pixels of the first to sixth columns which form the second row of the partly lacking matrix are turned on n+36×mth, n+26×mth, n+14×mth, n+16×mth, n+24×mth, and n+30×mth, respectively; the pixels of the first to sixth columns which form the third row of the partly lacking matrix are turned on n+32×mth, n+20×mth, n+8×mth, n+6×mth, n+10×mth, and n+18×mth, respectively; the pixels of the first to seventh columns which form the fourth row of the partly lacking matrix are turned on n+27×mth, n+9×mth, n+2×mth, nth, n+4×mth, n+12×mth, and n+22×mth, respectively; the pixels of the first to seventh columns which form the fifth row of the partly lacking matrix are turned on n+21×mth, n+11×mth, n+3×mth, n+mth, n+5×mth, n+17×mth, and n+33×mth, respectively; the pixels of the second to seventh columns which form the sixth row of the partly lacking matrix are turned on n+25×mth, n+15×mth, n+7×mth, n+13×mth, n+29×mth, and n+37×mth, respectively; the pixels of the second to fifth columns which form the seventh row of the partly lacking matrix are turned on n+35×mth, n+31×mth, n+23×mth, and n+19×mth, respectively; and the pixel of the second column which forms the eighth row of the partly lacking matrix is turned on n+39×mth, m and n being arbitrary natural numbers, the turn-on order of the pixels being set so that dots having shapes same as each other individually grow from a plurality of points; and
an image forming step of selecting the pixels from the starting pixel in the turn-on order to the pixel to which a predetermined turn-on order number is set in the binarization dither matrix pattern in accordance with the turn-on order based on a pixel value of an inputted multi-value image to determine the pixels on which a color material is to be formed and forming the color material on the determined pixels to form an image.

21. The printing method as claimed in claim 1, wherein, in the binarization dither matrix pattern, the rectangular pattern to which the turn-on order is set is turned 90 or 270 degrees.

22. The printing method as claimed in claim 1, wherein, in the binarization dither matrix pattern, the turn-on order number set to an arbitrary pixel in the rectangular pattern and the turn-on order number set to a pixel at a point symmetric to the pixel with respect to the center of the rectangular pattern are exchanged for each other.

23. A printing apparatus, comprising:
a storage area for expanding a multi-value image; and
an image forming section for binarizing the multi-value image expanded in said storage area using a binarization dither matrix pattern and forming an image based on a result of the binarization; and wherein
the binarization dither matrix pattern is configured as a rectangular pattern wherein a plurality of pixels to be turned on successively are arranged in a matrix, and the rectangular pattern includes a plurality of basic patterns formed such that, in a partly lacking matrix having four rows and three columns, the pixels of the first to third columns which form the first row of the partly lacking matrix are turned on 7th, 5th, and 9th, respectively; the pixels of the first to third columns which form the second row of the partly lacking matrix are turned on 4th, 1st, and 3rd, respectively; the pixels of the first to thi rd, columns which form the third row of the partly lacking matrix are turned on 6th, 2nd, and 8th, respectively; and the pixel of the first column which forms the fourth row of the partly lacking matrix is turned on 10th, and the turn-on order of the pixels is set so that dots having shapes same as each other individually grow in order from a plurality of points.

24. A printing apparatus, comprising:
a storage area for expanding a multi-value image; and
an image forming section for binarizing the multi-value image expanded in said storage area using a binarization dither matrix pattern and forming an image based on a result of the binarization; and wherein
the binarization dither matrix pattern is configured as a rectangular pattern wherein a plurality of pixels to be turned on successively are arranged in a matrix, and the rectangular pattern includes a plurality of sub patterns formed by arranging m basic patterns formed such that, in a partly lacking matrix having four rows and three columns, the pixels of the first to third columns which form the first row of the partly lacking matrix are turned on n+6×mth, n+4×mth, and n+8×mth, respectively; the pixels of the first to third columns which form the second row of the partly lacking matrix turned on n+3×mth, nth, and n+2×mth, respectively; the pixels of the first to thi rd, columns which form the third row of the partly lacking matrix are turned on n+5×mth, n+mth, and n+7×mth, respectively; and the pixel of the first column which forms the fourth row of the partly lacking matrix is turned on n+9×mth, m and n being arbitrary natural numbers, and the turn-on order of the pixels is set so that dots having shapes same as each other individually grow in order based on said plurality of sub patterns.

25. A printing apparatus, comprising:
a storage area for expanding a multi-value image; and
an image forming section for binarizing the multi-value image expanded in said storage area using a binarization dither matrix pattern and forming an image based on a result of the binarization; and wherein
the binarization dither matrix pattern is configured as a rectangular pattern wherein a plurality of pixels to be turned on successively are arranged in a matrix, and the rectangular pattern includes a plurality of basic patterns formed such that, in a partly lacking matrix having five rows and four columns, the pixels of the first to fourth columns which form the first row of the partly lacking matrix are turned on 14th, 6th, 12th, and 16th, respectively; the pixels of the first to fourth columns which form the second row of the partly lacking matrix are turned on 10th, 2nd, 4th, and 8th, respectively; the pixels of the first to fourth columns which form the thi rd, row of the partly lacking matrix are turned on 5th, 1st, 3rd, and 11th, respectively; the pixels of the first to fourth columns which form the fourth row of the partly lacking matrix are turned on 13th, 9th, 7th, and 15th, respectively; and the pixel of the first column which forms the fifth row of the partly lacking matrix is turned on 17th, and the turn-on order of the pixels is set so that dots having shapes same as each other individually grow in order from a plurality of points.

26. A printing apparatus, comprising:
a storage area for expanding a multi-value image; and
an image forming section for binarizing the multi-value image expanded in said storage area using a binarization dither matrix pattern and forming an image based on a result of the binarization; and wherein
the binarization dither matrix pattern is configured as a rectangular pattern wherein a plurality of pixels to be turned on successively are arranged in a matrix, and the rectangular pattern includes a plurality of sub patterns formed by arranging m basic patterns formed such that, in a partly lacking matrix having five rows and four columns, the pixels of the first to fourth column which form the first row of the partly lacking matrix are turned on n+13×mth, n+5×mth, n+11×mth, and n+15×mth, respectively; the pixels of the first to fourth columns which form the second row of the partly lacking matrix are turned on n+9×mth, n+mth, n+3×mth, and n+7×mth, respectively; the pixels of the first to fourth columns which form the third row of the partly lacking matrix are turned on n+4×mth, nth, n+2×mth, and n+10×mth, respectively; the pixels of the first to fourth columns which form the fourth row of the partly lacking matrix are turned on n+12×mth, n+8×mth, n+6×mth, and n+14×mth, respectively; and the pixel of the first column which forms the fifth row of the partly lacking matrix is turned on n+16×mth, m and n being arbitrary natural numbers, and the turn-on order of the pixels is set so that dots having shapes same as each other individually grow in order based on said plurality of sub patterns.

27. A printing apparatus, comprising:
a storage area for expanding a multi-value image; and
an image forming section for binarizing the multi-value image expanded in said storage area using a binarization dither matrix pattern and forming an image based on a result of the binarization; and wherein
the binarization dither matrix pattern is configured as a rectangular pattern wherein a plurality of pixels to be turned on successively are arranged in a matrix, and the rectangular pattern includes a plurality of basic patterns formed such that, in a partly lacking matrix having six rows and five columns, the pixels of the first to fifth columns which form the first row of the partly lacking matrix are turned on 23rd, 15th, 13th, 21st, and 25th, respectively; the pixels of the first to fifth columns which form the second row of the partly lacking matrix are turned on 19th, 7th, 5th, 9th, and 17th, respectively; the pixels of the first to fifth columns which form the third row of the partly lacking matrix are turned on 12th, 4th, 1st, 3rd, and 11th, respectively; the pixels of the first to fifth columns which form the fourth row of the partly lacking matrix are turned on 14th, 6th, 2nd, 8th, and 20th, respectively; the pixels of the first to fifth columns which form the fifth row of the partly lacking matrix are turned on 22nd, 18th, 10th, 16th, and 24th, respectively; and the pixel of the first column which forms the sixth row of the partly lacking matrix is turned on 26th, and the turn-on order of the pixels is set so that dots having shapes same as each other individually grow in order from a plurality of points.

28. A printing apparatus, comprising:
a storage area for expanding a multi-value image; and
an image forming section for binarizing the multi-value image expanded in said storage area using a binarization dither matrix pattern and forming an image based on a result of the binarization; and wherein
the binarization dither matrix pattern is configured as a rectangular pattern wherein a plurality of pixels to be turned on successively are arranged in a matrix, and the rectangular pattern includes a plurality of sub patterns formed by arranging m basic patterns formed such that, in a partly lacking matrix having six rows and five columns, the pixels of the first to fifth columns which form the first row of the partly lacking matrix are turned on n+22×mth, n+14×mth, n+12×mth, n+20×mth, and n+24×mth, respectively; the pixels of the first to fifth columns which form the second row of the partly lacking matrix are turned on n+18×mth, n+6×mth, n+4×mth, n+8×mth, and n+16×mth, respectively; the pixels of the first to fifth columns which form the third row of the partly lacking matrix are turned on n+11×mth, n+3×mth, nth, n+2×mth, and n+10×mth, respectively; the pixels of the first to fifth columns which form the fourth row of the partly lacking matrix are turned on n+13×mth, n+5×mth, n+mth, n+7×mth, and n+19×mth, respectively; the pixels of the first to fifth columns which form the fifth row of the partly lacking matrix are turned on n+21×mth, n+17×mth, n+9×mth, n+15×mth, and n+23×mth, respectively; and the pixel of the first column which forms the sixth row of the partly lacking matrix is turned on n+25×mth, m and n being arbitrary natural numbers, and the turn-on order of the pixels is set so that dots having shapes same as each other individually grow in order based on said plurality of sub patterns.

29. A printing apparatus, comprising:
a storage area for expanding a multi-value image; and
an image forming section for binarizing the multi-value image expanded in said storage area using a binarization dither matrix pattern and forming an image based on a result of the binarization; and wherein
the binarization dither matrix pattern is configured as a rectangular pattern wherein a plurality of pixels to be turned on successively are arranged in a matrix, and the rectangular pattern includes a plurality of basic patterns formed such that, in a partly lacking matrix having seven rows and six columns, the pixels of the first to sixth columns which form the first row of the partly lacking matrix are turned on 34th, 26th, 14th, 24th, 32nd, and 36th, respectively; the pixels of the first to sixth columns which form the second row of the partly lacking matrix are turned on 30th, 16th, 8th, 12th, 20th, and 28th, respectively; the pixels of the first to sixth columns which form the third row of the partly lacking matrix are turned on 22nd, 6th, 2nd, 4th, 10th, and 18th, respectively; the pixels of the first to sixth columns which form the fourth row of the partly lacking matrix are turned on 15th, 5th, 1st, 3rd, 11th, and 23rd, respectively; the pixels of the first to sixth columns which form the fifth row of the partly lacking matrix are turned on 25th, 13th, 7th, 9th, 19th, and 31st, respectively; the pixels of the first to sixth columns which form the sixth row of the partly lacking matrix are turned on 33rd, 29th, 21st, 17th, 27th, and 35th, respectively; and the pixel of the first column which forms the seventh row is turned on 37th, and the turn-on order of the pixels is set so that dots having shapes same as each other individually grow in order from a plurality of points.

30. A printing apparatus, comprising:
a storage area for expanding a multi-value image; and
an image forming section for binarizing the multi-value image expanded in said storage area using a binarization dither matrix pattern and forming an image based on a result of the binarization; and wherein
the binarization dither matrix pattern is configured as a rectangular pattern wherein a plurality of pixels to be turned on successively are arranged in a matrix, and the rectangular pattern includes a plurality of sub patterns formed by arranging m basic patterns formed such that, in a partly lacking matrix having seven rows and six columns, the pixels of the first to sixth columns which form the first row of the partly lacking matrix are turned on n+33×mth, n+25×mth, n+13×mth, n+23×mth, n+31×mth, and n+35×mth, respectively; the pixels of the first to sixth columns which form the second row of the partly lacking matrix are turned on n+29×mth, n+15×mth, n+7×mth, n+11×mth, n+19×mth, and n+27×mth, respectively; the pixels of the first to sixth columns which form the third row of the partly lacking matrix are turned on n+21×mth, n+5×mth, n+mth, n+3×mth, n+9×mth, and n+17×mth, respectively; the pixels of the first to sixth columns which form the fourth row of the partly lacking matrix are turned on n+14×mth, n+4×mth, nth, n+2×mth, n+10×mth, and n+22×mth, respectively; the pixels of the first to sixth columns which form the fifth row of the partly lacking matrix are turned on n+24×mth, n+12×mth, n+6×mth, n+8×mth, n+18×mth, and n+30×mth, respectively; the pixels of the first to sixth columns which form the sixth row of the partly lacking matrix are turned on n+32×mth, n+28×mth, n+20×mth, n+16×mth, n+26×mth, and n+34×mth, respectively; and the pixel of the first column which forms the seventh row of the partly lacking matrix is turned on n+36×mth, m and n being arbitrary natural numbers, and the turn-on order of the pixels is set so that dots having shapes same as each other individually grow in order based on said plurality of sub patterns.

31. A printing apparatus, comprising:
a storage area for expanding a multi-value image; and
an image forming section for binarizing the multi-value image expanded in said storage area using a binarization dither matrix pattern and forming an image based on a result of the binarization; and wherein
the binarization dither matrix pattern is configured as a rectangular pattern wherein a plurality of pixels to be turned on successively are arranged in a matrix, and the rectangular pattern includes a plurality of basic patterns formed such that, in a partly lacking matrix having eight rows and seven columns, the pixels of the fourth to sixth columns which form the first row of the partly lacking matrix are turned on 29th, 35th, and 39th, respectively; the pixels of the first to sixth columns which form the second row of the partly lacking matrix are turned on 37th, 27th, 15th, 17th, 25th, and 31st, respectively; the pixels of the first to sixth columns which form the third row of the partly lacking matrix are turned on 33rd, 21st, 9th, 7th, 11th, and 19th, respectively; the pixels of the first to seventh columns which form the fourth row of the partly lacking matrix are turned on 28th, 10th, 3rd, 1st, 5th, 13th, and 23rd, respectively; the pixels of the first to seventh columns which form the fifth row of the partly lacking matrix are turned on 22nd, 12th, 4th, 2nd, 6th, 18th, and 34th, respectively; the pixels of the second to seventh columns which form the sixth row of the partly lacking matrix are turned on 26th, 16th, 8th, 14th, 30th, and 38th, respectively; the pixels of the second to fifth columns which form the seventh row of the partly lacking matrix are turned on 36th, 32nd, 24th, and 20th, respectively; and the pixel of the second column which forms the eighth row of the partly lacking matrix is turned on 40th, and the turn-on order of the pixels is set so that dots having shapes same as each other individually grow in order from a plurality of points.

32. A printing apparatus, comprising:
a storage area for expanding a multi-value image; and
an image forming section for binarizing the multi-value image expanded in said storage area using a binarization dither matrix pattern and forming an image based on a result of the binarization; and wherein
the binarization dither matrix pattern is configured as a rectangular pattern wherein a plurality of pixels to be turned on successively are arranged in a matrix, and the rectangular pattern includes a plurality of sub patterns formed by arranging m basic patterns formed such that, in a partly lacking matrix having eight rows and seven columns, the pixels of the fourth to sixth columns which form the first row of the partly lacking matrix are turned on n+28×mth, n+34×mth, and n+38×mth, respectively; the pixels of the first to sixth columns which form the second row of the partly lacking matrix are turned on n+36×mth, n+26×mth, n+14×mth, n+16×mth, n+24×mth, and n+30×mth, respectively; the pixels of the first to sixth columns which form the third row of the partly lacking matrix are turned on n+32×mth, n+20×mth, n+8×mth, n+6×mth, n+10×mth, and n+18×mth, respectively; the pixels of the first to seventh columns which form the fourth row of the partly lacking matrix are turned on n+27×mth, n+9×mth, n+2×mth, nth, n+4×mth, n+12×mth, and n+22×mth, respectively; the pixels of the first to seventh columns which form the fifth row of the partly lacking matrix are turned on n+21×mth, n+11×mth, n+3×mth, n+mth, n+5×mth, n+17×mth, and n+33×mth, respectively; the pixels of the second to seventh columns which form the sixth row of the partly lacking matrix are turned on n+25×mth, n+15×mth, n+7×mth, n+13×mth, n+29×mth, and n+37×mth, respectively; the pixels of the second to fifth columns which form the seventh row of the partly lacking matrix are turned on n+35×mth, n+31×mth, n+23×mth, and n+19×mth, respectively; and the pixel of the second column which forms the eighth row of the partly lacking matrix is turned on n+39×mth, m and n being arbitrary natural numbers, and the turn-on order of the pixels is set so that dots having shapes same as each other individually grow in order based on said plurality of sub patterns.

33. The printing apparatus as claimed in claim 23, wherein, in the binarization dither matrix pattern, the rectangular pattern to which the turn-on order is set is turned 90 or 270 degrees.

34. The printing apparatus as claimed in claim 23, wherein, in the binarization dither matrix pattern, the turn-on order number set to an arbitrary pixel in the rectangular pattern and the turn-on order number set to a pixel at a point symmetric to the pixel with respect to the center of the rectangular pattern are exchanged for each other.
